(19) United States
(12) Patent Application Publication
(10) Pub. No.: US 2013/0008542 A1
(43) Pub. Date: Jan. 10, 2013

(54) DIAPHRAGM VALVE AND METHODS AND ACCESSORIES THEREFOR

(76) Inventors: Kevin M. Irwin, Tucson, AZ (US); Steven L. Felde, Tucson, AZ (US); Kenneth J. Skripkar, Tucson, AZ (US); Samuel C. Walker, Green Valley, AZ (US); Russell Churchill, Phoenix, AZ (US); Edward David Baker, Hillsboro, OR (US); Oscar Pulgarin, JR., Tucson, AZ (US); Zachary Steven Dean, Tucson, AZ (US); Mustafa Mohammed A. Albahrani, Dammam (SA); Christopher D. Holt, Tempe, AZ (US); Scott Kent Zimmerman, Tucson, AZ (US); Peter Niess, Vail, AZ (US)

(21) Appl. No.: 13/542,413

(22) Filed: Jul. 5, 2012

Related U.S. Application Data
(60) Provisional application No. 61/504,623, filed on Jul. 5, 2011.
(60) Provisional application No. 61/603,842, filed on Feb. 27, 2012.

(51) Int. Cl. F16K 15/14

(52) U.S. Cl. 137/859

(57) ABSTRACT

Various diaphragm valves and accessories therefore are disclosed herein which improve on existing diaphragm valves and accessories and overcome many of the shortcomings of same. Related methods to these valves and accessories and/or their manufacture, assembly or use are also disclosed.

### CROSS REFERENCE TO RELATED APPLICATIONS

This application claims the benefit of U.S. Provisional Application Nos. 61/504,623 filed Jul. 5, 2011 and 61/603,842 filed Feb. 27, 2012 which are hereby incorporated herein by reference in their entirety.

### FIELD

The disclosure is directed to a diaphragm valve for irrigation systems, and in particular to a diaphragm valve configured for improved flow, operation, installation and serviceability.

### BACKGROUND

Diaphragm valves for use in irrigation systems typically have an inlet opening, an outlet opening and a diaphragm element having a seal positioned to selectively open and close against a generally cylindrical diaphragm seat to permit or block fluid flow through an opening of the diaphragm seat and thus from the inlet opening to the outlet opening. A control chamber is positioned on the opposite side of the diaphragm element from the seat to control the position of the seal of the diaphragm element. When the fluid pressure acting on the diaphragm element from the control chamber side exceeds the fluid pressure acting on the opposite side of the diaphragm element, the diaphragm element will be forced against the diaphragm seat to block fluid flow through the opening of the seat and thereby block fluid flow from the inlet opening to the outlet opening. Conversely, when the fluid pressure acting on the diaphragm element from the control chamber side is less than the fluid pressure acting on the opposite side of the diaphragm element, the diaphragm element will be forced away from the diaphragm seat to permit fluid flow through the opening of the seat and thereby permit fluid flow from the inlet opening to the outlet opening.

The seal of the diaphragm element often engages an annular face of the diaphragm seat when the diaphragm element is in its closed position to block fluid flow through the opening of the seat. As the diaphragm element moves from its open position to its closed position, the flow area between the diaphragm seat and the seal continually decreases in correspondence with the position of the seal from the diaphragm seat until the seal is engaged with the diaphragm seat to block flow through the opening of the diaphragm seat. When the seal engages the diaphragm seat to block flow through the opening of the diaphragm seat, the abrupt change in the flow area between the seal and the diaphragm seat from greater than zero, immediately prior to engagement, to zero, at the time of engagement, can cause a sudden pressure spike greater than the upstream pressure. More specifically, the pressure spike in the upstream pressure can be caused as the motion energy in the flowing fluid is abruptly converted to pressure energy acting on the components of the diaphragm valve. This pressure spike can cause the diaphragm valve to experience a water hammer effect, which can undesirably result in increased stress on the components of the diaphragm valve, as well as other components of the irrigation system, and can lead to premature failure of the components.

In order to control the pressure in the control chamber, a fluid entrance path and a fluid exit path to and from the control chamber are typically provided. The fluid entrance path may extend between the inlet opening and the control chamber, and may be continuously supplied with fluid from the inlet opening. The fluid exit path may extend between the control chamber and the outlet opening. A selectively actuable control valve or actuator may be positioned to block fluid flow through the fluid exit path.

When the control valve is positioned to block fluid flow through the fluid exit path from the control chamber, the fluid entrance path continues to permit fluid to flow from the inlet opening to the control chamber, thereby causing fluid to accumulate in the control chamber. The diaphragm element has a larger surface area exposed to high pressure on the control chamber side than is exposed to high pressure on the side facing the inlet opening. Thus, when the fluid pressure in the control chamber and inlet opening are generally the same, the operation of the fluid pressure in the control chamber acts on the greater surface area of the control chamber side of the diaphragm element and causes the diaphragm element to either shift from its open position to its closed position or to remain in its closed position.

When the control valve is positioned to permit fluid flow through the fluid exit path from the control chamber, fluid exits the control chamber at a faster rate than fluid enters the control chamber. This causes the fluid pressure acting on the control chamber side of the diaphragm element to decrease relative to the fluid pressure acting on the side of the diaphragm element facing the inlet opening. The fluid pressure in the inlet opening then causes the diaphragm element to move to its open position, whereby the seal of the diaphragm element is spaced from the diaphragm seat and fluid flow is permitted from the inlet opening, through the opening of the diaphragm seat and through the exit opening.

Dirt, grit and other debris are typically present in an irrigation system. The debris can have a detrimental effect on the operation of the diaphragm valve, particularly when the debris accumulates on various components within the diaphragm valve. For instance, debris can accumulate on the seal of the diaphragm element, and reduce the seal that can be achieved between the seal and the diaphragm seat. In some circumstances, the abrasive effect of the debris can degrade the seal. Debris can also clog the fluid entrance and fluid exit paths of the control chamber, which can result in improper operation of the diaphragm element and thus can lead to difficulties in opening and closing of the valve.

In order to reduce the presence of debris in the diaphragm valve, some valve assemblies have been provided with a filter cartridge connected between the inlet opening and the control chamber of the diaphragm valve, as disclosed in U.S. Pat. No. 7,552,906. The filter is typically offset from the axis about which the main valve components are aligned (e.g., diaphragm, control chamber, bonnet and flow control mechanism, if any) and, as such, often complicates the construction of the valve assembly. For example, in several embodiments, such a filter cartridge requires the presence of an additional structure in the bonnet of the valve as seen in the '906 patent, thereby complicating the construction of the bonnet itself.

It has also been known to position a cylindrical screen between the inlet opening and the control chamber of the diaphragm valve, as disclosed in U.S. Pat. No. 5,996,608. The '608 patent also discloses the use of a wiper that extends around the circumference of the cylindrical screen and is mounted for longitudinal reciprocation along the screen when the diaphragm valve is shifted between its open and closed positions to reduce accumulation of debris, and potential clogging, on the screen. The '608 patent further discloses a modified wiper element that is configured to spin freely around the filter screen. However, a freely spinning wiper element can disadvantageously harm the screen when the wiper element is rotating at high speeds due to the frictional contact therebetween. High speeds of the wiper element relative to the screen can occur, for example, during winterization when compressed air is blown through the system to flush out water. The high frictional contact between a freely spinning wiper element and the screen could generate sufficient heat to deform the screen and/or the wiper element. These conventional filters are also difficult to remove, clean and/or service, and often are limited in the amount of surface area they can provide and amount of filtered fluid they can allow pass through to the control chamber due to their cylindrical shape and positioning within the valve.

The configuration of conventional valves also makes them challenging to install and service due to the facts that fittings often have to be threaded into the inlet and outlet passages of the valve, many of the valve components require use of tools to assemble/disassemble, assembly/disassembly often is done blindly, and the valve components often come apart in pieces when disassembled. In addition, once assembled and installed, the valve cannot conveniently be removed for service and/or replacement and often requires working in dirt or debris filled environments that can make it even harder to keep the valve assembly and piping clean and free of debris. Installation and/or servicing also often requires the shutting off of an upstream branch valve or entire system via a master valve rather than a more local valve, which adds time and labor (and therefore expense) to the handling of these tasks.

During operation of the diaphragm valve, air can become trapped in the control chamber. The presence of excess air, a compressible fluid, in the control chamber can adversely effect the operation of the diaphragm valve, and in particular the shifting of the diaphragm element between its open and closed positions. For example, excess air in the control chamber can cause the diaphragm element to shift from its open position to its closed position more rapidly than intended, which can further exacerbate the water hammer effect discussed above. In order to permit for air to be removed from the control chamber, diaphragm valves have been provided with manually-operated bleed mechanisms that allow for a user to selectively vent air from the control chamber. However, most conventional valve assemblies do not effectively bleed the air from the highest point of the bonnet; thus, making it difficult to remove all air trapped inside the bonnet.

Often times these bleed mechanisms also complicate the structure of the bonnet and/or valve body and can be difficult to use along with other components of the valve assembly such as flow control handles, if present, or may affect the operation of such other components or ability to operate such other components due to the configuration of the assembly. Conventional valve configurations can also require valve components to increase in size or height either permanently or temporarily while operating certain components, neither of which are preferred due to the often limited space valve installers and servicers are dealing with, such as in valve boxes and the like.

The flow path that the fluid follows when the diaphragm valve is in its open position is generally from the inlet opening, past the opening of the diaphragm seat, and finally through the outlet opening. As the fluid follows this path, typical internal geometry of the diaphragm valve and valve housing can cause very rapid acceleration and deceleration of the fluid. In particular, the geometry of upright valves and internal flow path therein can lead to rapid turning of the fluid flow, thereby accelerating the flow, in a vector sense, by forcing it to change direction several times. In addition, the geometry of the diaphragm seat can cause acceleration of the fluid as it approaches the opening of the diaphragm seat from the inlet opening. This can be due to the larger flow area of the inlet opening as compared to the flow area of the opening of the diaphragm seat, which can cause the fluid to rapidly accelerate as it approaches the opening in order to maintain conservation of mass in the incompressible flow. Moreover, the geometry of the diaphragm seat can cause deceleration of the fluid at it exits the opening of the diaphragm seat and enters the outlet opening due to the smaller flow area of the opening of the diaphragm seat as compared to the larger flow area of the adjacent portion of the outlet opening. Rapid acceleration or deceleration of the flow, whether through a change in flow velocity or flow direction, can cause the loss of energy in the fluid, which results in a pressure loss in the diaphragm valve and can therefore increase the number of valves required to irrigate the intended area.

In addition to the above-mentioned problems, conventional valves are not equipped to provide information relating to the operation of the valve and/or the fluid flowing through the valve. This lack of information hinders the ability of the user to fully understand and optimize the system within which the valve is placed and may lead to a delay in discovery of unwanted fluid flow conditions (if ever discovered). Conventional valves also fail to process information relating to fluid flow and to automatically take action in response to this information resulting in unwanted conditions developing with respect to the irrigation system and/or requiring additional labor to achieve desired results. Similarly, conventional valves typically have complicated installation, setup and servicing requirements that cause further delays and interruptions to normal system operation and ultimately require more labor leading to greater costs for installing, operating and maintaining the irrigation system.

In view of the foregoing deficiencies in existing diaphragm valves, there remains an unmet need for diaphragm valves having improved flow, operation, installation and serviceability, including diaphragm valves configured to reduce debris in the flow paths, improve filtering of fluid flowing to the control chamber, reduce the energy lost during flow, and/or improve bleed operation and operation of other valve components, and ultimately improve or increase the ease of installation and serviceability. There also remains an unmet need for diaphragm valves equipped to provide information relating to the operation of the valve and/or the fluid flowing through the valve and for valves that automatically take action in response to this information.

### BRIEF DESCRIPTION OF THE DRAWINGS

FIG. 1A-D are perspective, side, front and rear elevational views, respectively, of a diaphragm valve for irrigation systems showing a valve body, a bonnet, a flow-control handle and a solenoid actuator;

FIGS. 1E-F are cross-sectional views of the diaphragm valve of FIGS. 1A-D, illustrating the valve in its respective closed and open positions;

FIG. 1G is a top plan view of the diaphragm valve of FIGS. 1A-F, with a partial cutaway to illustrate the control chamber exit passage and the path fluid takes when the solenoid actuator has been activated to reduce the pressure in the control chamber thereby allowing the valve to move or remain in its open position;

FIGS. 2A-C are perspective, side and cross-sectional views, respectively, of the diaphragm valve of FIGS. 1A-G including additional clamp, pressure sensing, cleaning and shutoff accessories that may be used in conjunction therewith to improve or increase ease of installation and/or serviceability of the diaphragm valve and accessories;

FIGS. 3A-D are perspective, side, front and rear elevational views, respectively, of an alternate diaphragm valve for irrigation systems showing a valve body, a bonnet, a flow-control handle, a solenoid actuator, a bleed mechanism, a pressure regulator and a Schrader valve;

FIGS. 3E-F are cross-sectional views of the diaphragm valve of FIGS. 3A-D, illustrating the valve in its respective closed and open positions;

FIG. 3G is a top plan view of the diaphragm valve of FIGS. 3A-F, with a partial cutaway to illustrate the control chamber exit passage and the path fluid takes when the solenoid actuator has been activated to reduce the pressure in the control chamber thereby allowing the valve to move or remain in its open position;

FIG. 3H is an enlarged partial cross-sectional view of the main valve housing of FIGS. 3A-G, illustrating an integrated filter and scrubber assembly, a second canister filter, a valve seal, support and spacer assembly, alignment/guide structures, flow control piston and diaphragm;

FIG. 3I is an enlarged partial cross-sectional view of the main valve housing of FIGS. 3A-H, illustrating the diaphragm, flow control piston and stem assembly, and a bonnet and snap ring assembly with the flow control handle being removed for purposes of showing the snap ring more clearly;

FIG. 3J is an enlarged perspective view of the flow control piston of FIGS. 3A-I, illustrating the grooved, grit tolerant structure and ribs for aligning and guiding the seal;

FIG. 3K is an enlarged partial cross-sectional view of the main valve housing of FIGS. 3A-K, illustrating one exemplary embodiment of guide structures for guiding the diaphragm assembly and seal between the open and closed positions;

FIG. 3L is an front elevational view of the diaphragm valve of FIGS. 3A-K, similar to that shown in FIG. 3D, however, having the valve body removed to illustrate the integrated valve seat and diaphragm support member and show how this assembly captures the integrated screen and scrubber assembly when installed in the valve housing;

FIGS. 4A-B are perspective views of another alternate diaphragm valve in accordance with the invention, illustrating an alternate filter and scrubber assembly and captured articulating or pivoting fasteners;

FIGS. 4C-E are side, front and rear elevational views of the diaphragm valve of FIGS. 4A-B, illustrating the captured articulating or pivoting fasteners for connecting the bonnet to the valve body;

FIG. 4F is a cross-sectional view of the diaphragm valve of FIGS. 4A-E, illustrating an integral fin-shaped filter and scrubber insert;

FIGS. 4G-I are top and exploded views of the diaphragm valve of FIGS. 4A-F, showing the bonnet connecting fasteners attached to the bonnet, released from the bonnet and an exploded view of the valve, respectively;

FIG. 4J is an enlarged partial perspective view of the diaphragm valve of FIGS. 4A-I, illustrating one of the bonnet connecting fasteners exploded from its mating recess in the valve body and illustrating the lip or ridge that snap fits the fastener to the valve body;

FIGS. 4K-L are perspective views of the filter and scrubber insert of FIGS. 4A-J, illustrating the filter in its closed position and open position, respectively;

FIGS. 4M-N are enlarged perspective views of the diaphragm and filter of FIGS. 4A-L illustrating the filter in a partially installed and installed position, respectively;

FIGS. 5A-C are perspective, partial cross sectional and enlarged views, respectively, of an alternate form of valve clamp accessory in accordance with the invention illustrating a clamp with projections, such as barbs or teeth, for engaging and securing a pipe to the diaphragm valve;

FIGS. 6A-D are perspective, side, front and rear elevational views, respectively, of an alternate diaphragm valve assembly for irrigation systems showing a valve body and clamp for securing the valve body to a conduit, a bonnet secured with captured articulating or pivoting fasteners, a flow-control handle, a solenoid actuator, a bleed mechanism, an integral flow sensor for providing information relating to the valve and/or fluid flowing through the valve in accordance with one aspect of the present invention;

FIG. 6E is a cross-sectional view of the diaphragm valve assembly of FIGS. 6A-D, illustrating the valve in a closed position and the flow meter;

FIGS. 7A-D are perspective, side, front and rear elevational views, respectively, of an alternate diaphragm valve assembly for irrigation systems showing a valve body, a bonnet, a flow-control handle, a solenoid actuator, a bleed mechanism, a Schrader valve and an externally accessible universal filter;

FIGS. 7E-F are cross-sectional views of the diaphragm valve assembly of FIGS. 7A-D, illustrating the valve in its closed and open positions, respectively;

FIGS. 8A-C are cross-sectional, perspective and top views, respectively, of an eccentric diaphragm valve assembly for a reverse flow valve;

FIG. 9 is a circuit diagram for one embodiment of the flow meter illustrated in FIGS. 6A-E;

FIG. 10 is a block diagram illustrating various ways in which a diaphragm valve assembly in accordance with the present invention may be configured;

FIG. 11 is a block diagram illustrating one form of diaphragm valve with turbine driven flow meter in accordance with the present invention;

FIG. 12 is a flow chart illustrating one way in which a diaphragm valve with flow meter may operate in accordance with the present invention;

FIGS. 13A-B are perspective views of an alternate diaphragm assembly with an integral flow meter in accordance with the present invention, viewed from above and below respectively;

FIGS. 14A-B are perspective and exploded views of the flow meter portion of the alternate diaphragm assembly of FIGS. 13A-B;

FIGS. 15A-B are assembly illustrations for assembling the alternate diaphragm assembly of FIGS. 13A-B and installing this assembly into a valve housing in accordance with the present invention;

FIG. 15C is a side elevation view of the alternate diaphragm assembly of FIGS. 13A-B installed in a valve housing and looking into the inlet opening of the valve housing;

FIG. 16 is a circuit diagram for an alternate flow meter embodiment of the flow meter illustrated in FIGS. 6A-E;

FIGS. 17A-C are perspective, exploded and cross-sectional views of an alternate flow meter embodiment in accordance with the present invention, illustrating a flow meter accessory that may be used with new valves or used to retrofit existing valves and showing how the flow meter could be designed to screw into a threaded socket like those discussed in prior embodiments;

FIG. 18 is a cross-sectional view of the turbine of the flow meter illustrated in FIGS. 17A-C taken along lines 18-18 and illustrating an exemplary turbine shape and guards for protecting the turbine from line-debris;

FIG. 19 is a cross-sectional view of an alternate flow meter embodiment in which the flow meter is self-powering and includes a generator and energy storage device such as a battery for storing energy generated by the generator;

FIG. 20 is a flow chart illustrating a method for automatically establishing at least one fluid flow parameter for shortening the amount of time it takes for the flow meter to learn or establish at least one normal fluid flow parameter; and

FIG. 21 is a flow chart illustrating a method for automatically determining if detected flow that is outside parameter thresholds is an unwanted fluid flow event for which the valve should be shut or if the detected flow is indicative of another event such as purging or winterizing for which the flow meter should be suspended or placed in a bypass mode.

### DESCRIPTION OF PREFERRED EMBODIMENTS

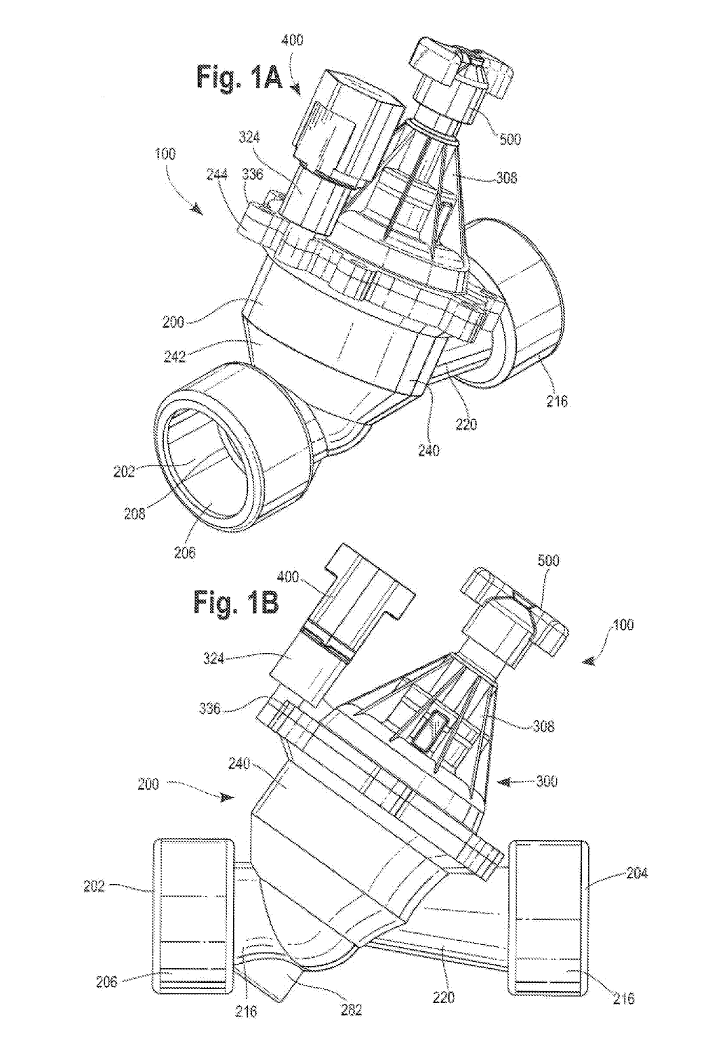

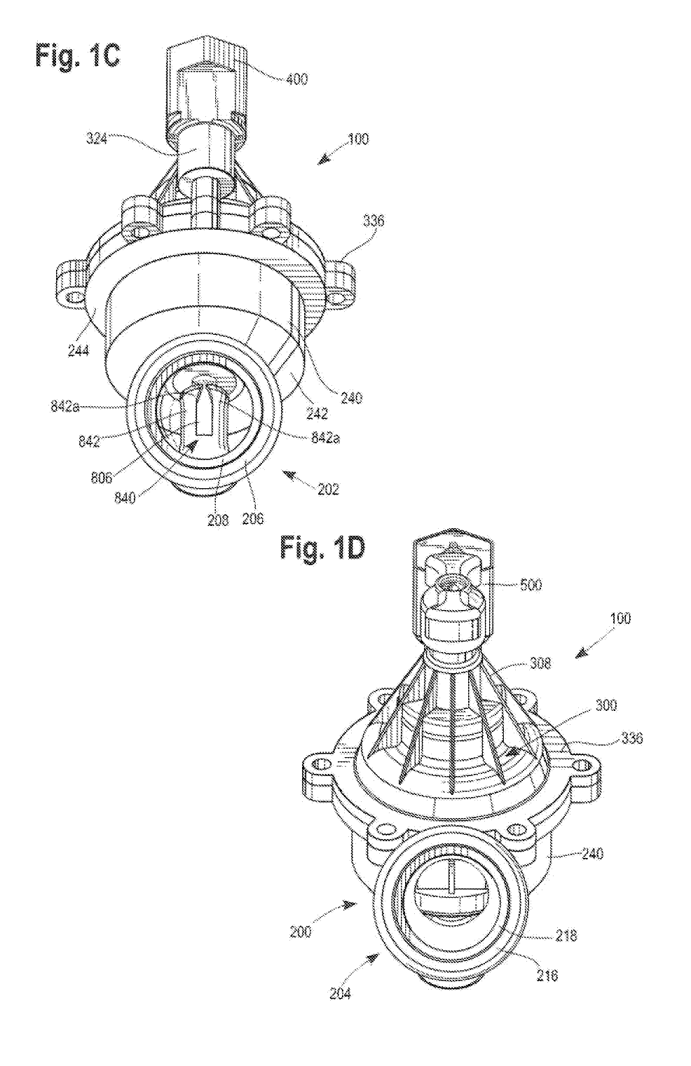

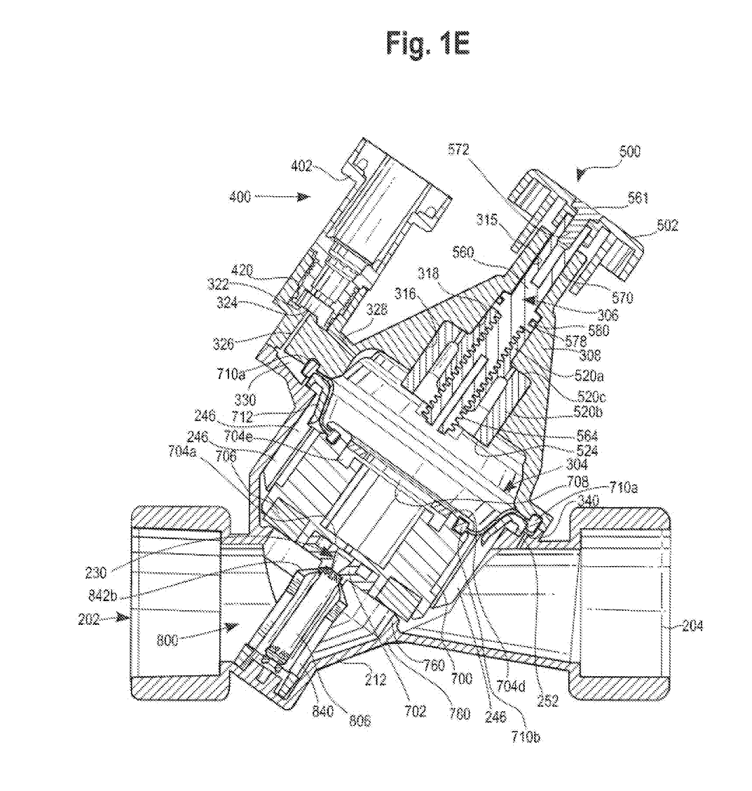

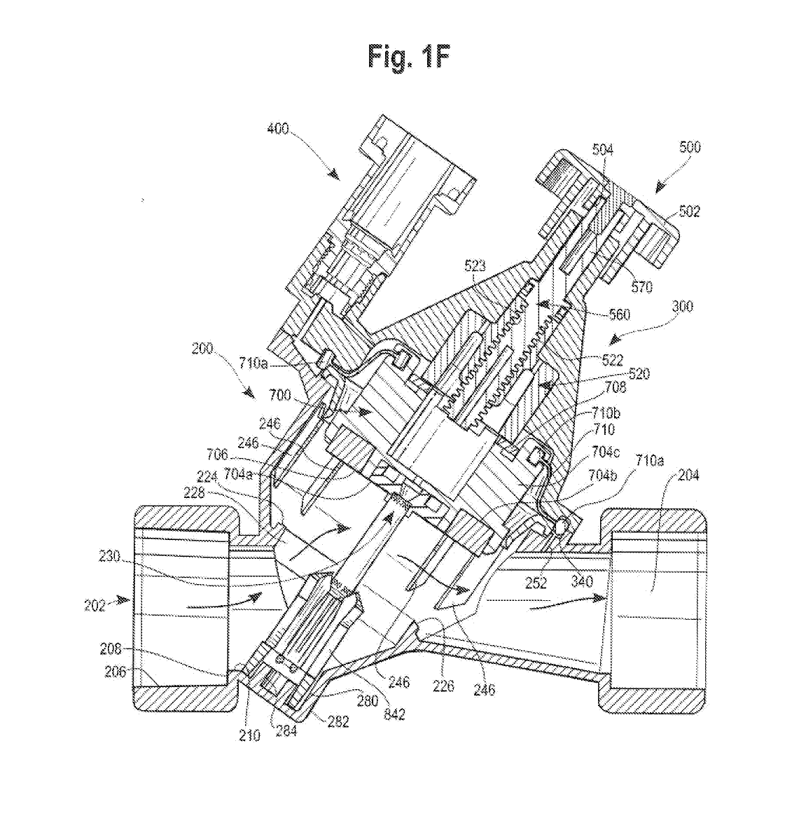

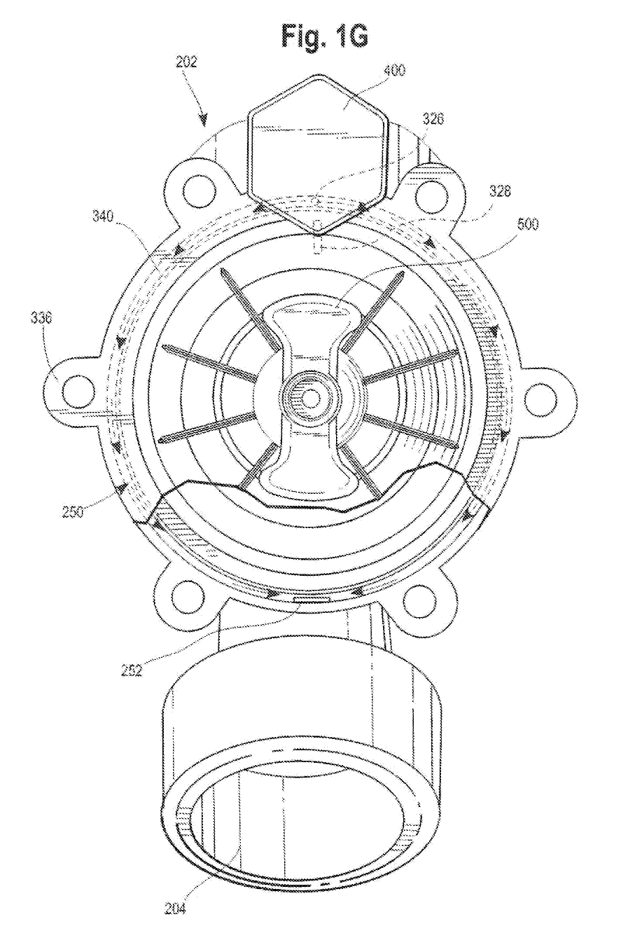

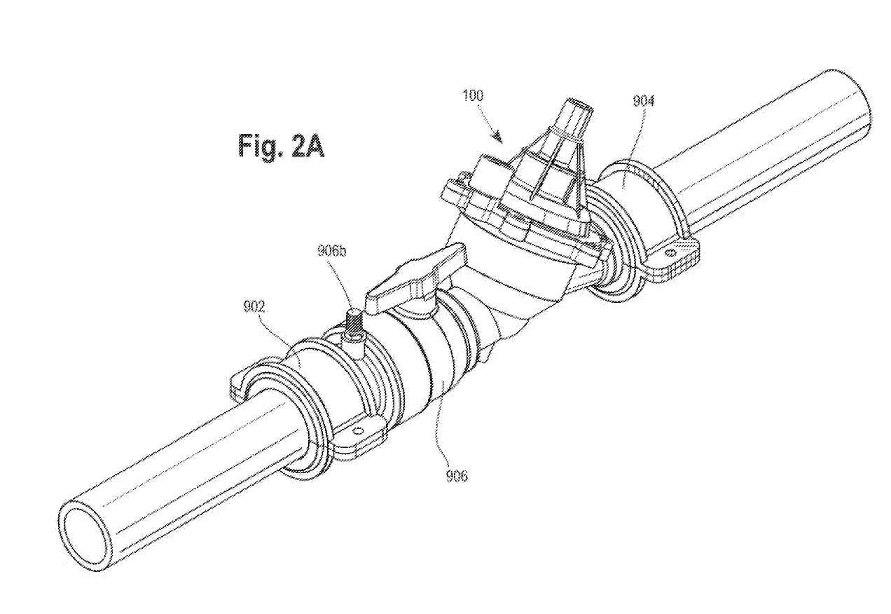

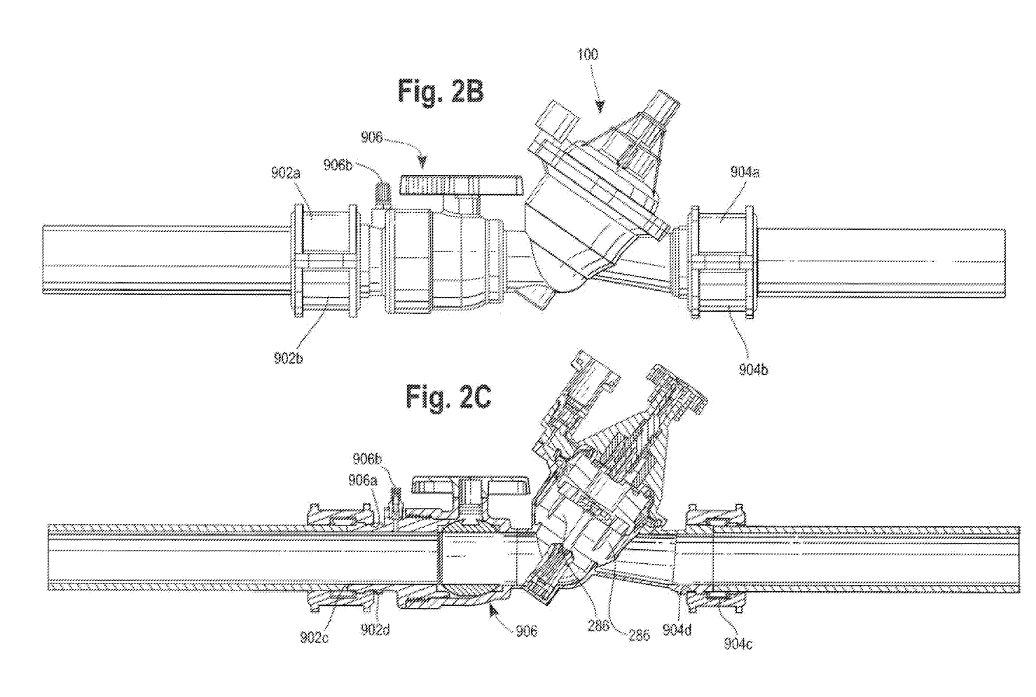

A diaphragm valve 100 is disclosed herein and aspects of which are illustrated in FIGS. 1A-2C that has improved flow, including being adapted to reduce debris in the flow paths, reduce the energy lost during flow, improved operation, and improved installation and serviceability valve. The reduction of debris in the control flow path is achieved using a filter positioned in the control flow path which is cleaned by a stationary scrubber that is coaxially aligned with both the filter and the diaphragm in one aspect of the diaphragm valve 100. In another aspect, a radial second filter is provided that restricts passage of debris further upstream from the above-mentioned filter. The reduction in the flow energy lost is achieved by shaping specific surfaces in contact with the fluid flow at specific locations, including but not limited to using a canted inlet passage to reduce the directional changes and the resulting pressure loss that corresponds with such turning of fluid flow. Finally, the improved installation and serviceability of the valve is at least partially achieved using internal guide and alignment structures and pointed or domed filter ends and bell-mouth openings in the corresponding scrubber for assisting in the blind installation of the filter, diaphragm, flow control and bonnet structures. In another aspect, the valve may also be assembled with accessories such as seal and clamp type connections to the inlet and outlet piping, a shutoff valve (such as a ball-type shutoff valve) and a Schrader valve test/pressure port, all of which can be used to help improve installation and serviceability of the valve.

The diaphragm valve 100 consists of a valve body 200, a bonnet 300 attached to the valve body 200 and an actuator or valve, such as solenoid 400, attached to both the bonnet 300 and valve body 200, as illustrated in FIGS. 1A-G. The diaphragm valve 100 includes an internal, centrally located diaphragm assembly 700 that is shiftable both away from and toward a diaphragm valve seat 224. When the diaphragm assembly 700 is engaged with the diaphragm valve seat 224 fluid flow through the diaphragm valve 100 is blocked. Conversely, when the diaphragm assembly 700 is unengaged with the diaphragm valve seat 224 fluid flow through the diaphragm valve 100 is permitted. In conjunction with the solenoid actuator 400, an internal control chamber 304, positioned between the valve body 200 and the bonnet 300, is used to shift the diaphragm assembly 700 relative to the diaphragm valve seat 224.

A flow-control handle 502 is positioned over the bonnet 300, on a side of the bonnet 300 opposite from the valve body 200. The flow-control handle 502 permits external adjustments to be made to the spacing, and thus the flow area, between the diaphragm assembly 700 and the diaphragm valve seat 224 when the diaphragm valve 100 is in its open position, as will be discussed in greater detail below. Although not shown in FIGS. 1A-2C, in alternate embodiments (as will be discussed further below), a bleed mechanism/metering assembly may be positioned in a central aperture of the flow-control handle 502 to further assist with flow-control and/or servicing of the valve 100. For example, the bleed mechanism could be used to permit external bleeding of fluid, such as air, from the control chamber 304 and/or to flush debris from the flow paths.

A filter 806 is positioned coaxially with the diaphragm 700, between the inlet of valve body 200 and the control chamber 304 in order to prevent debris from flowing into the control chamber 304 which could negatively affect the operation of diaphragm 700 and, thus, valve 100. In the form illustrated, the filter 806 is connected to the diaphragm 700 and moves between open and closed positions that correspond with the open and closed positions of the diaphragm 700. In addition, a scrubber 840 is anchored to the valve housing 200 and has fingers or pawls which clean the exterior or outer surface of filter 806 while the diaphragm assembly 700 to which the filter is attached moves between its open and closed positions.

Turning now to more of the details of the components, the valve body 200 defines the inlet opening 202 and outlet opening 204, as well as the annular diaphragm valve seat 224 and a divider wall 214 between the inlet fluid passage and the outlet fluid passage. With specific reference to FIGS. 1E-F, the inlet fluid passage includes a larger diameter segment 206 immediately adjacent the inlet opening 202 that is sized to be joined to piping of an irrigation system. A reduced diameter segment 210 is positioned adjacent to the larger diameter segment 206. A ledge 208 between the two segments 206 and 210 restricts intrusion of the piping into the reduced diameter segment 210. Similarly, the outlet fluid passage includes a larger diameter segment 216, a reduced diameter segment 220 and a ledge 218 therebetween. Both of the larger diameter segments 206 and 216 are shown as smooth to accommodate a glue joint with pipe fixtures. However, the larger diameter segments 206 and 216 can alternately be threaded, such as with NPT threading, to accommodate threaded pipe ends or fixtures. An axis of the diaphragm valve seat 224 is positioned at an angle less than ninety degrees (90°) to a longitudinal axis extending through the inlet opening 202 and outlet opening 204, such as the illustrated canted inlet portion positioned at a generally thirty-five degree (35°) angle. The diaphragm valve seat 224 has a central opening circumscribing the upper edge of an inner wall 228 of the valve seat 224. A curved segment 212 is disposed in the valve body 200 generally proximate to the diaphragm valve seat 224 to facilitate directing the fluid flow through the inlet fluid passage and to the opening of the diaphragm valve seat 224. Another curved segment 222 is disposed on the opposite side of the divider wall 214 in the outlet fluid passage to facilitate directing the fluid flow to the outlet opening 204. On the outlet side of the valve body 200, a smaller generally rectangular bore 252 is present to permit drainage of fluid from the solenoid actuator 400 into the reduced diameter segment 220 of the outlet passage.

The valve body 200 also includes an annular wall 240 positioned to define a portion of the fluid flow path downstream of the opening of the diaphragm valve seat 224. The body 200 further includes a tapered section 242 adjacent one end of the annular wall 240 and a flanged section adjacent the opposite end of the annular wall 240. Together the tapered section 242, annular wall 240 and flanged end 244 define an internal passage with an upper opening into which internal valve components (e.g., diaphragm assembly 700, seal 706, etc.) are disposed. As will be discussed further below, the tapered section 242 and internal guide structures, such as ribs 246, which extend from an interior surface of the valve body towards the diaphragm assembly 700 help guide the diaphragm assembly as it travels between the closed and open positions to ensure that the seal 706 remains properly aligned with the valve seat 224 so that the diaphragm valve 100 opens and closes properly. In the form illustrated, the flanged end 244 corresponds in shape to the bonnet and is positioned to be engaged with the bonnet 300. To this end, a plurality of bolt holes are provided in the bonnet 300 and are aligned with similar openings or bores in the valve body flange 244. In a preferred form, the bores defined by the valve body flange 244 are threaded via threaded metal inserts to permit the bonnet 300 to be secured to the valve body 200 using a plurality of bolts.

The bonnet 300 has a generally dome-shaped portion 308 surrounded by a peripheral flange 336, as illustrated in FIGS. 1A-F. A central opening 306 is formed through the dome-shaped portion 308 of the bonnet 300 for accommodating components of the flow-control assembly 500 and the bleed screw assembly (if present), which will be discussed in greater detail below. The central opening 306 includes a larger diameter opening 316, an intermediate diameter opening 318 and a smaller diameter opening 315. An actuator seat 324 and aligned opening 326 are formed in the peripheral flange 336 of the bonnet 300 in order to accommodate the solenoid valve 400. A fluid passage 328 formed in the dome-shaped portion 308 of the bonnet 300 extends between the control chamber 304 and an outer chamber 322 formed between the solenoid valve 400 and the seat 324 in the flange 336 of the bonnet 300, as also will be discussed in greater detail below.

The diaphragm assembly 700 includes a multitude of different components, including a filter support 702, a seal support cup 704, a seal such as seal support cup insert 706, a diaphragm stop 708, a dish diaphragm or web 710 and a diaphragm support ring 712. The filter support 702 forms an annular wall about the filter 806 and within which the filter 806 is disposed. The filter support 702 is nested in a central recess 704a located on the bottom surface of seal support cup 704. Similarly, seal support cup insert 706 is disposed in a secondary outer recess 704b that circumscribes the central recess, helps stiffen the bottom of seal support cup 704, and actually forms the seal 706 between the diaphragm assembly 700 and valve seat 224. The distal end of upstanding annular wall 704c of seal support cup 704 defines a channel 704d within which a first end 710a of dish diaphragm 710 is captured to form an inner bead and a recessed step 704e atop which is disposed the diaphragm stop 708 which is shaped as a flat ring or washer. The opposite end 710b of dish diaphragm 710 is captured in a cavity formed between the bonnet flange 336 and the mating portion of valve body 200 to form an outer bead. The dish diaphragm 710 is made of a flexible material so that the diaphragm may easily move between its open and closed positions and is supported by supporting ring 712 which helps ensure the alignment of the diaphragm 700 so that the diaphragm 700 and valve seat 224 remain coaxially aligned, the filter 806 and scrubber 840 remain coaxially aligned, and flow control assembly 500 and diaphragm 700 remain coaxially aligned. The diaphragm support 712 further helps to prevent the diaphragm web or dish 710 from stretching, particularly while the diaphragm assembly 700 is in the closed position.

The diaphragm assembly 700 functions to both selectively permit fluid flow through the diaphragm valve 100 by being either engaged or unengaged with the diaphragm valve seat 224. To this end, the diaphragm assembly 700 includes seal 706 which is positioned to abut against a face 226 of the diaphragm valve seat 224. In one form, the inner surface of the valve housing may include a plurality of notches or cut-outs forming an incongruous ring about the inner wall of the valve body 200 in order to form a multi-stage reduction in the flow area between the diaphragm assembly 700 and the valve body 200 as disclosed in U.S. Pat. No. 7,694,934 issued Apr. 13, 2010 to Irwin and entitled “Diaphragm Valve for Irrigation System” (“the '934 patent”), which is incorporated herein by reference in its entirety. In addition the use of first and second seals and cut-outs may be used as described in the '934 patent to permit for a multi-stage reduction in the flow area between the diaphragm assembly 700 and the diaphragm valve seat 224 when the central stem assembly is being shifted toward the diaphragm valve seat 224 for blocking fluid flow through the diaphragm valve 100. The use of multi-stage reduction in the flow area can reduce the water hammer effect that can occur when, as in typical diaphragm valves having single-stage sealing, the diaphragm valve is suddenly closed and a resulting pressure spike causes potentially harmful vibration to the system.

The diaphragm valve seat 224 includes an annulus that projects upward from the surrounding portion of the valve body 200, and includes a sealing face 226 that is positioned to be engaged by seal 706 when the diaphragm valve 100 is in its closed position to block fluid flow through the opening 262 of the diaphragm valve seat 224. The sealing face 226 also slants downward from inner diameter to outer diameter of the wall defining valve seat 224 to ensure that the inner most portion of valve seat 224 engages the insert 706 first and, thus, will be the last portion of seal 706 to break from the valve body 200 when the diaphragm 700 moves from the closed position to the open position. In addition, as mentioned above, the inclined inner surface of valve body 200 that mates with seal support cup 704 to form second seal 780 may include a plurality of bypass cut-outs. The inclined surface and bypass cut-outs permit gradual, sealing of the opening of the diaphragm valve seat 224 by seal 706 (or in alternate embodiments multi-stage sealing if implemented).

The diaphragm assembly 700 also functions to supply operating fluid to the control chamber 304 positioned between the bonnet 300 and valve body 200. The supply of operating fluid to the control chamber 304 is continuously available when the diaphragm valve 100 is supplied with fluid, regardless of whether the diaphragm valve 100 is in its open position or its closed position.

The fluid supplied to the diaphragm valve can contain dirt or other debris that can adversely impact the operation of the diaphragm valve 100. In particular, debris can degrade the seals and can clog the small fluid passages in the diaphragm valve 100. To reduce the amount of debris in the control chamber 304, a filter or screen assembly 800 is positioned in the flow path between the inlet passage and the control chamber 304. In the form illustrated, the filter or screen assembly 800 is a generally cylindrical canister filter which defines a plurality of holes sized to allow fluid but not debris to flow through to the control chamber 304 via the control chamber inlet passage 230. Furthermore, a scrubber 840 is positioned adjacent to the filter 806 to remove debris from the surface thereof to reduce clogging of the filter 806 due to accumulation of debris. The scrubber 840 is positioned within an annular recess 280 located in the bottom of valve body 200 on the inlet passage side of the valve 100. The recess is surrounded at least partially by an upstanding peripheral wall 282 and uses a fastener, such as clips 284, to anchor the scrubber 840 to the valve body 200. In the embodiment illustrated, the scrubber 840 includes a plurality of fingers or pawls 842 extending upward in a direction opposite the bottom of valve body 200 about the filter 806 and engaging at least a portion of the exterior surface of the filter 806. More particularly, in the form illustrated the distal end 842a of the fingers or pawls 842 of scrubber 840 extend inward to form nubs 842b having an inner diameter that is smaller than the inner diameter of the remainder of the scrubber 840 (or at least the proximate end of the scrubber 840) and slightly smaller than the outer diameter of the filter 806. The contact created by these nubs 842b at the distal end 842a of the scrubber 840 allows the scrubber 840 to clean the exterior of filter 806 as the filter 806 moves between its open and closed position (which corresponds to the open and closed position of diaphragm 700). In a preferred form and to maximize effectiveness, the nubs 842b will collectively cover as much of the circumferential outer surface of the filter 806 as possible. For example, in additional to bowing in towards the distal end 842a, the fingers 842 may also be formed of a concave shape to track the radius or circumferential outer surface of the filter 806 thereby generally forming a ring about a portion of the filter 806 which is used to scrub or clear debris away from the outer surface of the filter 806.

It should be understood that in alternate embodiments, the scrubber 840 may take a variety of different shapes and sizes. For example, in an alternate form, the scrubber 840 may be configured as a cylinder or cylindrical sleeve having a plurality of openings therein to allow fluid to flow through the scrubber 840 and to the filter 806. In other forms, the scrubber 840 may, itself, serve as a first form of filter that surrounds filter 806 and scrubs filter 806 in a manner similar to that discussed above (e.g., by having a distal end engage an outer portion of filter 806 and clean filter 806 as it moves between its open and closed position). In still other forms, the scrubber 840 may be anchored to valve body 200, but be capable of rotating with respect to the valve body 200 and/or filter 806 to provide a rotational scrubber that cleans filter 806 as it moves between its open and closed position. For example, a turbine may be associated with the scrubber 840 to rotate the scrubber 840 as it cleans the exterior surface of the filter 806. Additional concepts, such as the governor or deceleration concept disclosed in the '934 patent are also incorporated herein by reference.

In a preferred form, the distal end 806a of the filter 806 is tapered, rounded or curved and the distal end of the scrubber fingers 842 are tapered or bell-mouth shaped (“bell-mouthed)”) to assist the valve assembler in guiding the filter 806 into the scrubber 840, which is a blind assembly process. This configuration also assists in re-installing the filter 806 into scrubber 840, such as when servicing the valve assembly 100 and re-installing or replacing any of the main valve components (e.g., filter 806, diaphragm assembly 700, bonnet 300, flow control assembly 546, etc.) as will be discussed further below.

The flow-control assembly 500 permits adjustments to be made to the flow rate of fluid through the diaphragm valve 100. The flow-control assembly 500 accomplishes these adjustments by controlling the maximum spacing between the diaphragm assembly 700 and the diaphragm valve seat 224 when the diaphragm valve 100 is in its open position, and more particularly the maximum spacing and flow area between the diaphragm seal 706 and seat 224. Increasing the maximum spacing between the seal 706 and the diaphragm seat 224 will increase the maximum flow rate through the opening 228 of the diaphragm valve seat 224, while decreasing the maximum spacing between the seal 706 and the diaphragm valve seat 224 will comparatively decrease the maximum flow rate through the opening 228 of the diaphragm valve seat 224. In this manner, the flow rate of fluid through the diaphragm valve 100 can be adjusted by a user according to the requirements of the irrigation system in which the diaphragm valve 100 is installed.

The flow-control assembly 500 includes a translatable stop member or piston 520, a rotatable drive cylinder or stem 560 and the flow-control handle 502. The flow-control handle 502 is positioned on the outside of the bonnet 300, on a side of the bonnet 300 opposite the control chamber 304 formed between the bonnet 300 and the diaphragm assembly 700. The stop member 520 has a first generally cylindrical portion 520a of a reduced diameter and a second generally cylindrical portion 520b of a larger diameter, with a ledge or shoulder 520c formed therebetween. In the form illustrated, the inner cylindrical portion 520a is disposed at least partially within the outer cylindrical portion 520b and has an internally threaded bore 522.

The stop member 520 is positioned such that the outer cylindrical portion 520b is disposed in the larger diameter opening 316 of the dome-shaped portion 308 of the bonnet 300 and the inner cylindrical portion 520a is disposed in the intermediate diameter opening 318 of dome-shaped portion 308. The drive cylinder 560 is partially positioned in the internal bore 522 of the stop member 520 and extends through an intermediate diameter opening 318 and a small diameter opening 315 in the dome-shaped portion 308 of the bonnet 300 and to the outer surface of the bonnet 300. Rotation of the flow-control handle 502 causes rotation of the drive cylinder 560 but not movement along its axis. Rotation of the drive cylinder 560 causes the stop member 520 to translate along its axis but not to rotate relative to the bonnet 300 due to external protrusions or ribs extending from the drive cylinder 560 that mate with corresponding grooves or channels in tongue-and-groove like fashion on the inner surface of dome portion 308 of bonnet 300 to align and/or guide the stop member 520 and prevent it from rotating as drive cylinder 560 is rotated. An example of this can be seen in the '934 patent which is incorporated herein by reference.

In this manner, rotation of the flow-control handle 502 selectively adjusts the position of the stop member 520, and in particular the position of a stop surface 524 of the stop member 520 in the control chamber 304 without raising and lowering handle 502 with respect to bonnet 300 thereby making this a non-rising type flow-control which is desirable when trying to maintain the profile, height and footprint of a valve to fit certain applications. When the diaphragm assembly 700 abuts the stop surface 524, the assembly 700 is in its maximum open position for that flow control assembly setting. Thus, by adjusting the position of the stop surface 524 using the flow-control handle 502, the maximum open position of the diaphragm assembly 700, and therefore the maximum spacing and flow area between the diaphragm seal 706 and the valve seat 224, can be controlled. For example, the stop surface 524 can be placed closer to the valve body 200 and diaphragm assembly 700 (e.g. away from the bonnet 300) to reduce flow through diaphragm valve 100 or further from the valve body 200 and diaphragm assembly 700 (e.g., towards the bonnet 300) to increase flow through valve 100.

As mentioned above, the drive cylinder 560 is partially positioned in the internal bore 522 of the stop member 520 and extends through the larger diameter opening 316, intermediate diameter opening 318 and small diameter opening 315 in the dome-shaped portion 308 of the bonnet 300 and to the outer surface of the bonnet 300. An intermeshing end 570 of the drive cylinder 560 extends through the opening 306 of the bonnet 300. The intermeshing end 570 has at least one flat that aligns and mates with a corresponding flat in the opening 504 of the flow control handle 502 so that rotation of the handle 502 results in rotation of the drive cylinder 560. In the form illustrated, the end 570 actually has two flats located on opposite sides of the intermeshing end 570, which align and mate with corresponding flat structures in the opening 504 of handle 502. Having two flats gives the intermeshing end 570 a generally square cross-section that mates with a corresponding square cross-section in opening 504 of the flow-control handle 502 so that rotation of the flow-control handle 502 causes the drive cylinder 520 to rotate.

An annular groove 578 is positioned on the drive cylinder 560 and contains a seal, such as an o-ring or quad ring 580, that engages the intermediate diameter portion 318 of the opening 306 of the bonnet 300 to reduce, and ideally prevent, leakage of fluid there past. In the form illustrated, the ceiling 578a of annular groove 578 abuts the shoulder formed between the intermediate diameter opening 318 and the smaller diameter opening 315. This abutment prevents the handle 502 and drive cylinder 560 from extending further out of the domed-portion 308 of bonnet 300. Conversely, the drive cylinder 560 is prevented from falling into the central opening 306 of bonnet 300 via a fastener, such as screw 561, which connects the flow-control handle 502 to the intermeshing end 570 of drive cylinder 560. More particularly, an internally threaded bore 572 extends though the intermeshing end 570 of the drive cylinder 560 and a fastener is threaded into the bore 572 to connect the handle 502 to intermeshing end 570 of drive cylinder 560 so that an operator may rotate the handle 502 and cause corresponding rotational movement of the drive cylinder 560 as desired.

As mentioned above, in alternate embodiments, the valve 100 may be provided with a bleed mechanism and/or a metering mechanism connected to the rotatable drive cylinder and extending through the central opening 306 of bonnet 300. An alternate embodiment of valve 100 will be discussed later herein having such a mechanism. In addition, an example of one form of bleed mechanism/metering device is disclosed in the '934 patent incorporated herein.

Turning back to FIGS. 1A-G, the drive cylinder 560 includes external threads 564 that mate with internal threads 523 formed on the internal bore 522 of the stop member 520. When the flow-control handle 502 is rotated it drives the drive cylinder 560 for rotation as well. The rotation of the drive cylinder 560 causes the stop member 520 to translate due to the engagement between the external threads 564 on the drive cylinder 560 and the internal threads 523 on the stop member 520. As mentioned above, the thread to thread engagement between the stop member 520 and the drive cylinder 560 would typically cause the stop member 520 to rotate. Such rotation is prevented, however, by use of mating structures between the bonnet 300 and the stop member 520. For example, in the form illustrated the stop member 520 has projections, such as ribs, that extend into mating recesses defined by the dome 308 of bonnet 300 to prevent rotation of the stop member 520 and guide the stop member 520 as it translates between its upper and lower limits of travel (e.g., maximum diaphragm opening and minimum diaphragm opening). More particularly, a tongue and groove type relationship is formed between the stop member 520 and the larger diameter opening 316 of central opening 306 of bonnet 300. The engagement between the locking ribs of the stop member 520 and the mating grooves or recesses in the larger diameter portion 316 of the opening 306 of the bonnet 300 prevent the stop member 520 from rotating. Thus, rotation of the flow-control handle 502 causes the stop member 520 to translate either further into or away from the control chamber 304, and thereby permits selective positioning of the stop surface 524 of the stop member 520 to selectively control the flow area between the seal 706 and the valve seat 224 to control the flow rate of fluid through the diaphragm valve 100.

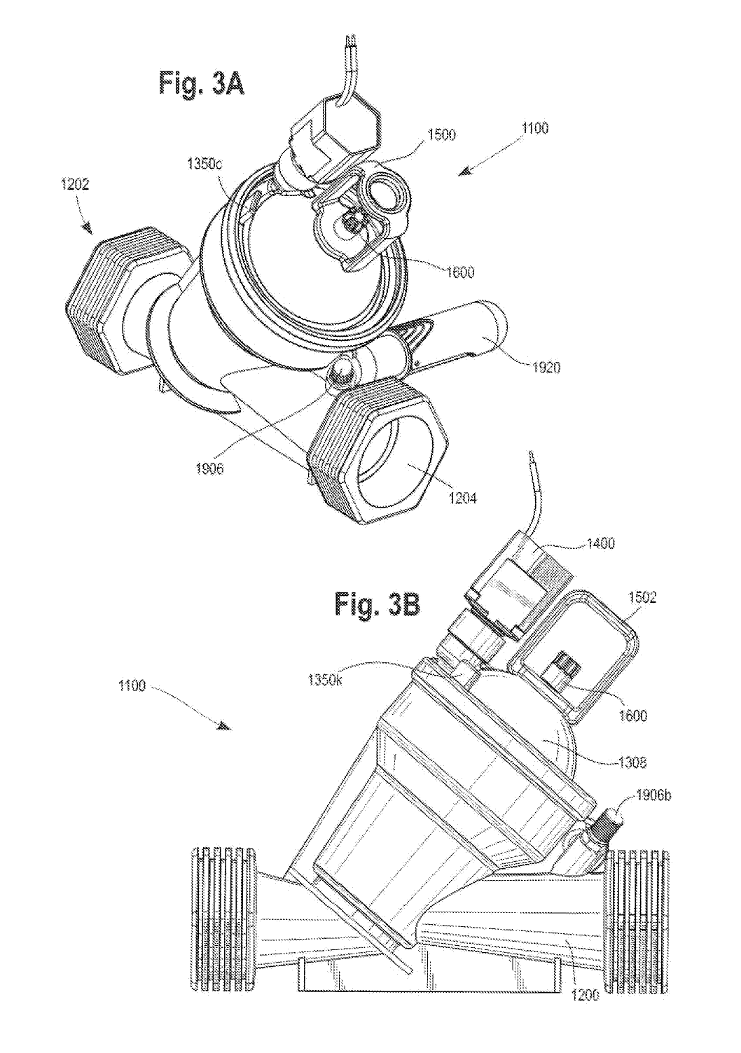

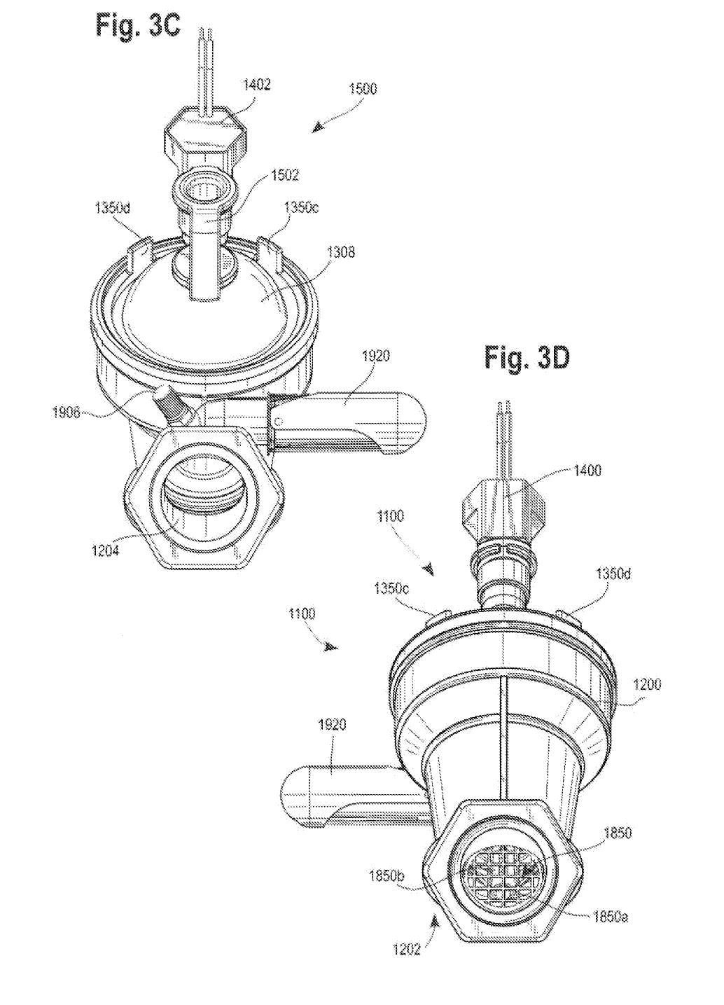

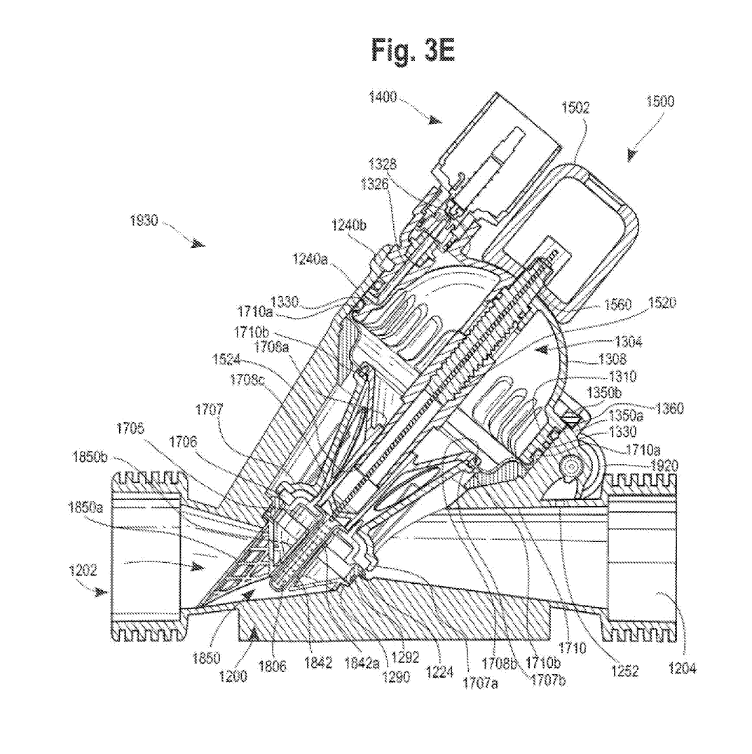

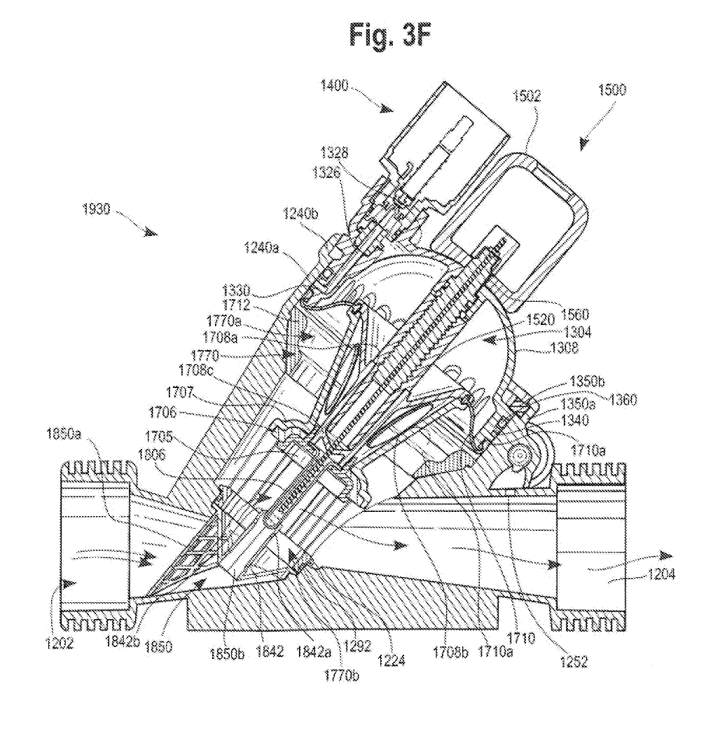

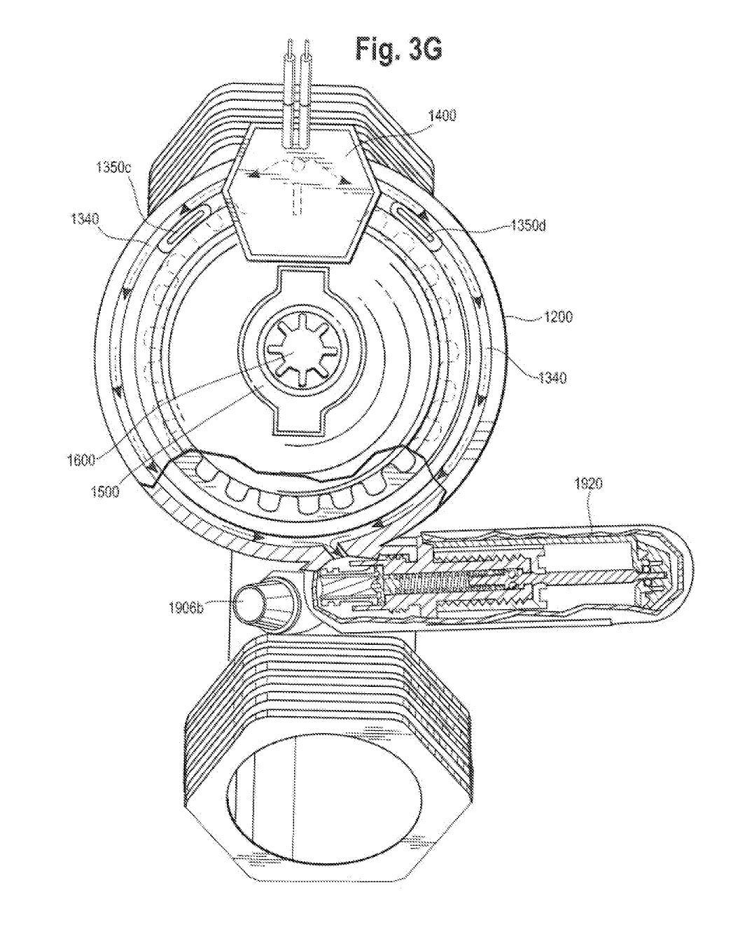

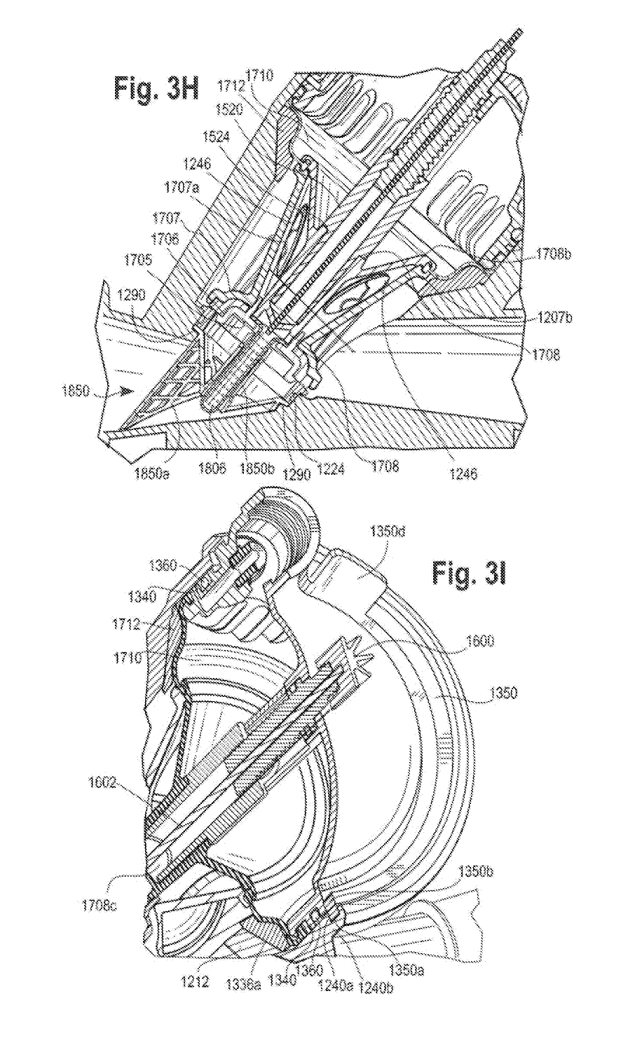

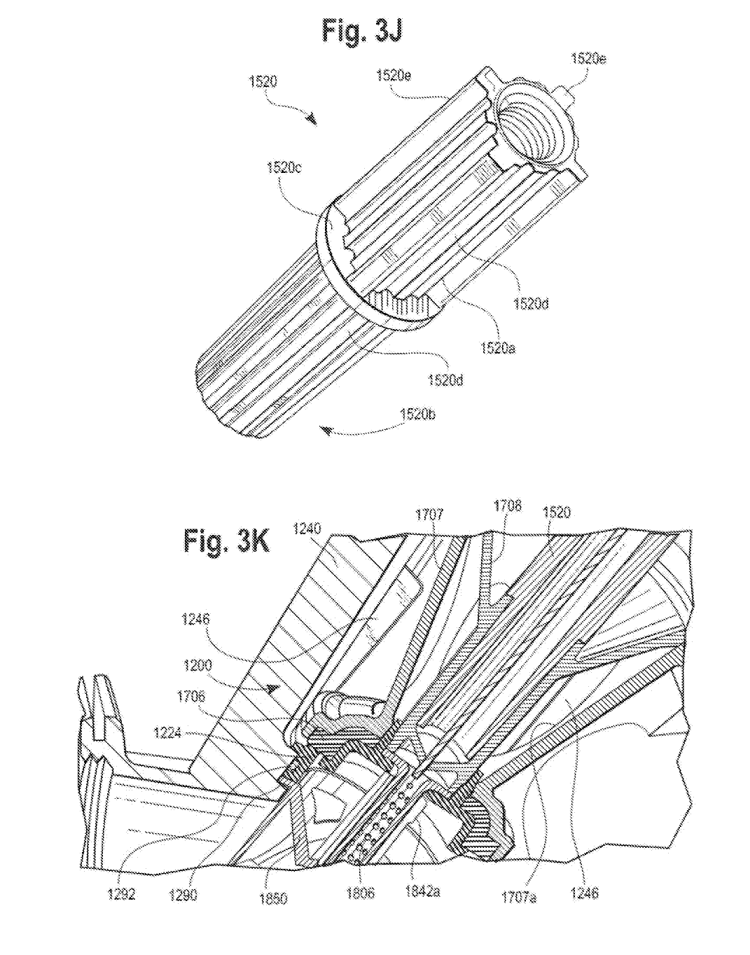

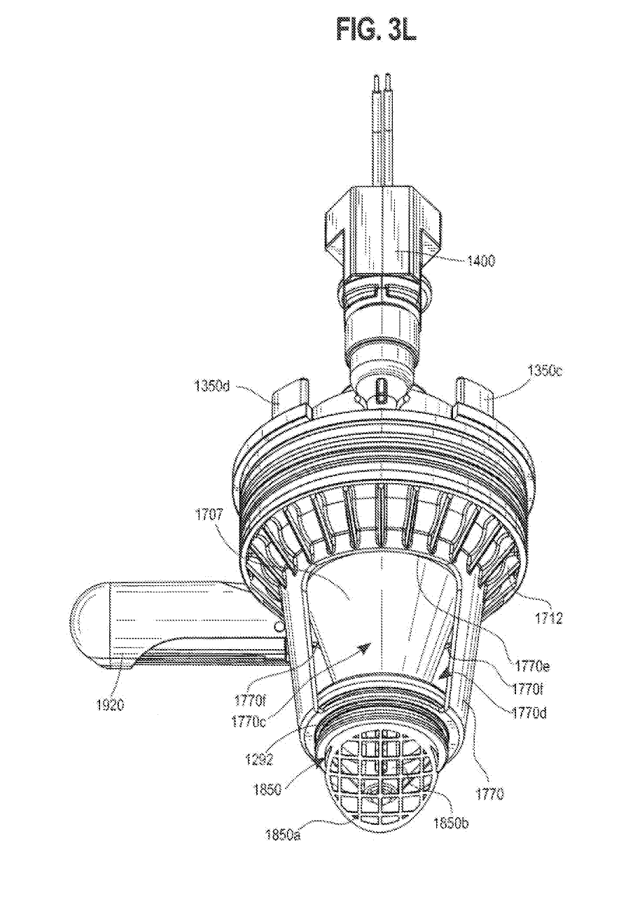

As will be discussed further below with respect to the embodiment of FIGS. 3A-K, the grooves or recesses may be sized for extra clearance with the ribs to permit fluid flow through the gaps or spaces created between these structures, which can provide an escape path for grit that might otherwise wedge in the grooves or recess and otherwise interfere with the ribs ability to travel linearly through the channels defined by the grooves or recesses. The mating structures may further have rounded portions to reduce stress concentrations. This can advantageously result in reduced structural requirements of the bonnet 300, which can in turn reduce the time it takes to produce the bonnet 300 and costs associated with same. It should also be understood that in alternate embodiments the position of the ribs and mating recesses may be swapped (i.e., ribs on bonnet 300 and mating grooves or recesses on stop member 520) and in still other embodiments, combinations or ribs and grooves may be located on both the bonnet 300 and stop member 520. In still other forms, the stop member 520 and bonnet 300 may be configured with complimentary shapes that prevent rotational movement. For example, the stop member 520 may have a shape with at least one flat side (e.g., round with a flat, triangular, rectangular, etc.) that fits into a central opening of the bonnet that corresponds in shape and prevents the stop member 520 from rotating when the drive cylinder 560 is rotated.

Turning back to FIGS. 1A-G, opening and closing the diaphragm valve 100 is performed by unblocking and blocking the control chamber exit passage 250 which vents fluid from the control chamber 304 to the outlet 204. Assuming the valve 100 starts in a closed condition, when an electrical current is sent to the solenoid 400, the solenoid 400 actuates and permits fluid to flow between the control chamber 304 and the outlet opening 204 of the valve body 200 via exit passage 250, thus venting the control chamber 304 to the pressure of the outlet opening 204. When electrical current is first started, there is only atmospheric pressure at the outlet opening 204, the pressure in the control chamber 304 drops to near atmospheric. At that point, the generally much higher fluid-supply pressure acting on the bottom of the diaphragm assembly 700 through the inlet opening 202 of the valve body 200 urges the diaphragm assembly 700 off the valve seat 224, thus allowing fluid flow through the opening 262 of valve seat 224 and to the outlet 204. A typical irrigation system is generally at atmospheric pressure when the electrical current is sent to the solenoid valve 400. At that time, the pressure in the control chamber 304 does not exert sufficient resistance as compared to the incoming fluid acting on the other side of the diaphragm assembly 700. As a result, the diaphragm assembly 700 may rise to the mechanical limit set by the flow-control stop member 520.

However, once the irrigation system fills and pressurizes, the difference in pressure between the inlet 202 and outlet 204 of the diaphragm valve 100 can be limited to the valve characteristic pressure drop at the flow rate allowed by the irrigation system. At that point, the higher pressure at the outlet 204 will increase the pressure in the control chamber 304 because of the fluid connection between the outlet 204 and the control chamber 304 through the control chamber exit passage 250. The increased pressure will drive the diaphragm assembly 700 downward toward the valve seat 224 until a balance is achieved between the force exerted on the bottom of the diaphragm assembly 700 by the fluid flowing through the valve 100 and that acting on the top of the diaphragm assembly 700 by the fluid in the control chamber 304. The valve 100 will stabilize in this equilibrium position until the electrical current to the solenoid 400 is interrupted to allow the valve 100 to close.

When the electrical current to the solenoid actuator 400 ceases, the solenoid 400 closes and blocks fluid flow from the control chamber 304 to the outlet 204. High-pressure fluid upstream of the diaphragm assembly 700 is still feeding high pressure fluid into the control chamber 304 through the control chamber inlet path 230. Because there is nowhere for the high-pressure fluid to go, pressure in the control chamber 304 rises to nearly the high incoming line pressure. Due to the increased area of the diaphragm assembly 700 facing the control chamber 304 as compared to the opposite side thereof, the force is no longer in equilibrium and the diaphragm assembly 700 descends until the diaphragm seal 706 abuts against the valve seat 224 to block fluid flow between the inlet 202 and outlet 204 of the diaphragm valve 100.

The solenoid actuator 400 is mounted in socket or seat 324 located on the peripheral flange 336 of the bonnet 300. The solenoid housing 402 encloses a winding surrounding a portion of a plunger sleeve. When electrical current is passed through the winding, the plunger is drawn within the plunger sleeve against the biasing force of a spring to withdraw a plunger seal connected to the plunger from sealing the exit passage 250 that extends from the control chamber 304 to the outlet passage 204 of valve 100 so that fluid can flow from the control chamber 304 to the outlet passage 204 thereby allowing the diaphragm 700 to move from the closed position to the open position and allow fluid to flow through valve 100.

More particularly, in the embodiment illustrated in FIGS. 1A-G, the control chamber inlet passage comprises the inlet passage 230 from the inlet 202 to the control chamber 304, which in the embodiment illustrated is defined by filter 806, filter support 702, and seal support cup 704 which allows fluid to flow in from the inlet passage 202 through filter 806 and into cup 704 and above the diaphragm assembly 700. The control chamber outlet passage 340 (as best illustrated in FIGS. 1E-G) comprises the channel from the control chamber 304 to the outlet 204 defined by first bonnet passage 328, solenoid 400, second bonnet passage 326, third passage 340 created by the mating of the bonnet 300 to the valve body 200 (or more particularly the groove in the body 200 that is capped by the distal end or bead 710a of diaphragm web 710, and valve body passage 252. Thus, when the solenoid 400 is actuated, fluid is allowed to flow out from the control chamber 304 via passage 328, into a pool or reservoir chamber located in the lower portion of solenoid 400, down from the solenoid 400 via passage 326 and into the generally circular or peripheral passage 340 defined between (and by) the lower rim of bonnet 300 and upper rim of valve body 200, and into the outlet passage 204 via opening 252.

In alternate embodiments, the outlet passage 340 may be defined by any combination of the bonnet 300, diaphragm web 710 and valve body 200, or by any one of these on its own without the others. For example, in the form illustrated in FIGS. 1A-G, the peripheral outlet passage or dump 340 is defined by a peripheral groove or recess in an upper surface of the valve body 200, which is sealed by the distal end 710a of diaphragm web 710 when sandwiched or compressed between the bonnet 300 and the valve body 200 after those items are fastened to one another. In an alternate embodiment, the peripheral dump 340 may be defined by a groove in a lower surface of the bonnet 300 and sealed by the distal end 710a of diaphragm web 710 when the bonnet 300 and valve body 200 are connected to one another. In still other embodiments, and as will be discussed below with respect to FIGS. 3A-L, the peripheral dump 340 may be defined by an annular wall member extending down from the bonnet 300 and the valve body 200 when the bonnet 300 is secured to valve body 200.

With the configuration illustrated in FIGS. 1A-G, the fluid that is allowed to fill-up the control chamber is filtered using a conveniently replaceable filter cartridge 806 that is coaxially aligned with the central opening 306 and diaphragm assembly 700. This allows the main valve assembly to be easily removed from the valve body 200 with bonnet 300. To further improve the ease of installing or re-installing the main valve assembly as well as the operation of the diaphragm valve 100, the valve body 200 may include cooperating guide structures for guiding the diaphragm assembly 700 (and thereby the filter 806) into the internal passage defined by the valve body 200. For example, in the form illustrated, the body 200 includes guide structures such as ribs 246 (as can best be seen in FIGS. 2E-F) which cooperate with an outer or exterior surface of the diaphragm assembly 700 to guide the diaphragm assembly 700 back into the internal passage of the valve body 200 and between its movement from the open and closed positions. The primary function of these guides (e.g., the ribs 246 and exterior surface of diaphragm assembly 700) is to assure concentricity and/or maintain proper alignment between seal 706 and seat 224 so that the diaphragm valve 100 opens and shuts as desired. More particularly, the ribs 246 extend from the inner surface of annular wall 240 of valve body 200 toward the diaphragm assembly 700 and guide the diaphragm assembly 700 as it moves up and down between the open and closed positions. The ribs preferably provide just enough clearance for the diaphragm assembly 700 to easily move between the open and closed positions.

In another embodiment, the ribs 246 may be tapered to assist with the initial insertion of the diaphragm 700 assembly (and, thus, filter 806) and help guide the assembly into valve housing 200 and, in particular, help guide the filter 806 into scrubber assembly 840. As mentioned above, in a preferred form, the distal end 842a of scrubber fingers 842 are tapered or bell-mouthed to further assist in guiding the filter cartridge 806 into the scrubber assembly 840. During operation of the valve 100, the scrubber 840 further assists in cleaning the filter 806 and thereby ensuring that the fluid used to fill the control chamber 304 remains clean and free of debris that could hamper the performance of the diaphragm (e.g., such as by clogging the control chamber exit passage or preventing the diaphragm from being able to move to its fully open position, etc.). Having the scrubber assembly 840 anchored on the bottom of the valve body 200 further helps maintain proper alignment of the valve components within the bonnet 300 and valve body 200 (e.g., filter 806, diaphragm assembly 300, etc.) and keeps the valve operating as desired while it cycles from on and off. Thus, the diaphragm assembly 700 remains well guided during its travel between the open and closed positions via guide ribs 246 and via the guidance the scrubber assembly 840 provides for filter 806 as the diaphragm causes the filter to move up and down within the scrubber assembly 840. This helps keep the diaphragm valve operating as desired, but also makes the valve 100 easier to service because a user can now remove the internal components of the valve 100 to access the filter 806, diaphragm 700 (and in particular the seal 706), valve seat 224 and scrubber 840 (which in some forms is also removable) so that these items can be easily inspected, cleaned and reused, and/or replaced without the need to remove the valve body 100 from the remainder of the irrigation system (e.g., without the need to cut the valve 100 from the piping it is connected to). This top serviceable nature of the diaphragm valve 100 solves many of the above-mentioned problems with respect to conventional valves.

The canted nature of valve 100 and, in particular, inlet passage 202 and dividing wall 214 further reduces the chance that debris will rest on the valve seat 224 and prevent the diaphragm from moving to its fully closed position when desired (a significant problem for any valve). This canting of the valve 100 also assists in reducing the amount of pressure loss experienced by the fluid flowing through the valve 100 and, thus, allows for a higher maximum pressure rating for the valve 100. For example, in the embodiment illustrated, a double digit percentage reduction in the pressure loss for the diaphragm valve 100 can be achieved over some conventional upright valves and the valve 100 can be used for applications requiring a maximum pressure of 220 psi for the valve, if not more. In addition to this, the valve 100 is easier to assemble and easier to service.

In other embodiments, additional items or accessories may be added to the diaphragm valve 100 in order to further assist in making the valve 100 easier to install and/or service. For example, as illustrated in FIGS. 2A-C, seal clamps 902 and 904 may be used to ensure a good fluid connection is made between the valve input and output 202, 204 and the sections of pipe to which the valve 100 is connected. In the form illustrated, the seal clamps include two clamshell halves 902a, 902b and 904a, 904b, respectively, and seals, such as O rings 902c, 904c. Each clamshell halve 902a, 902b and 904a, 904b has a generally C-shaped structure with flanged ends defining openings through which fasteners, such as bolts or screws may be disposed or thread, and a channel within which the pressure-activated u-channel seals 902c, 904c are disposed. The clamshells preferably position the seals 902c, 904c directly over the joint between the items the clamps 902, 904 are connecting. In one form, one of the ends of the clamps 902, 904 further defines a projection or tooth 902d, 904d which mates with a corresponding recess in the items the clamps are being connected to. For example, in the form illustrated, the clamp 902 is connected to an integrated shutoff valve assembly, such as ball valve 906, such that tooth or rim 902d engages an annular recess 906a on the inlet end of the shutoff valve assembly 906. On the other end, clamp 904 is connected directly to valve 100 and the tooth or rim 904d engages an annular recess 100a in the outlet end of valve 100. This further assists in securing the two items together and prevents separation of the items connected by clamps 902, 904 when the system is put under pressure.

The clamps 902, 904 further greatly assist with the installation and/or removal/re-installation of valves because they allow the valve 100 to simply and easily be pulled out of connection with the items it is in fluid communication and/or dropped in and connected or re-connected to the items it is in fluid communication with. This cannot be done with conventional valves because the items the valves are connected to are typically threaded into the valve's inlet and outlet passages (e.g., conventional NPT engagement) or threaded onto (e.g., using conventional union fitting engagements). Thus, clamp accessories 902, 904 greatly improve the ease of installation, replacement, and serviceability of the valve 100.

The shutoff valve accessory 906 further improves the ease of serviceability of the valve 100 and accessories in that it allows isolation of the supply pressure from the valve 100 in order to perform work on the valve 100 or other downstream components without the need to go to an upstream branch valve or system valve, and further includes a port, such as Schrader valve 906b, which allows fluid, such as air, to be bled from the system upstream of the valve 100 and can be connected to a hose or other conduit to provide a pressurized cleaning source for cleaning off the valve 100 or other accessories when installing and/or servicing these items. For example, when installing valve 100, the person performing this task will likely wish to bleed the upstream line of any air in order to prevent this air from working its way into the valve 100 and hampering the performance of the diaphragm assembly 300 (particularly in cases where there is no bleed mechanism on the valve itself). The installer or servicer may also wish to use the Schrader valve 906b in order to test line pressure, etc. As another example, the installer or servicer may wish to hook-up a hose to the Schrader valve 906b in order to give themselves a water source to spray off, clean or flush the valve 100, clamps 902, 904, pipe to which these items may be connected, or any other item they wish to clean, such as the valve box within which these items may rest, etc. Although the form illustrated shows the shutoff valve accessory 906 being an integral part of valve 100, it should be understood that in alternate embodiments any one or more of these features may be integrated into a diaphragm valve assembly or, alternatively, they may all be provided as accessories capable of being used with any of the diaphragm valves discussed herein.

Turning now to FIGS. 3A-L, there is illustrated an alternate valve according to the invention disclosed herein, including an integrated flow-control assembly, bleed mechanism, pressure regulator and Schrader valve, in addition to other items and features. For convenience, this embodiment will use the same reference numerals for similar items as those mentioned above with respect to valve 100, but with the addition of a prefix “1” just to distinguish one embodiment from another. Thus, in FIGS. 3A-L, the valve will be denoted using reference numeral 1100, valve body using reference numeral 1200, bonnet using reference numeral 1300 and so on. This disclosure will also focus on the items that differ from valve 100 rather than repeat a discussion of other common features and items to avoid redundancy.

As mentioned above, the valve 1100 includes a non-rising flow-control assembly 1500, an integrated bleed/metering mechanism 1600, pressure regulator 1920, Schrader valve 1906b, and solenoid actuator 1400. Before discussing these clearly visible items, however, four not-so-visible items will be discussed, including the bonnet quick release mechanism 1350, integrated filter and scrubber assembly 1850, the integrated internal valve component assembly 1930 and alignment guides 1246.

As best illustrated in FIGS. 3A-B, E, F and I, the valve 1100 includes a bonnet quick release mechanism, such as snap ring 1350, which can be used to quickly and easily remove or secure the bonnet 1300 to valve body 1200. In the form illustrated, valve body 1200 includes an upstanding annular wall or collar portion 1240a that forms a recessed inward-facing C-shaped channel 1240b near the distal end of collar 1240a. The lower inner surface of the inward-facing C-shaped channel 1240b is generally coplanar with the upper surface of the bonnet flange 1336, however, the bonnet flange 1336 further includes a projection, such as annular dimple or ridge 1336a. In this regard, the inward-facing C-shaped channel 1240b captures an outer peripheral end 1350a of ring 1350 and the annular ridge 1336a secures or traps the opposite end or inner end 1350b of ring 1350 to capture ring 1350 and secure the bonnet 1300 to the valve body 1200.

The snap ring 1350 itself has a notch in it to form a C shaped ring structure and further includes gripping portions, such as upstanding handles 1350c, 1350d on opposite distal ends of ring 1350. Thus, when an installer or servicer wishes to remove bonnet 1300, he or she simply needs to pinch or push handles 1350c, 1350d toward one another to pop the distal ends of ring 1350 out of the channel formed by inwardly-facing C-shaped channel 1240b and annular ridge 1336a. Then the installer and servicer can continue to pull the remainder of ring 1350 out of this channel and remove the bonnet 1300 from the valve body 1200. This configuration allows the installer or servicer to quickly release the bonnet 1300 from the valve body 1200 without the need for tools and, thus, eases installation and serviceability of the valve 1100 because no fasteners (e.g., bolts) need to be undone or done to remove or install the bonnet 1300. Like bonnet 300 above, bonnet 1300 is a spherical design which minimizes stress for a given wall thickness and allows the bonnet to be made with minimal material yet still provide acceptable stress levels, thereby making the valve 1100 less expensive to make and lighter. The spherical shape also facilitates bleeding from the truly highest point in the bonnet, which will be discussed further below.

As illustrated best in FIGS. 3E, F, H and K, the valve 1100 further includes an integrated debris screen and scrubber assembly 1850 which is seated in the lower portion of valve body 1200 between inlet passage 1202 and valve seat 1224. In the form illustrated, the filter is sandwiched between the valve seat 1224 and an internal annular ledge 1290, adjacent valve seat 1224. The valve seat 1224 is further sealed to valve body 1200 via O-ring seal 1292. Thus, with this configuration the debris screen and scrubber assembly 1850 is retained in the valve body 1200 via the main valve seat 1224 and diaphragm support 1712 (which are also removable thereby allowing the debris screen to be serviceable). In FIG. 3L, the integral valve seat 1224 and diaphragm support 1712 member and other internal valve components are illustrated removed from the valve body 1200 to show an exemplary embodiment of how these items may be structured. For convenience, the integral seat and diaphragm support structure will be referenced in general by reference numeral 1770 and reference numerals 1224 and 1712 will be used for specific discussions about the role this integral component plays as the valve seat and diaphragm support, respectively.

In the form illustrated, the integral seat and diaphragm support structure 1770 has a general cone shape, such as a frustum or frustoconical shape, with a first (or upper) opening 1770a of a first diameter and a second (or lower) opening 1770b of a second diameter, which is smaller in diameter size than the first diameter. The integral structure 1770 further defines two large openings 1770c, 1770d on opposite sides of the cone-shaped body which provide gripping surfaces, such as lips 1770e, 1770f, which a person may use to grip and remove the integral structure 1770 from valve body 1200 as will be discussed further below. The upper opening 1770a is flanged and has a general S-shape cross-section (see FIGS. 3E-F) or at least an S-shaped surface facing the dish diaphragm 1710 to correspond in shape with the dish diaphragm 1710 so that when the diaphragm assembly 1700 is installed in the valve 1100 and in the closed position, the dish diaphragm 1710 rests against the diaphragm support 1712 of integral seat and support structure 1770 to support the diaphragm and/or prevent stretching of the dish diaphragm 1710.

The integral valve seat 1224 is located on the opposite end of the cone-shaped body and forms the lower opening 1770b which is disposed in a corresponding circular opening or recess 1290 defined by the valve body 1200. The circular valve seat 1224 has a generally C-shaped cross section and defines a recess, such as a channel, that opens toward the side wall of corresponding circular opening 1290 and receives a seal, such as O-ring 1292, which seals the lower portion of the integral structure 1770 (i.e., valve seat 1224 and diaphragm support 1712) into the valve body 1200. In a preferred form, the valve seat 1224 and recess 1290 are sized to create a friction fit between the valve seat 1224, seal 1292 and recess 1290. The upper portion of the integral valve seat 1224 and diaphragm support 1712 is preferably friction fit into an upper portion of the integral passage defined by the valve body 1200, however, in alternate embodiments this portion of the integral structure 1770 may be designed with a clearance fit if desired.

Thus, with this configuration, the interconnected internal components of the diaphragm valve such as the bonnet 1300, diaphragm assembly 1700, filter assembly 1800 (if present), flow control mechanism 1500 (if present), and bleed or metering mechanisms 1600 (if present) can be removed together as an interconnected unit 1930 to allow these items to be serviced (e.g., installed, removed, cleaned and reinstalled, replaced, etc.). In addition, however, this configuration also allows the integral valve seat 1224 and diaphragm support 1712 to be removed from the valve housing 1200 as well as the integral scrubber and debris screen assembly 1850 so that these items can be serviced as well. For example, once the initial internal valve components are removed, the integral valve seat 1224 and diaphragm support 1712 can be removed by grasping the openings 1770c, 1770d defined by the sides of the cone-shaped structure (in particular the upper lips 1770e, 1770f created by openings 1770c, 1770d) and pulling the integral valve seat 1224 and diaphragm support 1712 assembly out of the valve body. Then the integral scrubber and debris screen 1850 can be pulled out of the valve housing and serviced. Thus, this configuration allows easy access to all internal components of the valve 1100.

When reinstalling the serviced components, the integral scrubber and debris screen 1850 may first be inserted into the corresponding circular shaped opening 1290 defined by the valve body 1200 with the screen 1850a projecting into the inlet 1202 to block debris from traveling through the inlet 1202 and/or further downstream through the valve 1100. Then the integral valve seat 1224 and diaphragm support 1712 is inserted with the O-ring being positioned in the corresponding circular shaped opening defined by the valve body, which sandwiches or captures the integral scrubber and debris screen in the corresponding circular shaped opening defined by the valve body and seals the lower portion of the integral valve seat 1224 and diaphragm support 1712 into the valve body 1200. At the same time the upper portion of the integral valve seat 1224 and diaphragm support 1712 is friction fit into the upper portion of the internal passage of the valve body 1200. Then the remaining interconnected internal valve components 1930 may be inserted with the guide ribs 1246 and tapered/bell-mouthed structures 1842a helping to assist with the blind insertion of the filter 1806 into the scrubber portion 1850b of the integral scrubber and debris screen assembly 1850. As mentioned above, in alternate forms, the upper portion of the integral valve seat 1224 may alternatively be designed with a clearance fit if desired.

In a preferred form, however, all of the internal components of the valve (i.e., the interconnected components of unit 1930, the integral valve seat and diaphragm support structure 1770 and the integral screen and scrubber assembly 1850) (basically what is illustrated in FIG. 3L) may be connected to one another outside of the valve body 1200 and then inserted into the valve body 1200 and pressed in place to frictionally fit the integral seat and support structure 1770 in place, capture the integral screen and scrubber assembly 1850 and then the bonnet 1300 may be secured to the valve body 1200 (e.g., with fasteners such as bolts or snap ring 1350) to fully assemble the diaphragm valve 1100. Thus, this configuration not only allows for the ready servicing of all valve components, but also allows for quick initial assembly of the valve when it is manufactured/assembled and for quick re-installation of the valve components once the valve 1100 has been serviced. Although the actual valve has been described thus far, it should be understood that the improvements disclosed herein provide many new methods as well (e.g., methods of manufacturing and/or assembling a valve, methods of accessing various internal valve components, methods of servicing a valve, etc.).

Turning now, more closely to the integral debris screen and scrubber assembly 1850, the debris-screen portion 1850a catches debris before it can get hung-up on the valve seat 1224. Connected to the first filter member 1850a and, preferably integral thereto, is scrubber assembly portion 1850b. The scrubber assembly 1850b includes scrubber fingers 1842, like fingers 842 discussed above, which are used to scrub or clean the exterior surface of the pilot filter 1806 as it moves between open and closed positions with diaphragm 1700. In a preferred form and like valve 100 above, distal ends 1842a of scrubber fingers 1842 are tapered or bell-mouth openings and the distal end of filter 1806 are curved or domed to help aid in the insertion of filter 1806 into the scrubber assembly 1850b, which is done blindly. The end of filter 1806 will be capped in production as shown in FIGS. 3E-F, however, the filter 1806 could be uncapped in production so that the filter could be flushed or rinsed out after manufacturing to ensure the filter is clean or clear of any and all debris before being capped and installed in valve 1100.

Thus, as mentioned above, the valve of FIGS. 3E-F, H and K, includes an integrated internal valve component assembly 1930 which allows the solenoid 1400, flow-control assembly 1500, bleed/metering mechanism 1600, bonnet 1300, diaphragm assembly 1700, and filter 1806 to all be removed as one assembly simply by actuating the bonnet quick release mechanism 1350. In this way, the internal components of the valve can quickly and easily be removed from the valve body 1200 so that they can be checked, worked on or replaced. Similarly, the internal components can be quickly and easily installed or re-installed into valve body 1200 because they are all connected as one assembly thereby making the blind assembly of these items much easier to accomplish (particularly due to the tapered configurations of the filter 1806 and scrubber assembly 1850b as discussed above).

In the form illustrated, this integration of components as an assembly is achieved via a seal and filter support 1705 and a seal spacer 1707, which sandwich the seal 1706 and secure and align filter 1806. The seal spacer 1707 connects to the innermost end 1710b of dish diaphragm 1710, which is also connected to top diaphragm plate or diaphragm stop 1708. More particularly, distal ends 1707b of seal spacer 1707 and 1708b of diaphragm plate 1708 define an opening in which the innermost end or bead 1710b of dish diaphragm 1710 is captured. The other end 1710a of dish diaphragm 1710 is captured in an opening defined by the annular wall 1310 of bonnet 1300 that extends downward from the outer rim of dome-shaped portion 1308 and the inner surface of annular wall 1240a. Together, this bead 1710a and an additional O-ring seal 1360 seal the bonnet 1300 to valve body 1200. Support ring 1712 supports dish diaphragm 1710 in a manner similar to that discussed above regarding support ring 712.

In a preferred form, the diaphragm assembly 1700 is put together by placing the seal spacer 1707 over the seal rubber 1706 and that over the seal support 1705, and then sonic welding these items together at the joint between the seal support 1705 and the seal spacer 1707. Then the pilot filter 1806 is placed down into the assembly, the diaphragm stop 1708 is placed in the groove on top of the assembly, the dish diaphragm 1710 is placed into the assembly and the assembly is sonic welded again at the joint between the seal support 1705, the diaphragm stop 1708 and the innermost end 1710b of dish diaphragm 1710. In this way, a diaphragm support is provided that is molded integral with the main seal 1706 of valve 1100.

The bottom of diaphragm stop 1708, together with metering rod 1602, defines a metering annulus 1708c which will be discussed further below with respect to the bleed/metering mechanism 1600. On the side opposite the annulus 1708c, the diaphragm stop 1708 includes stop surface 1708a which engages corresponding stop surface 1524 of translatable stop member 1520. Together the seal spacer 1707 and diaphragm stop 1708 form a tapering funnel-like structure with a central opening through which at least a portion of the translatable stop member 1520 and metering rod 1602 are disposed. Guide ribs 1246 depending from the interior surface of the valve body 1200 hold the seal 1706 concentric to the seat 1224 as the valve closes to assure a good seal. The guide ribs 1246 also guide the assembly 1930 into the valve so the filter 1806 is easily inserted into the scrubber fingers 1850b upon the blind insertion of assembly 1930 into the valve body 1200.

In the form illustrated, the guide ribs 1246 extend from the inner surface of the valve body 1200 toward the internal passage within which the diaphragm 1300 moves between its open and closed position. The guide ribs 1246 may simply be used to make sure that the diaphragm 1300 and/or valve seal 1706 shuts properly (e.g., seal is concentrically or coaxially aligned with the seat 1224 and not askew or misaligned with the seat). Alternatively, in some forms the valve body and diaphragm may be provided with cooperating guide structures for guiding and aligning the diaphragm/seal during at least a portion of the diaphragm/seal movement between the open and closed positions. For example, although it is not the case with the depicted embodiment, the guide ribs 1246 of FIG. 3H could, in an alternate embodiment, be extend from the inner surface of the valve body toward the passage within which the diaphragm/seal moves between the open and closed positions and into a mating recess, such as opening 1707a. Thus, the mating recess 1707a forms a channel within which the guide ribs 1246 are at least partially disposed and travel to align the ribs 1246 and, thus, align the diaphragm seal with the valve seat. The opening 1707a could be designed with an oval shape with a wider middle portion that then tapers toward the top and bottom of the opening. This configuration would ensure that the rib 1246 easily enters into the opening 1707a because this occurs at the wider middle portion of the opening where there is a maximum amount of clearance between the rib 1246 and opening 1707a, but then the opening or channel 1707a gradually tapers so that as the diaphragm and valve seal approach their closed positions the rib 1246 is gradually aligned and guided into a specific or predetermined position so that the valve closes fully and properly (e.g., so that the seal is not misaligned with the seat which could lead to minor leaks).

It should be understood that in alternate embodiments, other cooperating structures may be used to guide and align the diaphragm/seal during movement between the open and closed positions. For example, other forms of protrusions and mating recesses may be used besides the ribs and openings shown (e.g., different shapes, sizes, locations, etc.). These other forms of cooperating structures may be configured so that the protrusions easily enter the mating recesses and are gradually guided into a final position like the embodiment discussed above with respect to FIG. 3H. However, in alternate forms, the cooperating structures may not have this configuration. For example, in some forms the cooperating structures may remain mated to one another (e.g., one inserted into the other, the items interlocked, etc.) so that the diaphragm and seal are continually being guided and aligned throughout movement between the open and closed position. Such as a tongue and groove arrangement where the tongue member stays inserted within the groove member but allows for linear movement between the diaphragm/seal open and closed positions. This configuration prevents axial movement or rotation of the diaphragm and seal, which may be desired in some applications.

In yet other forms, the cooperating structures may not interact with one another until the moment the diaphragm/seal is in its fully closed position and/or there may be no gradual guiding of the diaphragm/seal into its desired position. For example, in one form interlocking structures may be positioned such that they align the diaphragm/seal into position right as they are placed in their not disengage from one another like the above embodiment (e.g., the protrusion may always be disposed in the mating recess or channel so that only linear movement is allowed and no axial rotation or movement is allowed). In addition, in some forms, these cooperating structures may be reversed. For example, the diaphragm/seat may have protrusions and the inner surface of the valve body may define recesses within which at least a portion of the protrusions are disposed.

As with flow-control assembly 500 above, flow-control assembly 1500 is a non-rising type flow control and includes a handle 1502, drive cylinder 1560 and a translatable stop member 1520. The handle 1502 defines an opening 1504 through which the end of drive cylinder 1560 is disposed and the handle 1502 matingly engages the drive cylinder 1560 so that rotation of the handle 1502 results in a corresponding rotation of the drive cylinder 1560. However, unlike flow control assembly 500 above, the drive cylinder or stem 1560 is not attached to the handle 502 using a fastener that serves no other function, but rather is thread into the bleed cap 1604 of bleed/metering mechanism 1600 to secure the handle 1502 to the valve 1100 and the stem 1560 to handle 1502 and bonnet 1300.

Like assembly 500 above, the drive cylinder 1560 includes an annular groove 1578 and o-ring or quad-ring which seal the drive cylinder 1560 (and hence the flow-control assembly 1500) to the bonnet 1300. The end of the drive cylinder 1560 opposite the handle 1502 is threaded and disposed at least partially within translatable stop member 1520. In a preferred form, the threaded engagement with the flow control stem 1560 is just a few threads so that as dimensions vary over time in the production/molding process the threads do not bind up. In a preferred form, the threads are left-hand threads so that as the handle 1502 is rotated clockwise, top looking down, the piston will be driven down to close the valve (what a user's intuition would tell them to try).

The translatable stop member 1520 further includes a first generally cylindrical portion of a first diameter 1520a and a second generally cylindrical portion of a second diameter 1520b, with a ledge 1520c interconnecting the two cylindrical portions. However, unlike flow-control 500 above, the first cylindrical portion 1520a is larger in diameter than the second cylindrical portion 1520b instead of being the other way around. In addition, as illustrated in FIG. 3J, the translatable stop member 1520 includes grooves 1520d in its outer surface running the length of the member with the exception of shoulder member or ledge 1520c. These grooves 1520d provide channels for grit or debris to fall and be washed out of engagement between mating components of the valve 1100. In addition to the grooves 1520d, the translatable stop member 1520 includes four squared ribs 1520e which are disposed in mating channels 1314 which depend from the interior of the bonnet dome 1308 and serve to prevent rotation of the translatable stop member or piston 1520 so that rotation of handle 1502 simply translates into up and down movement of the stop member 1520 and not rotational movement as well. These guide channels depending from the interior of bonnet 1300 closely pilot and stabilize the stop member 1520.

As mentioned above and unlike valve 100, valve 1100 further includes a bleed/metering mechanism 1600. In the form illustrated, the bleed cap 1604 is thread onto the distal end of rotatable drive cylinder or stem 1560 and the flow-control handle 1502 fills the axial gap between the bottom of bleed cap 1604 and the top of bonnet dome 1308. The bleed cap 1604 is sealed to the flow control stem 1560 via O-ring 1606 and the threads of the distal end of flow control stem 1560 to which the cap 1604 is connected include a groove which provides a path for fluid to escape from the control chamber 1308 when a manual external bleed is performed. The cap 1604 further includes an internal recess coaxially aligned with the channel defined by the stem 1560, piston 1520 and annulus 1708c, within which metering rod 1602 is disposed. In addition, flow-control handle 1502 is designed with an opening 1502a located in the side opposite bleed cap 1604 which is large enough to allow the bleed cap and metering mechanism 1600 to be fully removed from valve 1100 so that the metering annulus can be flushed in the event of a clog. Thus, a self-cleaning pilot annulus is provided on an angled-seat valve. Furthermore, the shape of the flow-control handle 1500 allows the entire integrated internal valve component assembly 1930 to be removed from the valve body 1200 in two quick and easy steps (i.e., removal of the bonnet quick release mechanism 1350, and then removal of the assembly 1930). Once the assembly 1930 is removed, the seat 1224 can be removed, then the debris screen/scrubber 1850 can be removed, and any debris which was held by the debris screen can be removed. Thus, the valve components themselves are top-serviceable in as similar manner as a conventional canister filter.

The inlet passage to the control chamber 1304 and exit passage from the control chamber 1304 to the outlet passage 1204 are similar to those illustrated for valve 100. However, unlike valve 100, a portion of the outlet passage is formed by an o-ring and the diaphragm bead and the valve 1100 further includes a pressure regulator 1920 and a Schrader valve 1906b connected between the bonnet/valve body passage 1340 and the outlet passage 1204. As best illustrated in FIGS. 3E-G, fluid flows from the inlet passage 1202 to the control chamber 1304 by passing through the debris screen 1850a, into main filter 1806, and through diaphragm assembly 1700. Conversely, fluid flows from the highest point in the control chamber 1304 to the outlet passage 1204 via first bonnet passage 1328. This ensures that, in the case of a conventionally installed valve (horizontal, in a valve box) substantially all the air will be bled from the bonnet by the normal operation of the valve. The pilot flow proceeds to the solenoid reservoir 1416, second bonnet passage 1326, bonnet/valve body passage 1340, pressure regulator 1920/Schrader valve 1906b and finally out through the valve body outlet passage 1252. The pressure regulator 1920 is used to maintain constant outlet pressure regardless of inlet pressure fluctuations. In a preferred form, the pressure regulator 1920 and pressure-sense Schrader valve 1906b will take the form of the PRS-D Pressure Regulator cartridge made and distributed by Rain Bird Corporation of Azusa, Calif., but may take other forms as well. However, unlike conventional pressure regulators and pressure-sense Schrader valve assemblies which require the removal of the solenoid unit and installation of an additional sleeve member to which the solenoid, pressure regulator and Schrader valve are then attached (increasing the height of the valve assembly), in the form illustrated, the pressure regulator 1920 and Schrader valve 1906b are directly connected to the valve body 1200 via sockets molded therein. Molding these items into the valve body 1200 reduces the cost of implementation of these items for the end consumer and allows the valve 1100 to maintain a smaller profile which is desirable given the sometimes cramped environment in which they are installed such as valve boxes, etc. In a preferred form, the valve 1100 may either be provided with the pressure regulator 1920 and Schrader valve 1906b as an upgrade, or alternatively the valve 1100 may be provided as a more basic unit with simple sealed caps connected to the sockets where the pressure regulator 1920 and Schrader valve 1906b are connected.

The solenoid actuator 1400 will preferably be like solenoid 400 above and that disclosed in U.S. Pat. No. 7,694,394 (which has been incorporated herein by reference). However, in one form, the solenoid will be provided with a commercial-grade coil allowing the solenoid to work reliably at two hundred forty-two pounds per square inch (242 psi). When the solenoid 1400 is activated, fluid will flow from the control chamber 1304, through the solenoid and around the bonnet/valve body channel 1340 and into the pressure regulator 1920 and then into the outlet passage 1204 via valve body passage 1252 (or, if no Pressure regulator is present, directly from the bonnet/valve body channel 1340 to the outlet passage 1204 via passage 1252. Once the solenoid actuator is de-activated, fluid will stop flowing out the control chamber exit passage and the valve diaphragm assembly 1700 will eventually move to the closed position once the force on top of the diaphragm assembly 1700 surpasses the force being applied to the bottom side of the diaphragm assembly 1700. As with valve 100, the passage from bonnet 1300 to solenoid 1400 is positioned at or near the very top of the bonnet, thus when the solenoid 1400 is actuated any air in the bonnet 1300 is removed from the control chamber 1304 which gives more solid closing performance because the seat cannot bounce as easily upon closing when the incompressible water is pushing down on the diaphragm assembly.

With the valve configuration discussed herein, no hinged diaphragm is needed and the diaphragm stroke to active web outer diameter ratio is approximately thirty-one percent (31%). The diaphragm assembly is well guided from both the top and the bottom throughout its stroke due to all the guiding and alignment structures. In addition, using the method of assembling the valve 1100 as discussed above instead of the more conventional torque method provides the following improvements: (1) the diaphragm does not have to be lubricated (which not only can be messy but can also cause chemistry problems for the valve depending on the particular environment the valve is to be used in, such as with certain fertilizers, etc.); (2) the compression forces on the seal and diaphragm are much more predictable and reliable; and (3) given this better predictability and reliability, statistical process control can be used with this valve. Thus, not only does valve 1100 provide a valve that is easier to assemble and service, but it provides a valve that is more reliable and easier to use for the end user.

It should be appreciated that in alternate embodiments, bleed cap and metering assembly 1600 may take many different forms. For example, U.S. Pat. Nos. 6,079,437 (issued Jun. 27, 2000), 7,552,906 (issued Jun. 30, 2009) and 7694934 (issued Apr. 13, 2002) disclose alternate bleed caps and metering mechanisms and are hereby incorporated herein by reference in their entirety. It should also be understood that the illustrated embodiment of FIGS. 3A-K is not the only way to practice what has been disclosed herein. For example, in alternate embodiments, various pipe attachment options may be provided such as by replacing the female NPT fittings shown with BSP threads, male threaded inlet/outlet attachments, slip by slip attachments, etc. Further, accessories such as the clamps and shutoff valves discussed above may be used in conjunction with valve 1100 (or 100 for that matter).

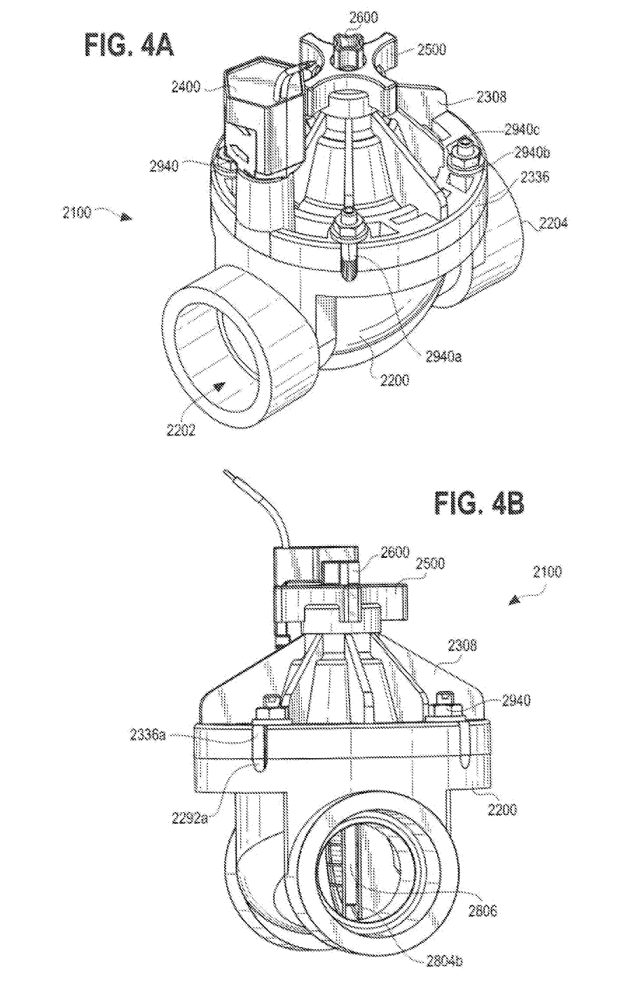

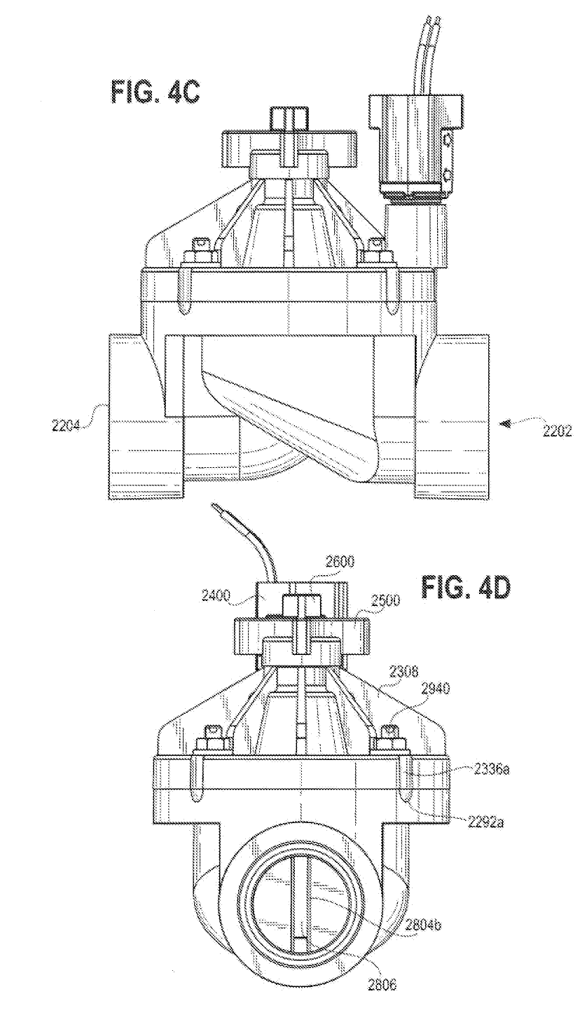

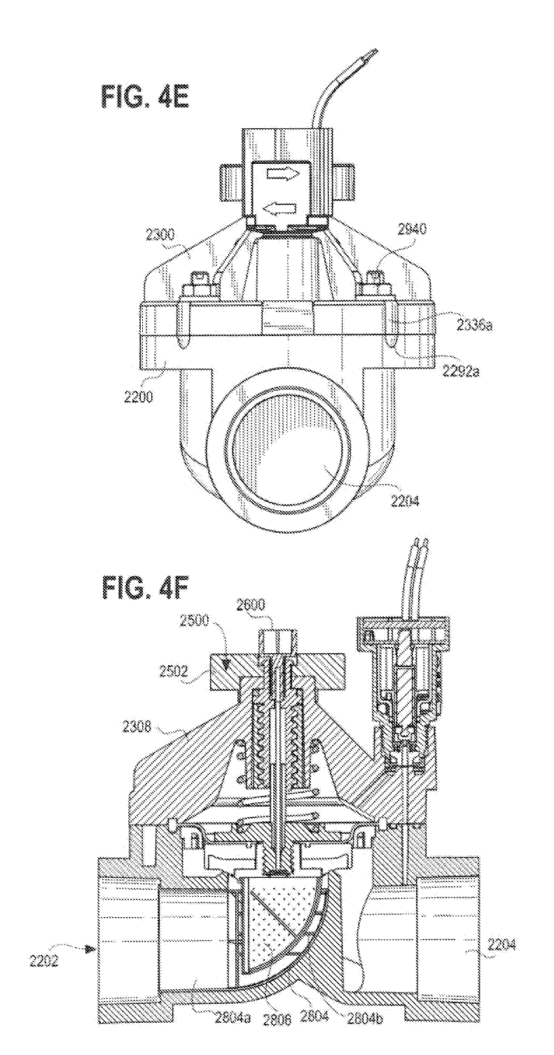

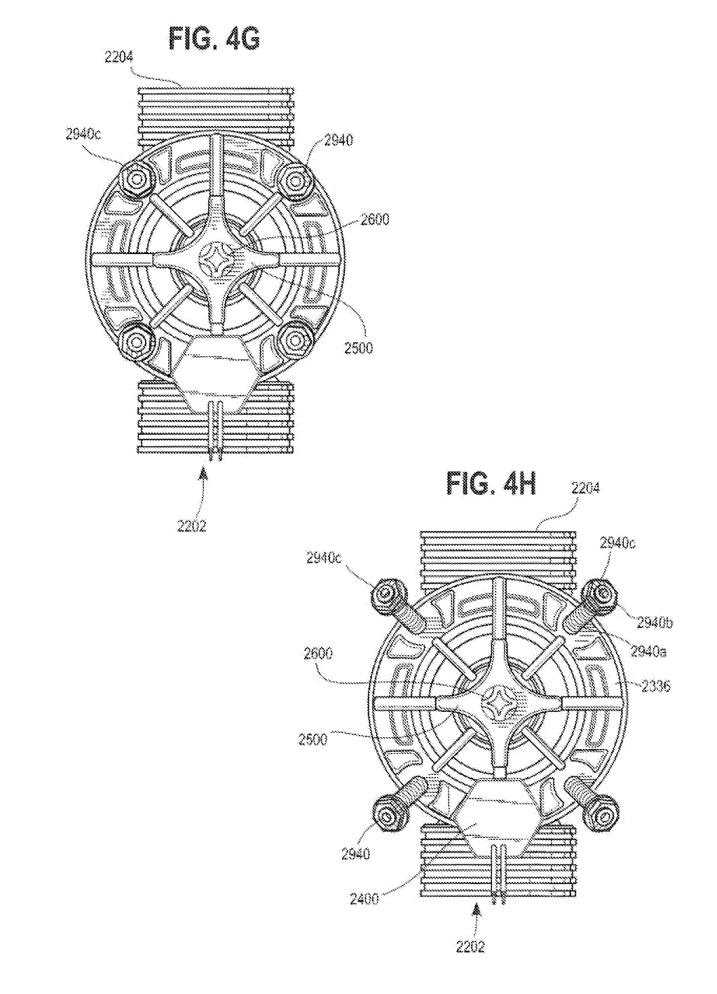

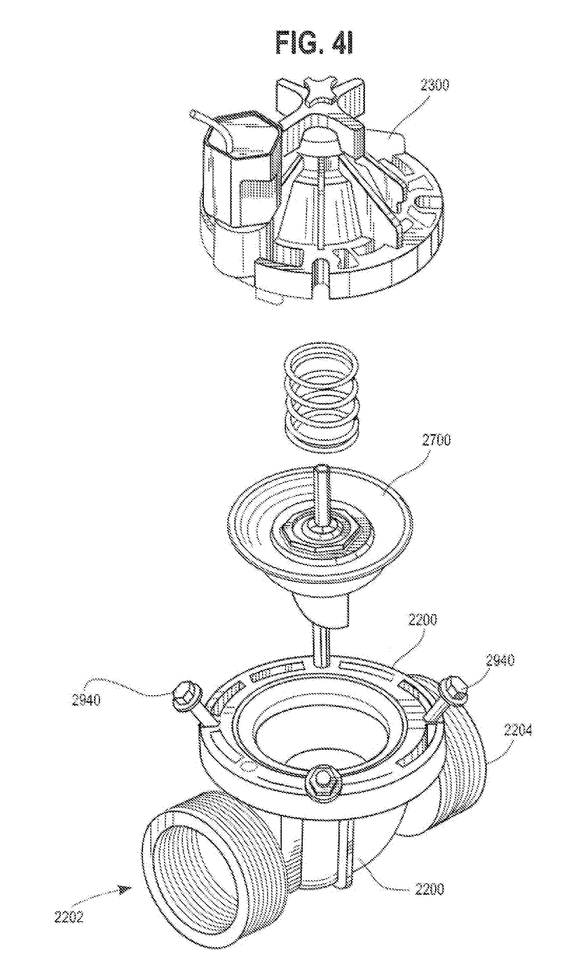

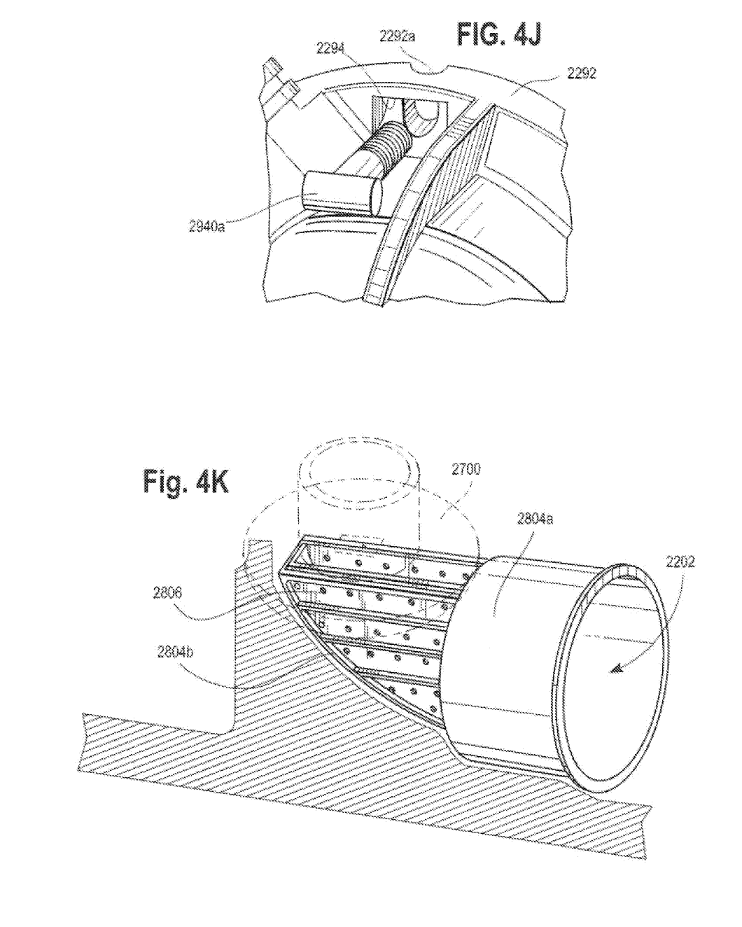

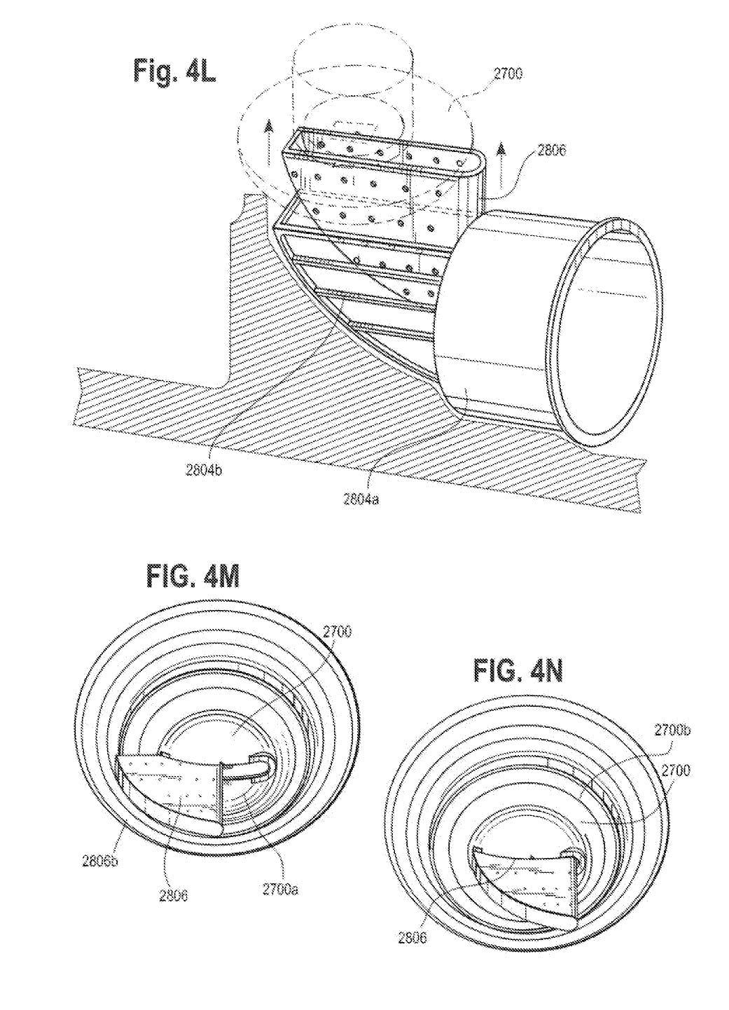

In addition to the valves and accessories discussed above, additional features and improvements may be made to the canted valves discussed above, as well as any other types of valves (e.g., upright valves, forward flow valves, reverse flow valves, etc.). For example, as illustrated in FIGS. 4A-N, there are illustrated improved bonnet/valve body connectors, and control chamber filters. As with valve 1100 above, similar features between valves will be identified using the same reference numerals, but in this embodiment the prefix “2” will be added to distinguish this embodiment from the prior embodiments of valves 100 and 1100. Thus, in FIGS. 4A-N, valve 2100 is illustrated having a valve body 2200 with bonnet 2300 connected thereto. Unlike prior embodiments, however, valve 2100 uses captive fasteners such as bolts 2940. These fasteners reduce the risk of an installer or servicer dropping the bolts when trying to connect or disconnect the bonnet 2300 from the valve body 2200.

More particularly, in the form illustrated, a T-bolt fastener 2940a is used to connect the bonnet 2300 and valve body 2200. As best illustrated in FIG. 4J, the T-bolt is inserted through a bore defined by flange 2292 of valve body 2200. The T end of bolt 2940a is snap fit or friction fit into recess 2294 of flange 2292 so that the bolt will not fall out of the recess 2294 once inserted therein. In addition, the flange 2292 defines a slot 2292a which gives the bolt room or play for pivoting between a first position angled with respect to valve body 2200 and a second position wherein the bolt extends generally normal from the flange 2292. In the form illustrated, bolt 2940a is capable of rotating from a position perpendicular or normal to the flange 2292 (see FIG. 4G) to some acute angle, such as forty-five degrees (45°) (see FIG. 4H).

The bonnet 2300 also includes a flange 2336 and corresponding slot 2336a which allows the threaded end of bolt 2940a to pivot from a position outside the bonnet 2300 (FIGS. 4H and I) to a position generally normal to the flange 2336 of bonnet 2300 or over the bonnet flange 2336 (FIG. 4G). In this way, the T-bolt 2940a can be pivoted from a release position wherein the bonnet 2300 if freely removable from valve body 2200 to an engaging position wherein the bolt is positioned within the slot 2336a of bonnet 2300. A nut 2940b is threaded onto the end of bolt 2940a and rotatable between an engaging position wherein the nut engages the upper surface of bonnet flange 2336 and a release position wherein the nut either does not engage the upper surface of bonnet flange 2336 or does not engage it with such force that the bolt 2940a cannot be pivoted between its first and second positions. In a preferred form, the distal end of bolt 2940a includes a divot or punch, such as peenable divot 2940c, which increases the diameter of the end of bolt 2940a (or mushrooms or peens the end) so that the nut 2940b cannot be removed from the bolt 2940a. Thus, in this way, the fastener is a captive fastener that cannot fall out of the valve 2100 and provides a quick and secure method for readily attaching or removing the bonnet 2300 from valve body 2200. For example, an installer or servicer only needs to loosen nut 2940b until the bolt 2940a can be pivoted out of engagement with the bonnet 2300 in order to remove bonnet 2300. In some embodiments pressing down on the bonnet will minimize the amount of loosening of the nut 2940b that is required and, thus, expedite the process. Then to install the bonnet the installer or servicer need only pivot the bolt back into engagement with the bonnet flange 2336 and then tighten the nuts 2940b until a secure connection is made therebetween. This configuration makes it easy to install and assemble the components of valve 2100 and/or easy to service the components thereof as well.

In addition to captive fasteners 2940, the valve 2100 further includes a control chamber filter 2806 which is designed to track the radius of curvature of the valve inlet passage and connects to the diaphragm of the valve using a quick connect/disconnect feature. More particularly, as illustrated in FIGS. 4B, 4F, 4K and 4L-N, filter 2806 has a dorsal fin shape with a plurality of openings throughout its exterior thereby forming a screen to filter debris out of the fluid allowed to travel to control chamber 2304. The curved surface of the filter 2806 tracks the curve of the inlet passage and takes on a shape that creates less turbulence and allows greater pressure to reach the downstream components connected to the valve 2100. This configuration also provides for more filter surface area, which allows more fluid to be filtered in preparation of traveling to the control chamber 2304. The increase surface area of the filter 2806 further provides more filtering in general as well.

The filter 2806 connects to the diaphragm assembly 2700 via a tongue-and-groove arrangement as illustrated best in FIGS. 4M and N. More particularly, a slot 2700a is formed in a portion of the diaphragm assembly 2700 and a corresponding flange or rim 2806b is formed on filter 2806. The rim 2806b is slid into engagement with the slot 2700a and the filter is continued to be inserted until a stop or indexing structure, such as projection 2806c and mating notch or recess 2700b are aligned or reached. In the form illustrated, the projection 2806c is in the form of a barb or tooth and the corresponding/mating recess 2700b is in the form of a similarly shaped notch. Thus, an installer or servicer can ensure that the filter 2806 is fully installed by sliding the filter 2806 onto the diaphragm piece until the projection 2806c mates with the notch 2700b. To release and remove the filter 2806, the installer or servicer can depress the sides of the filter adjacent the projections 2806c to disengage these projections 2806c from their mating recesses 2700b and then slide the filter back off the diaphragm structure in a direction opposite that followed when installing the filter 2806. This configuration enables easily cleaning the filter 2806 from the inside out, which will get the filter much cleaner than simply rinsing from the outside.

In addition, the valve 2100 includes a scrubber insert 2804, which is in the form of a sleeve inserted into the inlet passage 2204 of the valve 2100. The sleeve 2804 has a generally circular first portion 2804a which has a diameter that is sufficiently small enough to fit within the diameter of the inlet opening and is coaxially positioned within the inlet opening. The sleeve 2804 further includes a vertical slot portion 2804b that is defined by a plurality of generally horizontal scrubber bars 2804c. The slot 2804b corresponds in shape to filter 2806 and when disposed therein, the scrubber bars 2804c engage the exterior surface of filter 2806. In a preferred form, this engagement lasts the length of the bars 2804c and the bars 2804c are positioned with at least one bar at the top of the slot, one bar slightly up from the bottom of the filter, and an optional intermediate bar or bars as desired. Thus, when the diaphragm moves from its closed position to its open position, the filter 2806 makes a corresponding move from its lower or closed position to its upper or open position. While moving in this manner, the scrubber bards 2804c engage, scrub or clean the exterior surface of the filter 2806 in order to clean it of debris.

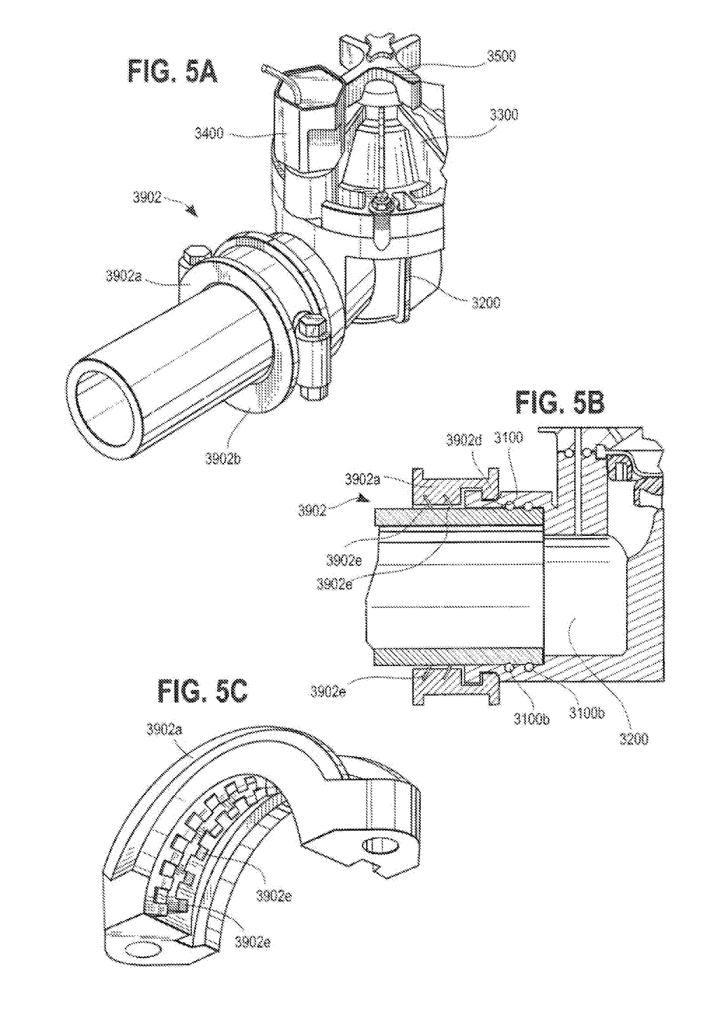

As mentioned above, the valves 100, 1100 and 2100, or any other valves, may be used with a variety of accessories. For example, some valves may be used with clamp members like those mentioned above with respect to FIGS. 2A-C above. In FIGS. 5A-C, similar sealing clamp members are illustrated, however, having additional features intended to improve the performance of the clamp and the sealing connection it makes between two items. For convenience, similar items will be identified using the same reference numerals as in FIGS. 2A-C with the exception of adding the prefix “3” in order to distinguish one embodiment from the other. Thus, in FIGS. 5A-C, seal clamp 3902 will be discussed, which includes two clamshell halves 3902a and 3902b. Each clamshell half 3902a, 3902b has a generally C-shaped structure with flanged ends defining openings through which fasteners, such as bolts or screws are disposed or thread. In the form illustrated, one of the ends of the clamp 3902 further defines a projection or tooth 3902d which mates with a corresponding recess in the item the clamp is being connected to. For example, in the form illustrated clamp 3902 is being used to connect a piece of pipe or conduit to the inlet 3202 of valve 3100. The valve 3100 has an annular recess 3100a within which the tooth 3902d is disposed and a seal, such as dual o-rings 3100b which seal the end of pipe into the valve inlet 3202. In addition, however, the clamp 3902 further includes protrusions, such as barbs or teeth 3902e, which extend inward from the inner surfaces of clamshell member 3902a, 3902b. Thus, as the clamp clamshell halves 3902a, 3902b are fastened together the barbs 3902e engage and dig into the outer surface of the pipe. Thus, when the system is put under pressure, the pipe will want to move out of the valve inlet. With this clamp, however, the pipe will either not move or simply move such that the barbs drive deeper into the pipe to further secure the clamp to the pipe section. As illustrated in FIG. 5C, in a preferred form, the barbs 3902e are generally rectangular in shape and staggered about at least two rows of teeth 3902e. In alternate forms, however, the teeth 3902e may take on any shape or size, such as shark teeth, semi-circular knives, etc.

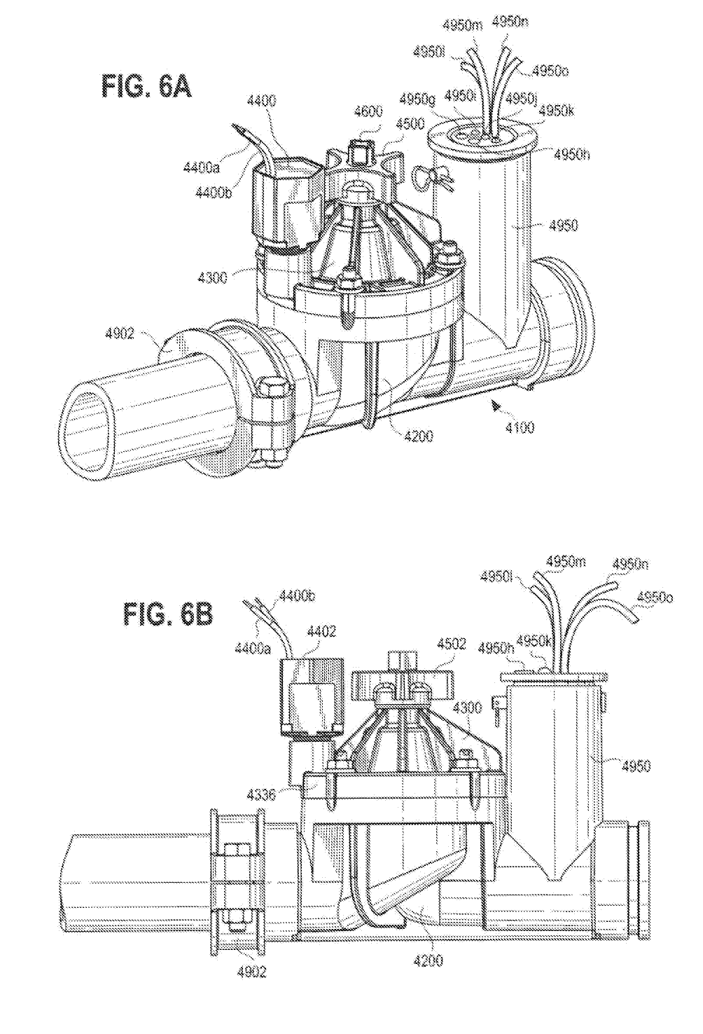

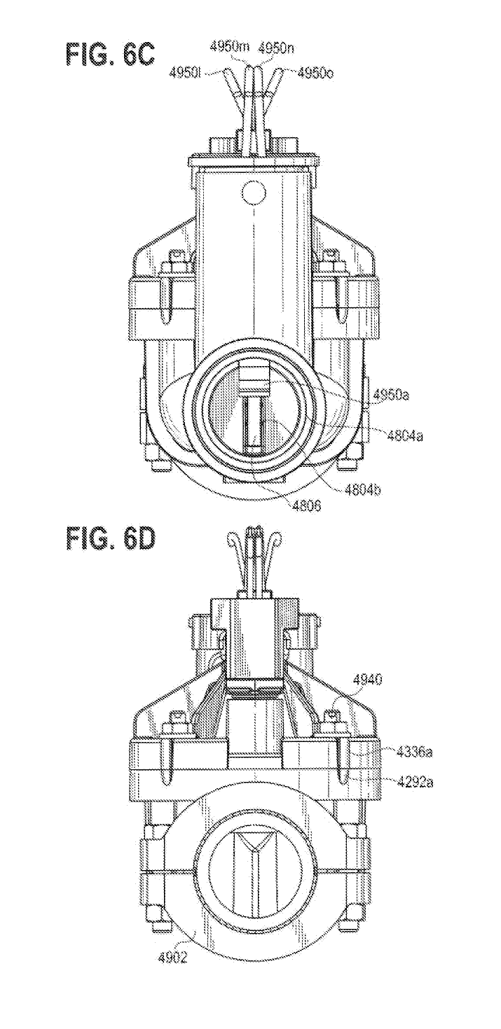

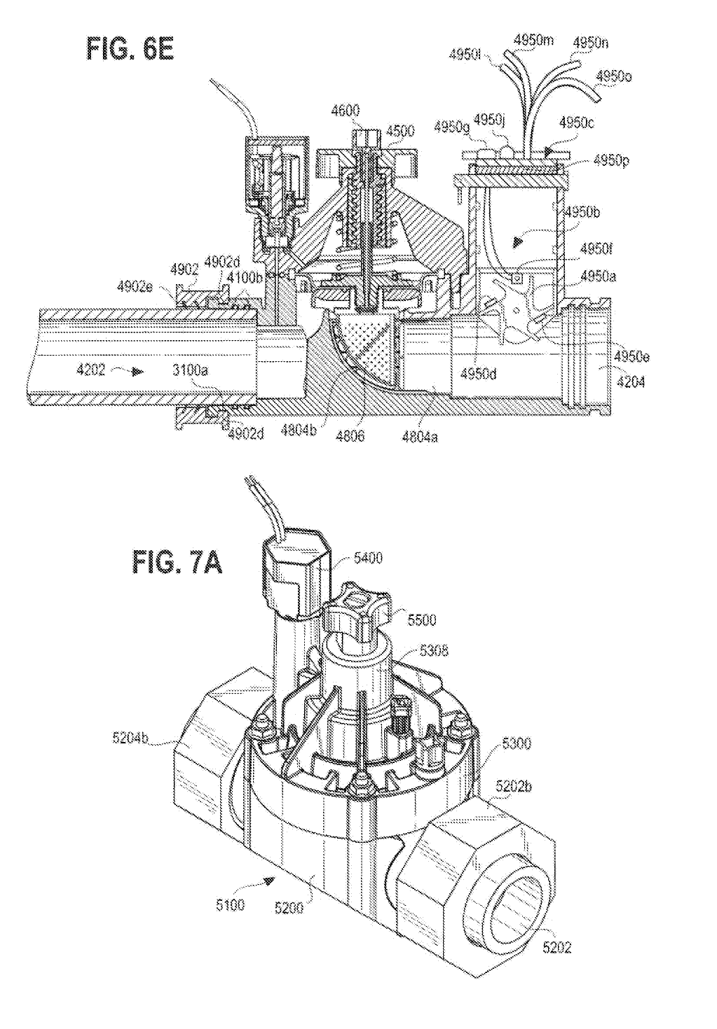

Turning now to FIGS. 6A-E, there is illustrated yet another embodiment of a valve. In keeping with the above, similar items will use similar reference numerals with the exception of adding a prefix “4” to distinguish between embodiments. In this embodiment, a clamp 4902 like that discussed above with respect to FIGS. 5A-C is disclosed connecting a pipe to the outlet of a forward flow diaphragm valve 4100. In addition to having a dorsal fin filter 4806 and scrubber insert 4804, the valve 4100 further includes an integrated flow meter 4950 placed upstream of the valve diaphragm 4700 so that general monitoring of the valve 4100 may be accomplished. In the form illustrated, the flow meter 4950 includes a rotor, such as paddle wheel 4950a, a transducer 4950b, and a controller 4950c. In the form illustrated, the paddle wheel 4950a includes at least one magnet and, preferably, has two magnets located on opposite sides of the paddle wheel, such as magnets 4950d and 4950e, and the transducer 4950b comprises a rotation sensor, which in this example is made-up of magnets 4950d and 4950e and Hall Effect sensor 4950f. The transducer 4950b converts the rotational movement of the paddle wheel 4590a into a signal (e.g., a voltage, current or frequency) which is used by the controller 4950c to determine if fluid is flowing through the valve 4100 and, if desired, the speed at which such fluid is flowing through the valve 4100. The magnets 4950d and 4950e may be arranged to give opposite polarity, such as if a latching Hall effect sensor is used, or alternatively, may not be arranged to give opposite polarity, such as if a non-latching Hall effect sensor is used.

In the form illustrated, the flow meter 4950 further includes inputs, such as first and second switches 4950g and 4950h, respectively, and has a display made up of first, second and third LEDs 4950i, 4950j and 4950k, respectively. As will be discussed in further detail below, the inputs may be used to turn on and off, program, reset and/or temporarily suspend or override the operation of flow meter 4950 and the display may be used to indicate when the flow meter is on or off, programmed, operating, reset, suspended or bypassed, etc. Although the switches and displays illustrated are push-button switches and LEDs, respectively, it should be understood that in alternate embodiments these items may be replaced with other known switches and displays. For example, other types of switches or sensors such as toggle switches, DIP switches, touch sensors, etc. may be used. Similarly, other forms of displays may be used, such as LED or LCD screens, capacitive touch screens, monitors, vacuum fluorescent displays (VFDs), etc. In addition, the flow meter may be equipped with other features such as audible alerts, wireless transmitters, auto-dialers, etc. to notify a party or parties of various information including alarm conditions wherein an unwanted fluid flow rate is detected. Similarly, in other embodiments more or less inputs and display items may be used (e.g., more or less switches, LEDs, LED/LCD screens, etc.). The number of these items may depend on, or correlate to, the model type of the component provided. For example, entry level products may have less of these items than higher end models. Conversely, the use of certain items, such as advance touch-screens, may allow for higher end models to actually use fewer switches and/or display items to be used because these items can be incorporated into the more advanced touch-screen.

Turning back to the embodiment illustrated in FIGS. 6A-E, the flow meter 4950 is connected between the solenoid and the irrigation controller (which could be a satellite controller, the main irrigation system controller, or both). In a preferred form, wires 49501 and 4950m of the flow meter 4950 are connected to wires 4400a and 4400b of solenoid 4400 and wires 4950n and 4950o are connected to the main irrigation system controller (which the solenoid wires would normally be connected directly to). This connection in series allows the flow meter 4950 to have control over the operation of the solenoid 4400 so that it can interrupt or shutoff the solenoid should an unwanted fluid flow condition be detected (e.g., fluid flow when there should not be any, fluid flow that exceeds a threshold amount, etc.). It should be understood, however, that in alternate embodiments the wiring for the flow meter 4950 may differ. For example, in conventional irrigation systems, both the flow meter 4950 and valve 4100 may be wired back to the main irrigation system controller and the controller itself will deactivate the valve 4100 if an unwanted fluid flow condition is detected by the flow meter 4950. In still other forms, the flow meter 4950 may be connected to the valve in a different manner than that shown in FIGS. 6A-E and/or the flow meter 4950 and valve 4100 may be connected to the irrigation system controller in different ways.

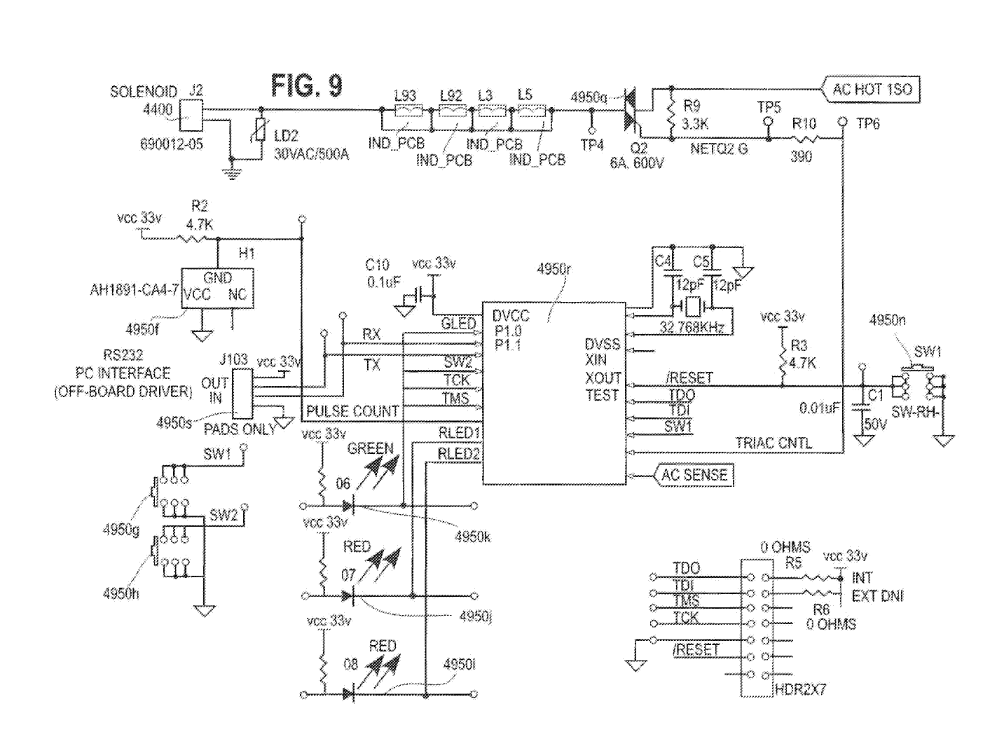

A diagram for one potential circuit for operating the flow meter 4950 is illustrated in FIG. 9. In this embodiment, a controller, such as microcontroller 4950p, is used to monitor the Hall Effect sensor 4950f and shut the valve 4100 if an unwanted fluid flow condition is detected. For example, in the form illustrated, the flow meter 4950 would cease powering the solenoid that keeps the valve 4100 open (thereby shutting the valve) if the flow rate of the fluid is greater than a predetermined threshold indicating that a problem has occurred with the irrigation system (e.g., a rupture or leak has occurred, etc.). As mentioned above, however, in alternate embodiments the valve and/or flow meter may be wired in different manners. For example, rather than having the valve and flow meter setup so that neither gets power when the controller has shut the valve, at least the flow meter could be configured to receive power so that the flow meter 4950 could also be used to detect fluid flow during periods of time when no fluid should be flowing and either check to make sure power is not being applied to the solenoid 4400 or may cycle the solenoid 4400 on and off one or more times in an attempt to clear the valve seal and seat of any obstruction that is causing fluid to flow through the valve 4100 and perfect the seal between the valve seal and seat. For example, an energy storage device, such as a battery, capacitor or other local power supply, may be used to supply power to the flow meter 4950 while the controller has deactivated valve 4100 so that the flow meter 4950 may be used to detect for unwanted flow conditions and/or so that the flow meter may be used to cycle the valve on and off (either via power form the controller or the local power supply) a predetermined number of times to make sure the seal between the valve seal and valve seat is perfected to block unwanted flow. One example of such a power supply is disclosed in U.S. patent application Ser. No. 12/428,429, filed Apr. 22, 2009 by Irwin et al. and entitled “Power Supply System” and published as U.S. Patent Application Publication No. 2010/0270803, which was published on Oct. 28, 2010, which are hereby incorporated herein by reference in their entirety.

In the form illustrated in FIG. 9, the flow meter 4950 activates the solenoid via switch, such as solid state switch or triac 4950q. It should be understood that alternate circuits may be configured to operate the flow meter 4950 in the desired manner. For example, in alternate forms something other than a microcontroller may be used, such as a microprocessor, programmable logic controller, etc. Similarly, other forms of switches may be used besides the triac 4950q as the AC switch. Furthermore, the circuit could be made-up completely of discrete logic components instead of integrated circuits if desired.

In the illustrated circuit of FIG. 9, the controller 4950p is connected to first LED 4950i, second LED 4950j and third LED 4950k to provide a visual display for the installer and/or user of the flow meter 4950. In a preferred form, first and second LEDs 4950i and 4950j, respectively, are red LEDs used to indicate a current state of the flow meter 4950 or confirm entry of a particular input and third LED 4950k is a green LED used to indicate when the flow meter 4950 is properly connected to the system controller of the irrigation system. First and second LEDs 4950i and 4950j may be used to indicate a variety of different states that the flow meter 4950 may be in and/or provide feedback or user interaction to the installer or user of the flow meter in response to any of the flow meter inputs (e.g., push buttons 4950g or 4950h) being actuated. More particularly and as illustrated in the below chart, when first LED 4950i and second LED 4950j are both off, the valve 4100 is off, meaning no power has been supplied to the solenoid 4400 via flow meter 4950 (note: in one form the flow meter may be used to detect high flow and shutoff the valve, thus in the below chart the HFSO notation refers to such a flow meter). When first LED 4950i is steady (or steadily on) and second LED 4950j is off, the flow meter 4950 is in its initial start-up state wherein the flow meter 4950 is essentially inactive, does not monitor flow or compare flow to a stored flow rate reference or threshold, and does not control when solenoid 4400 is turned on or off. Rather, in this state, the valve 4100 continues to operate via the system controller, similar to how it would if no flow meter 4950 was present in the irrigation system.

If ever it is desired to place the flow meter back into this initial start-up state, this can be done by depressing inputs 4950g and 4950h together and holding them down for five seconds. However, if the flow meter 4950 has been used to memorize and monitor a flow sequence, the depressing of inputs 4950g and 4950h in this manner will not erase this memorized flow sequence. This feature can be useful if it is desired to temporarily place the flow meter 4950 into a non-flow monitoring state or bypass state to winterize or purge the irrigation system without requiring a new flow sequence to be memorized. For example, in some climates it is desirable to evacuate fluid from the irrigation system lines in preparation for winter and freezing cold conditions to prevent fluid in the system from freezing and damaging the irrigation system lines or components. This is typically done by blowing air through the system at flow rates that may be significantly higher than the flow meter is programmed to accept as within a desired parameter or below a set threshold. Thus, by being able to place the flow meter 4950 into such a state or bypass the flow meter in this manner, the system can be flushed without concern that the flow meter 4950 will shut a valve 4100, which would slow down the winterizing process. Such a bypass state may also be desirable for irrigation systems where it is desirable to flush the lines (e.g., with water, air, etc.) in order to rid the system of grit or other particulates. In a preferred form, the flow meter 4950 of FIG. 9 is programmed so that depressing second input 4950h once the flow meter 4950 has been shutoff in this manner will have no effect on the flow meter 4950 and the flow meter will remain in the off position.

| | LED Status after | | Input | | | | | |
|---|---|---|---|---|---|---|---|---|
| | any Button | | Pressed? | | | | | |
| | Activity | | Input | Input | Power | HFSO | Power to | |
| State | LED 1 | LED 2 | 1 | 2 | to HFSO | State | Solenoid | Notes |
| 1 | Off | Off | No | No | Off | Last saved. | Off | No power |
| | | | | | | | | coming from |
| | | | | | | | | controller |
| 2 | On | Off | No | No | On | Out-of-box | On | This is the out- |
| | Steady | | | | | factory mode | | of-box LED |
| | | | | | | (same as bypass, | | state of HFSO, |
| | | | | | | but nothing is in | | can return to |
| | | | | | | flow-reference | | this bypass |
| | | | | | | memory. LED | | mode (non- |
| | | | | | | state and valve | | monitoring, |
| | | | | | | function is the | | but power to |
| | | | | | | same as bypass) | | solenoid) by |
| | | | | | | | | actuating both |
| | | | | | | | | inputs for 5 |
| | | | | | | | | seconds. This |
| | | | | | | | | bypasses |
| | | | | | | | | HFSO and lets |
| | | | | | | | | power |
| | | | | | | | | through to the |
| | | | | | | | | solenoid so |
| | | | | | | | | you can setup |
| | | | | | | | | or winterize |
| | | | | | | | | your zone |
| | | | | | | | | without |
| | | | | | | | | having the |
| | | | | | | | | valve keep |
| | | | | | | | | shutting down |
| | | | | | | | | due to turbine |
| | | | | | | | | overspeed. |
| 3 | On | Flashing | Yes | No | On | | On | This mode is |
| | Steady | | | | | | | accessed by |
| | | | | | | | | actuating |
| | | | | | | | | Input 1 for 5 |
| | | | | | | | | seconds and |
| | | | | | | | | releasing once |
| | | | | | | | | this LED |
| | | | | | | | | pattern shows. |
| | | | | | | | | Once the learn |
| | | | | | | | | procedure |
| | | | | | | | | executes and |
| | | | | | | | | the value is |
| | | | | | | | | stored, the |
| | | | | | | | | LED pattern |
| | | | | | | | | changes to |
| | | | | | | | | state 4, and |
| | | | | | | | | HFSO starts |
| | | | | | | | | monitoring. |
| 4 | On | On | No | No | On | | On | This is normal |
| | Steady | Steady | | | | | | mode once |
| | | | | | | | | flow is |
| | | | | | | | | memorized. |
| 5 | Flashing | Flashing | No | No | On | | Off | HFSO has |
| | | | | | | | | detected flow |
| | | | | | | | | >/= 120% of |
| | | | | | | | | memorized |
| | | | | | | | | flow, |
| | | | | | | | | performed |
| | | | | | | | | evaluation |
| | | | | | | | | sequence, |
| | | | | | | | | decided flow |
| | | | | | | | | is too high, set |
| | | | | | | | | LEDs to both |
| | | | | | | | | flashing, and |
| | | | | | | | | cut power to |
| | | | | | | | | solenoid. |
| 6 | On | On | No | Yes | On | | On | Used to |
| | Steady | Steady | | | | | | restore to |
| | | | | | | | | normal |
| | | | | | | | | function using |
| | | | | | | | | previously- |
| | | | | | | | | stored |
| | | | | | | | | reference flow |
| | | | | | | | | without |
| | | | | | | | | having to |
| | | | | | | | | memorize. |
| | | | | | | | | Accessed by |
| | | | | | | | | actuating |
| | | | | | | | | Input 2 for 5 |
| | | | | | | | | seconds. |
| 7 | On | Off | Yes | Yes | On | | On | Use bypass |
| | Steady | | | | | | | mode for |
| | | | | | | | | winterizing. |
| | | | | | | | | Same as out- |
| | | | | | | | | of-box mode |
| | | | | | | | | except there is |
| | | | | | | | | a value in flow |
| | | | | | | | | reference to go |
| | | | | | | | | back to with a |
| | | | | | | | | simple reset. |
| | | | | | | | | Accessed by |
| | | | | | | | | actuating both |
| | | | | | | | | inputs for 5 |
| | | | | | | | | seconds. |

As indicated above, the flow meter 4950 is initially activated by running a memorize-flow sequence, which is done by actuation or depressing first input 4950g. Once input 4950g has been depressed for approximately five seconds, first LED 4950i will remain on in a steady manner and third LED 4950j will begin to blink or flash indicating that the flow meter 4950 is about to start monitoring fluid flow to determine what the average fluid flow rate is with respect to the fluid flowing through the system. In a preferred form, the flow meter 4950 will delay measuring the flow for a predetermined period of time and then monitor and record the flow rate over a second predetermined period of time. For example, in one embodiment, the flow meter 4950 will delay measuring flow for a period of sixty seconds once the memorize-flow sequence is entered and will monitor flow for one hundred eighty seconds, taking readings every ten seconds and then averaging the readings to determine a reference flow rate. This value will be written to memory and overwrite any fluid flow rate value currently stored in memory. It will also be the value that the flow meter 4950 will use to determine when flow has exceeded a predetermined flow rate. The flow meter 4950 may be configured to use the average value as the threshold itself and to shut the valve 4100 if the fluid flow rate exceeds this value, however, in a preferred embodiment a buffer amount will be added to the average value to set the threshold flow rate that the flow meter 4950 looks to see or exceed before shutting the valve 4100 in order to account for normal flow rate and pressure fluctuations that may occur in a fluid supply lines (particularly those due to fluctuations in municipal water supply fluid flow rate and pressure). In the form illustrated, flow meter 4950 is programmed to add twenty percent (+20%) to the average flow rate and set that value as the reference threshold for determining when a high flow rate condition exists. In other forms where the flow rate is monitored to make sure it does not exceed a maximum flow rate or drop below a minimum flow rate, this buffer may be plus or minus twenty percent (±20%), however, other buffer ranges could be used as desired, such as for example, ±1%, ±2%, ±5%, ±10%, ±30%, ±40%, ±50%, etc.

During this process, power to operate the valve 4100 is transferred to the flow meter 4950 instead of the solenoid 4400, however, power will still freely flow to the solenoid 4400 to open and close the valve 4100 per the system controller's programmed settings until a threshold fluid flow rate is determined and then either detected or surpassed. Once the threshold fluid flow rate is determined, the second LED 4950j will cease flashing and both the first and second LEDs 4950i and 4950j, respectively, will remain steadily on. Thus, with this configuration, the flow meter 4950 may be programmed with a single touch of an input button rather than requiring multiple steps, such as multiple actuations of various inputs, or other cumbersome steps for the irrigation system installer or operator. In a preferred form, the flow meter 4950 will also delay monitoring flow rate for a period of time (e.g., 60 seconds) each time the solenoid 4400 is energized or powered to open the valve 4100 by the system controller in order to let the system fill fully with fluid (if not already full and under pressure) and in order to avoid detecting any bounces in fluid flow rate due to initial equipment or system startup (e.g., air pockets in the lines, hard starts associated with initial opening of the valve or valves, etc.).

When an unwanted flow rate condition is detected (e.g., a high flow rate condition in systems only monitoring for excess flow rate, a high or low flow rate condition in systems looking for flow rates above or below a predetermined range of acceptable flow rates, etc.), the flow meter 4950 enters an alarm state and continues to monitor flow rate for a predetermined period of time to make sure that the condition is constant or steady enough to be determined to be an actionable and not just a fluke reading or extraordinary condition in order to avoid unnecessarily shutting down the irrigation system or a portion of the irrigation system. In the form illustrated, the flow meter 4950 will continue to monitor flow rate for three minutes (3 min.) after an initial reading outside of the acceptable range is detected. If this flow rate reading exceeds the reference threshold or acceptable range during that period of time, the flow meter 4950 will interrupt power to the solenoid 4400, thereby shutting the valve 4100 to limit the amount of water wasted due to the high-flow condition. During the three-minute duration of the alarm state, and the rest of the time the controller is sending power to the flow meter 4950, the first and second LEDs 4950i and 4950j, respectively, will both flash. The alarm state will be recorded to memory using controller power which was interrupted due to the alarm state.

During the next watering cycle when the irrigation system wishes to open valve 4100, the flow meter 4950 prevents the solenoid 4400 from being actuated or powered on and starts flashing the first and second LEDS, 4950i and 4950j, again to indicate an unwanted flow rate issue has occurred with respect to this irrigation line and/or attached components. In addition, the valve 4100 or irrigation zone associated with this line will not water again the flow meter 4950 is reset. In the form illustrated, this resetting is a manual resetting and is accomplished by actuating reset button 4950r (see FIG. 9). It should be understood, however, that in alternate embodiments this resetting could be accomplished with the use of one or more of the other inputs 4950g, 4950h (e.g., entering a predetermined sequence of actuations, depressing second switch 4950h for a period of time, etc.), or the system could be setup so that this reset could be accomplished remotely, such as by way of a smart phone with an irrigation app or other interface with the irrigation system, etc. Such a remote feature may be further be used to turn on or off the flow meter and/or to place the flow meter in its bypass state, such as to winterize the system or simply test repair work and/or other work done on the system without having the flow meter setup to shut down the system if a normally unwanted fluid flow condition is detected. In addition, as mentioned above, the system could also be setup to attempt to take some intermediate or corrective step to see if the unwanted flow condition can be solved automatically, such as by cycling on and off the valve or other irrigation components in order to see if the unwanted flow condition is due to an intermittently working component, a bad seal, etc. A further embodiment could allow the flow meter unit to reset once controller power is interrupted knowing that only four minutes of water would be wasted during each valve-run cycle. This would allow the flow meter and valve to resume normal operation and not require a user or irrigation system supervisor to go and manually reset the flow meter each time an unwanted flow condition (e.g., too much flow, too little flow, reverse flow, etc.) has been corrected (e.g., no need to reset the flow meter once a broken sprinkler head has been replaced because the flow meter will automatically reset and only shutoff if another unwanted fluid flow condition is detected). Such an automatic resetting may also be desirable in cases where the detected unwanted flow condition is minimal in nature and the user or supervisor does not have time to address the matter immediately (e.g., the system would be allowed to run briefly with the unwanted fluid flow condition every time a watering cycle is initiated until the problem can be addressed by the user/supervisor).

In the form illustrated in FIGS. 6A-F and 9, once an unwanted fluid flow event results in the shutdown of a valve or irrigation zone, a technician or irrigation system operator will preferably examine the zone and determine and fix the problem causing the event. If this fix can occur without the need to reprogram or re-memorize the fluid flow rate (such as when a ruptured sprinkler head is replaced and the stored flow rate reference threshold is still desired/accurate), the technician or operator need only reset the flow meter 4950. In one preferred form, this is accomplished by depressing second switch 4950h for a period of five seconds. In this form, the first and second LEDs 4950i and 4950j will continue to blink until the second switch 4950h has been held for five seconds and then both LEDs 4950i, 4950j will steadily illuminate indicating that the flow meter 4950 is again monitoring flow (similar to what was described above about this state). By changing in this way, the display provides user feedback and/or an acknowledgment to the technician or operator that the command has been received or is confirmed. During this process power is allowed through to the solenoid 4400 so that the system controller can turn on the solenoid and open the valve 4100 when desired or programmed to be opened.

If the fix requires the reprogramming or re-memorizing of the acceptable fluid flow rate, then first switch 4950g may be held down for five seconds to put the flow meter 4950 back into the memorize flow sequence. After first switch 4950g is held down for five seconds, the first and second LEDs 4950i and 4950j will stop flashing and the first LED 4950i will change to being steadily on and the second LED 4950j will start to blink or flash (similar to what was described in the above memorize flow sequence). By changing in this way, the display provides feedback or a confirmation for the technician or operator that the command has been received and that the flow meter has now entered the memorize flow sequence. During this period power is allowed through to the solenoid 4400 so that the valve can be opened by the system controller when programmed or instructed to be opened.

As mentioned above, when in the normal system operation, the first and second LEDs 4950i and 4950j will be illuminated steadily and the flow meter will monitor for unwanted fluid flow rates (e.g., high flow rates if setup to only look for high fluid flow rates, flow rates when the valve is supposed to be shutoff, flow rates that are above or below a predetermined range of acceptable flow rates, etc.). During this time, the flow meter 4950 will allow power to be supplied to the solenoid 4400 by the systems controller when programmed to until such time as the flow meter detects an unwanted fluid flow condition or has been otherwise turned off or bypassed as discussed above. In the form illustrated, the flow meter 4950 may be placed into the bypass state by depressing the first and second switches 4950g and 4950h, respectively, for a period of five seconds. Once five seconds has been reached, the first LED 4950i will be steadily illuminated and the second LED 4950j will not be illuminated, indicating the flow meter 4950 is inactive and no fluid flow monitoring is taking place. Again, as mentioned above, this will not erase the programmed flow rate threshold (e.g., high flow rate reference value, range of acceptable flow rates, etc.) and power is allowed to be applied to the solenoid 4400 via the system controller as programmed during this time period so that services, such as winterization, line purging or flushing, etc., can take place.

Once these services are completed, the system can be reset in any of the manners discussed above so that the flow meter 4950 returns to active status and monitors for unwanted flow rates. In the form illustrated, the system may be reset by either actuating reset switch 4950r or by depressing or actuating second switch 4950h for a period of five seconds. Once either is done, the first and second LEDs 4950i and 4950j will both be steadily illuminated and the flow meter 4950 will return to active monitoring for unwanted flow rates using the previously stored reference threshold.

In a preferred form, the flow meter 4950 or valve 4100 (or their surrounding environments such as a valve box or valve box cover) will be marked with a legend that identifies what the flow meter display is indicating. However, other embodiments could be so intuitive that no legend is necessary. It should be understood, however, that variations may be made to the above-description of how the flow meter 4950 operates and that some or all of these features may be used or combined in different sequences to provide slightly different operating flow meters, valves and irrigation systems. For example, the display may be configured to illuminate the LEDs in a different pattern to indicate any of the various states, or the flow meter may not be programmed to have all of the above-mentioned sates. The flow meter 4950 could have different numbers of LEDs, colors of LEDs, and/or number of inputs or buttons than described above. In yet other forms, the flow meter may be configured to shutoff a valve, prevent a valve from being opened or simply notify a party that maintenance of the system is needed in situations where the measured flow rate does not fall within a desired parameter range (i.e., the flow rate is too low or too high), rather than simply looking for conditions where the flow rate exceeds a predetermined threshold. In still other embodiments, the flow meter may be provided as a stand alone item to be connected in series with a valve and irrigation tubing or piping or connected to another irrigation system component rather than being integrally connected to the valve housing.

In the form illustrated in FIG. 9, the flow meter 4950 is also equipped with an interface, such as RS232 PC interface 4950s. This interface 4950s allows the microcontroller 4950p of the flow meter 4950 to be accessed for data and/or reprogramming. For example, in one form, a hand held device can be connected to the flow meter 4950 to review prior alarm conditions. In other forms, this interface may be used to access data relating to the irrigation system operation (e.g., period of time of operation, statistics relating to operation, etc.). For example, the system could be used to measure the flow through the valve over a period of time. This data could be used to determine how much water the system dispenses, on a valve-by-valve basis.

It should also be understood that the above chart identifies one embodiment of a flow meter operating in accordance with the invention disclosed herein. Many other embodiments are possible and, thus, specific ways in which steps are acknowledged or states are identified could be changed. For example, different color LEDs could be used, different illumination sequences could be used (e.g., flash when in a state rather than stay on steady, or use no illumination to indicate a state that currently is indicated by flashing or steady on, etc.), in fact different ways of relaying the same information could be used, such as by using a display with text and symbols rather than using LEDs, etc.

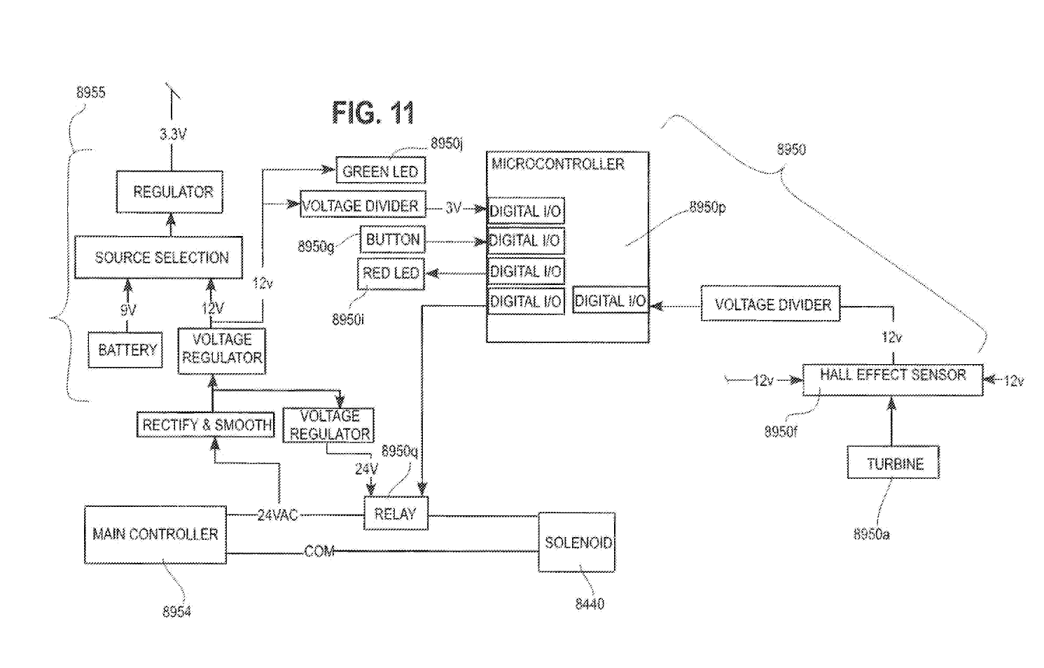

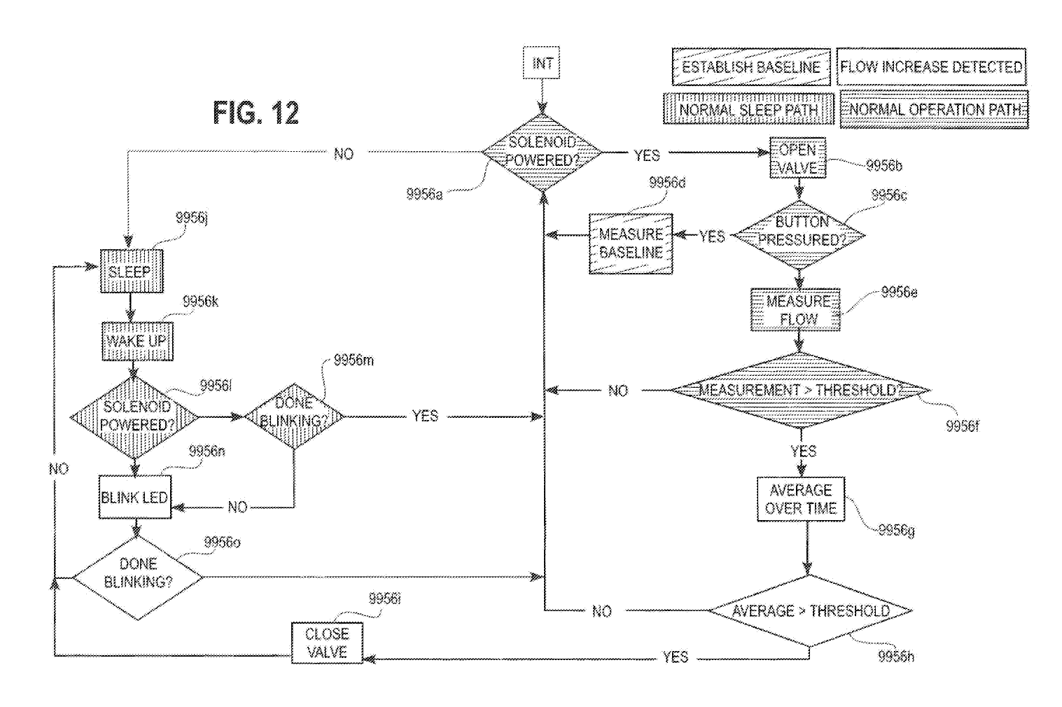

FIGS. 11 and 12 illustrate a block diagram and flow chart for another diaphragm valve with a flow meter. For example, in the block diagram of FIG. 11, a flow meter 8950 is shown connected between the main irrigation system controller 8954 and the solenoid 8440. The system includes power supply circuitry 8955 which is used to supply the appropriate voltage to the electronic components of the circuit including microcontroller 8450p, as well as the appropriate voltage to the solenoid to turn on and off the valve. As illustrated in FIG. 12, the system initially starts with a calculation of the average flow rate of fluid through the system to monitor for unwanted fluid flow rate conditions which should signal the shutting of the valve. In step 9956a, the system checks to see if the solenoid has been powered or turned on by the main controller. If the solenoid has been powered, the system opens the valve in step 9956b and then checks to see if any of the input buttons have been actuated in step 9956c. If yes, the system begins measuring flow rate in step 9956d to calculate an average flow rate and determine a reference or threshold flow rate value or range. This continues until the solenoid is no longer powered by the master control as checked in step 9956a or until none of the input buttons have been detected as being actuated in step 9956c. If none of the inputs are actuated, the system has determined the threshold flow rate value or range in step 9956e and checks to see if the current flow rate measurement is equal to or greater than the threshold flow rate value or range in step 9956f. If the measurement is not equal to or greater than the threshold flow rate, the system checks to see if the solenoid is powered again in step 9956a. If the measurement is equal to or greater than the threshold flow rate, the system has determined the average flow rate to be over the threshold flow rate value or range in step 9956g and double checks to make sure this is so in step 9956h. If so, the flow meter closes the valve in step 9956i.

If the system determines power is not applied to the solenoid in step 9956a, the system enters a sleep mode in step 9956j and eventually wakes up in step 9956k to determine if the solenoid is powered yet in step 99561. If the solenoid is now powered, the system checks to see if any of the LEDs of the display are blinking or flashing in step 9956m and, if so, restarts the process by checking again in step 9956a to see if power is applied to the solenoid. If the solenoid is not powered or if the LEDs of the display are not blinking or flashing, the system sets at least one of the inputs so that it blinks in step 9956n and then checks to see if the any of the inputs are still blinking in step 9956o. If any of the inputs are blinking, the system returns to the sleep mode in step 9956j. Alternatively, if none of the inputs are blinking, the system returns back to the beginning and checks for whether or not power is applied to the solenoid in step 9956a

It should be understood, however, that a variety of different flow meter and encoder mechanisms may be used in accordance with the present invention. For example, in the above-mentioned embodiment flow meter 4950 uses Hall Effect sensors for creating an electrical signal, the frequency of which tracks with the magnitude of the fluid flow. In other embodiments, an optical pair may be use to track paddle wheel movement and/or encode the data for processing via a processor. It should also be understood that while the form illustrated uses the flow meter 4950 to track flow rate, alternate uses of the flow meter may be made. For example, instead of continuously tracking fluid flow, the flow meter 4950 may be setup to only monitor flow at certain intervals or periods of time, or during certain events (e.g., such as when the solenoid 4400 is activated). In addition, the flow meter 4950 may alternately be setup to take batch readings rather than continuous readings, such as readings for predetermined amounts of time and at periodic intervals, and/or may be setup to determine when the valve 4100 is working within desired parameters or outside of those desired parameters. For example, the valve 4100 may use the flow meter 4950 to determine if fluid flow is occurring at times when no fluid flow should be occurring and then use this information to notify an individual or controller that a leak is occurring or some other error has occurred and/or may take some form of corrective action with respect to same (e.g., closing a shutoff valve further upstream).

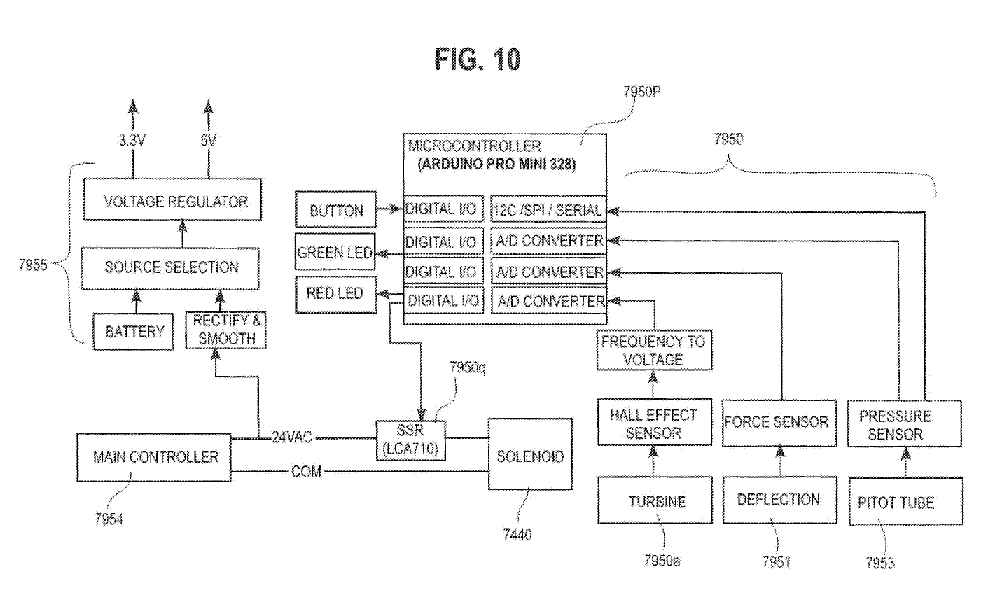

In FIG. 10, a block diagram is shown illustrating several different ways in which a diaphragm valve assembly in accordance with the present invention may be configured. More particularly, the diagram illustrates an irrigation system having a main controller 7954, power supply circuitry 7955 and a flow meter 7950 connected between the main controller 7954 and solenoid 7440. As with the embodiment of FIGS. 6A-E, the flow meter 7950 includes a controller, such as microcontroller 7950p which supplies power to solenoid 7440 via an AC switch, such as solid state relay or switch 7950q. As mentioned above, the fluid flow rate or motion may be detected using a turbine style flow meter 7950a like that discussed above with respect to FIGS. 6A-E to track and convert motion into frequency in order to determine flow rate. Alternatively, however, other types of sensors may be used such as diaphragm deflection sensors 7951, which may be used to measure the amount the valve diaphragm deflects in response to fluid flow, or pitot tube sensors which are used to measure differential pressures to determine fluid flow rate. For example, the deflection sensor may be measured via a force sensor, such as a spring connected to a force sensor to identify the amount of deflection based on the force associated with the diaphragm deflection. Alternatively, the deflection sensor may be measured optically to determine the displacement of the diaphragm, using inductance changes, resistance changes, or other technologies.

As examples of the various types of flow meters that can be used in accordance with an aspect of the invention disclosed herein, any one or more of the following sensors may be used in alternate embodiments: linear position sensors such as linear variable differential transformers (LVDTs); fluid flow switches such as Harwil brand fluid flow switch model Q-8CR; electromagnetic flow meters, turbine meters, nutating disc meters, oval gear meters, impeller meters, ultrasonic flow meters, or mass meters, such as those sold by Badger Meter; insertion flow monitors or meters, turbine and paddlewheel flow meters, pitot tubes and thermal dispersion flow switches such as those sold under the Omega brand.

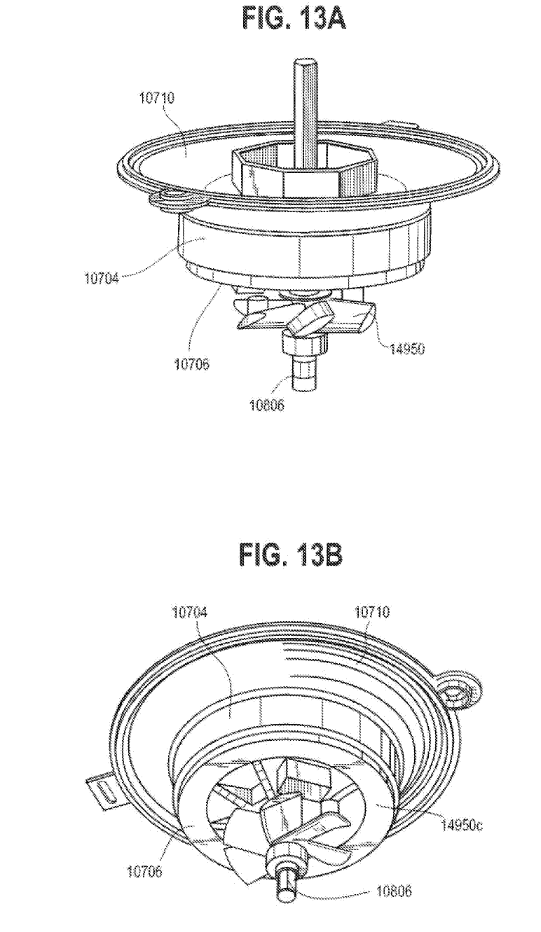

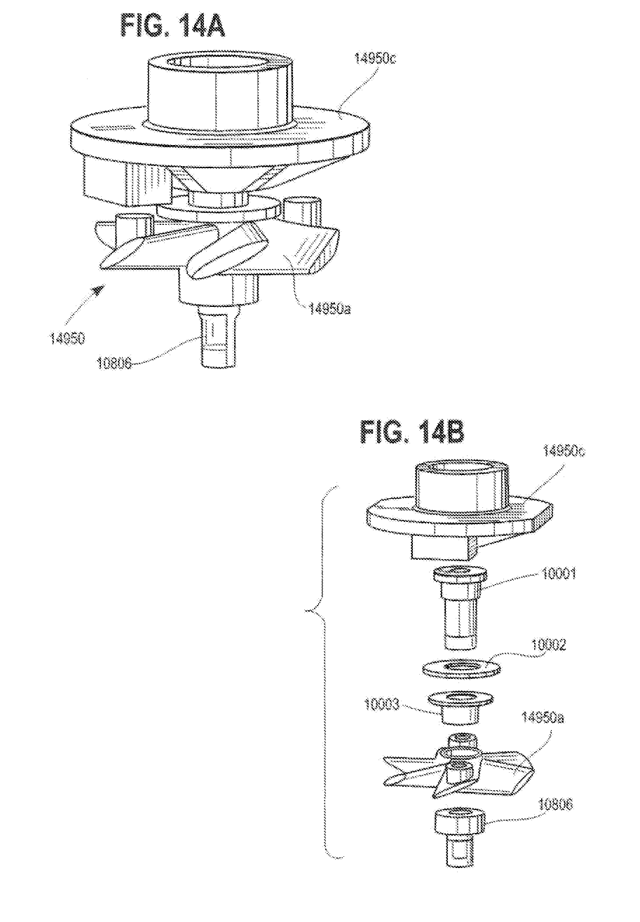

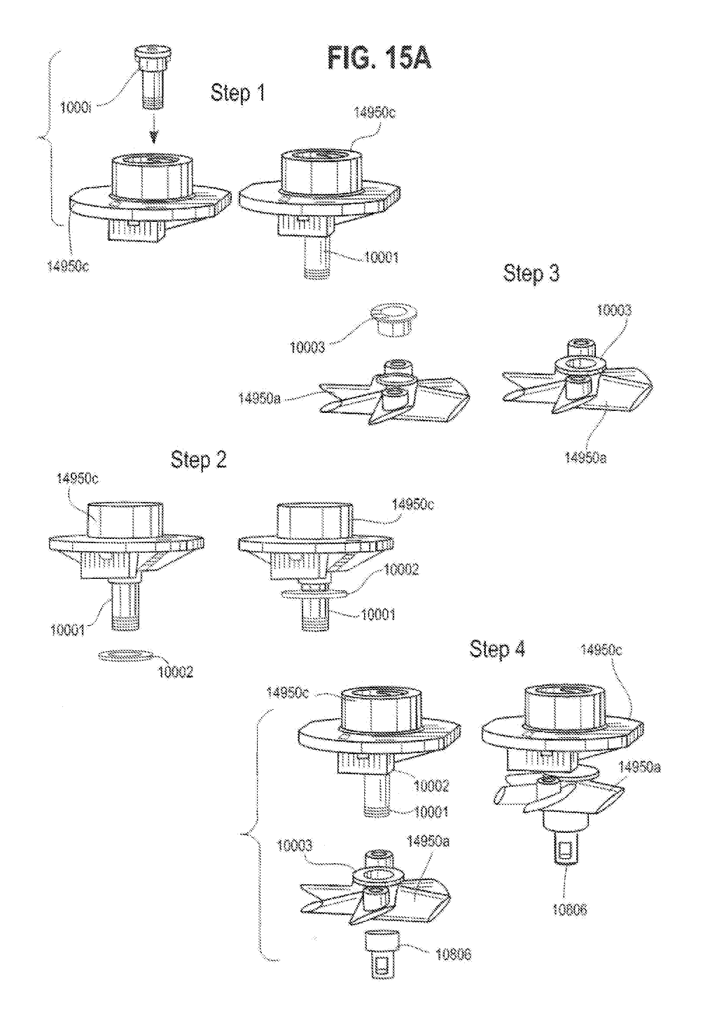

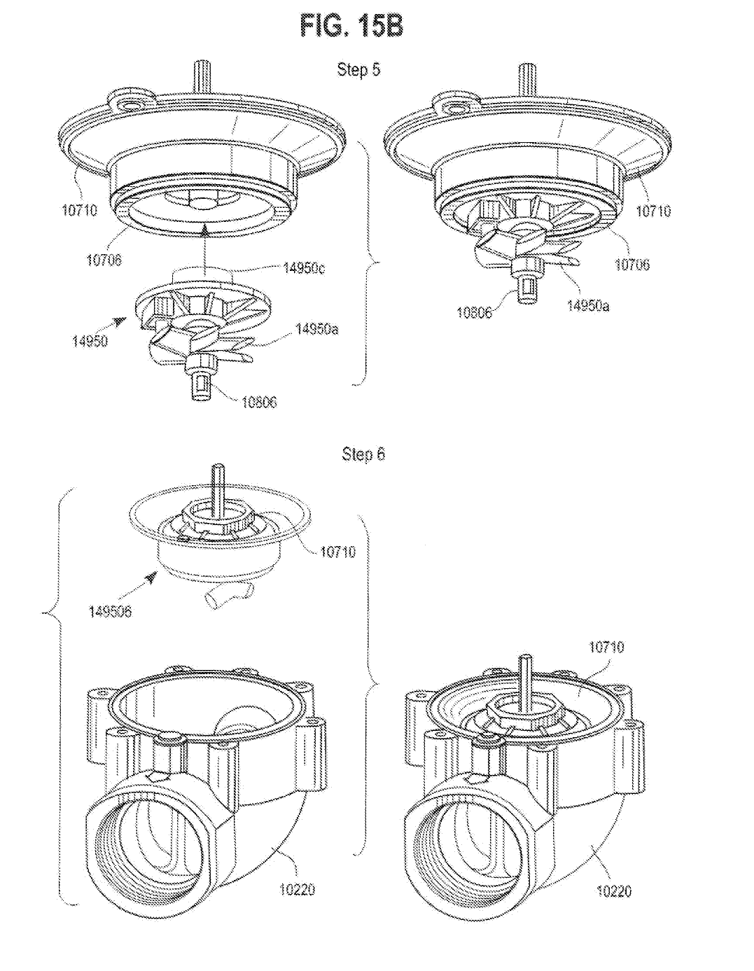

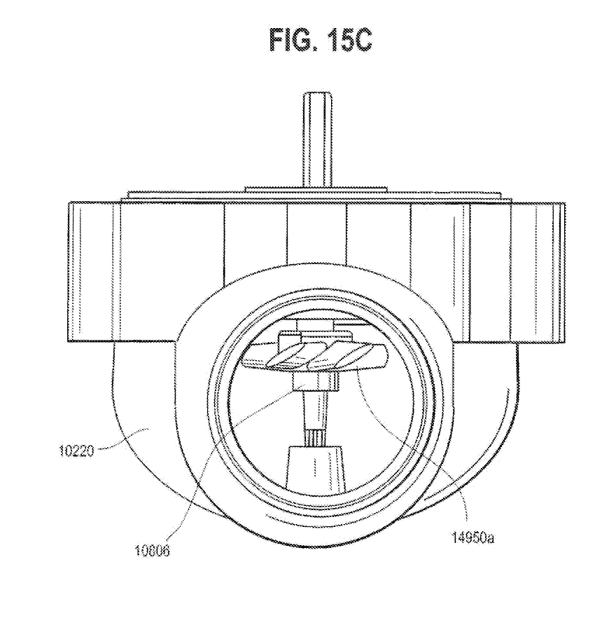

Yet another alternate embodiment of a diaphragm valve with flow meter is illustrated in FIGS. 13A-15C. Unlike the above embodiments, however, the embodiment illustrated in these figures incorporates the flow meter into the valve diaphragm assembly portion that is inserted into the lower valve housing, rather than requiring the formation of a new cylindrical structure off of the inlet side of the valve housing. In addition to allowing the flow meter of this embodiment to be able to work with existing valve housings, this also allows the flow meter to be incorporated into a new valve design such as the in-line assembly disclosed in FIGS. 1A-G above and to provide an internal assembly portion that can easily be installed, removed and re-installed even with the blind insertion that is required for this structure.

As best illustrated in FIGS. 13A-B, the diaphragm assembly of this in-line embodiment includes a dish diaphragm 10710, a seal support cup 10704 and seal 10706, flow meter controller 14950c and rotor 14950a, and a filter assembly 10806. In one form, this assembly could be substituted with the assembly illustrated in FIGS. 1A-G and used in combination with the scrubber assembly 840 therein, which is anchored to the valve housing 200 and has fingers or pawls which clean the exterior or outer surface of the filter while the diaphragm assembly 700 to which the filter is attached moves between its open and closed positions. This scrubber assembly 700 further assists in keeping the diaphragm assembly aligned and efficiently moving along a straight longitudinal axis in order to minimize fluctuations in the performance of the diaphragm valve assembly and differences in how one valve operates with respect to other valves of similar type.

In FIGS. 14A-B and 15A-C, a more detailed view of the flow meter assembly is shown and a method for assembling such a flow meter assembly is shown, respectively. In a preferred form, the printed circuit board that contains the microcontroller of the flow meter is inserted and fixed into the box-like structure of the controller assembly 14950c. This box-like structure is preferably water proof or at least water resistant to protect the electronic circuitry of the flow meter 14950. As illustrated, a turbine shaft 10001 is preferably inserted into the controller housing 14950c from above and a washer 10002 is inserted onto the turbine shaft 10001 from below. Bushing 10003 is inserted into rotor or turbine 14950a and filter assembly 10806 is connected onto the distal end of turbine shaft 10001. In the form illustrated, the filter assembly 10806 is that of a filter cap, but it should be understood that a canister type filter would be inserted within the filter cap and, in some forms, no external filter cap would be need such as, for example, when a scrubber assembly such as 840 is used. In such a configuration, the canister filter could be designed to screw directly onto the end of turbine shaft 10001 without the need for an external housing structure.

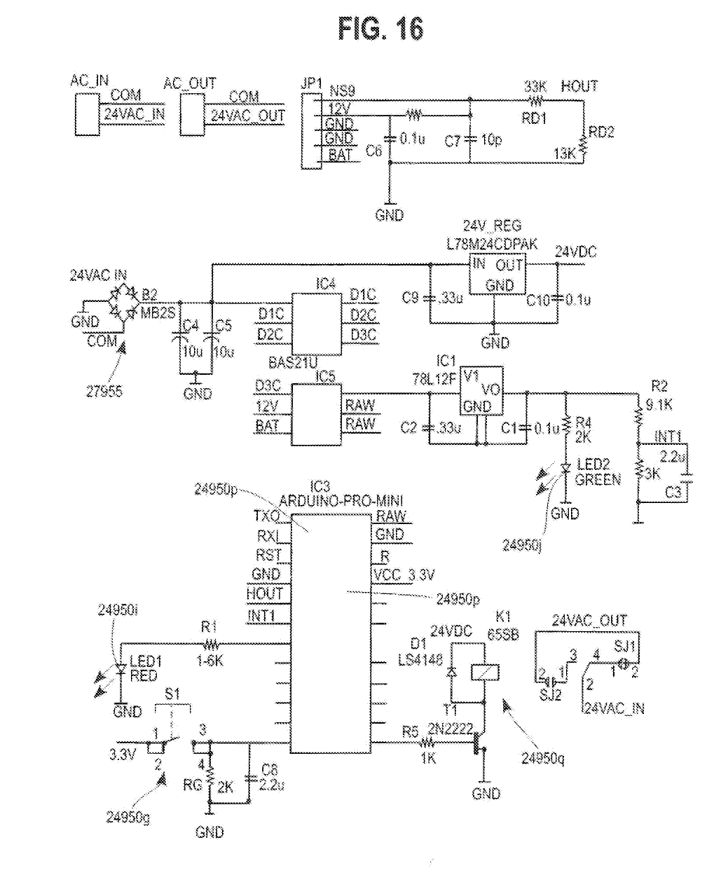

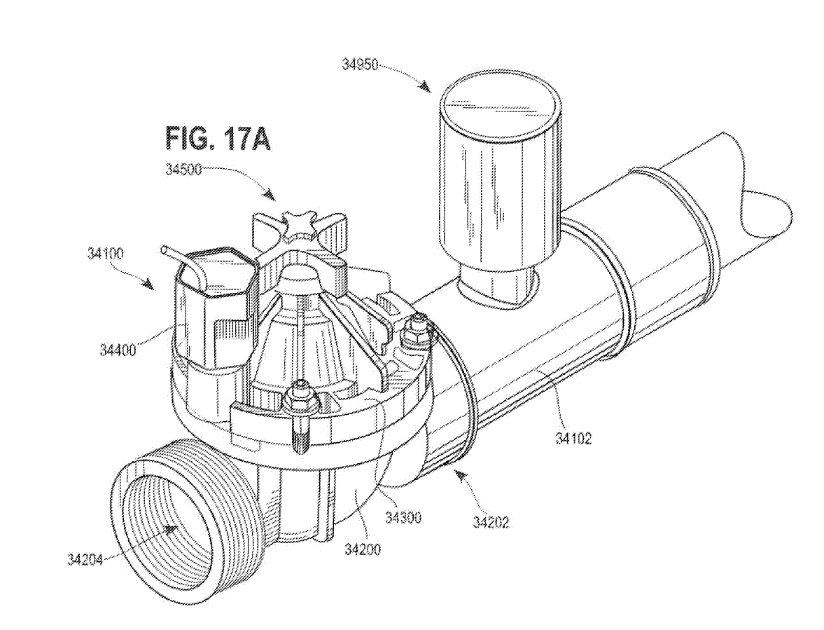

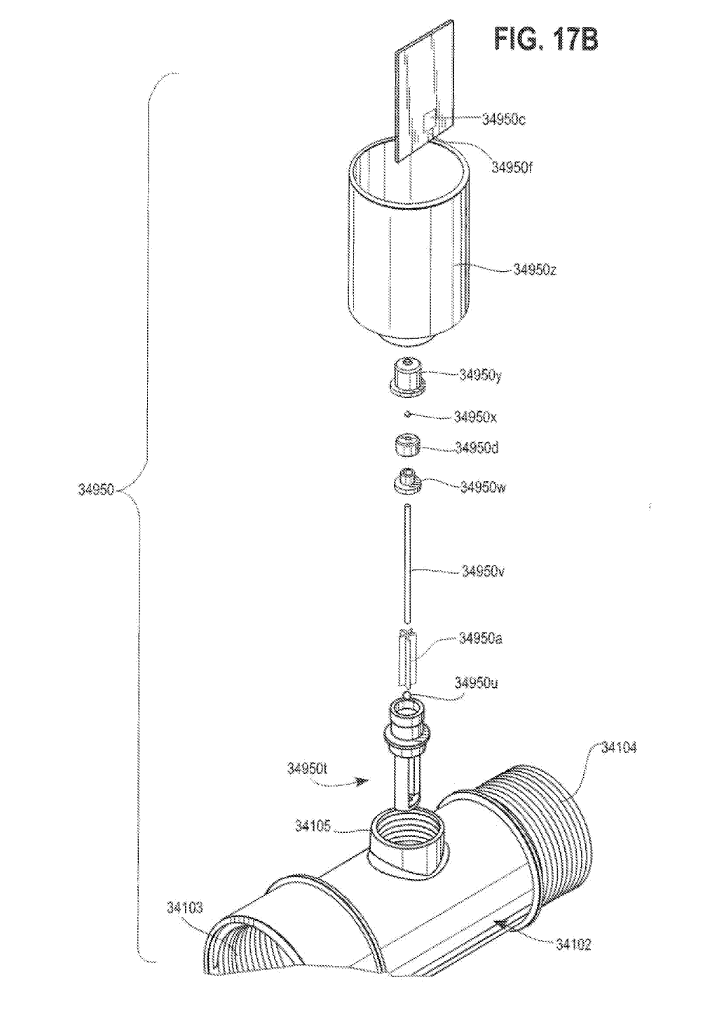

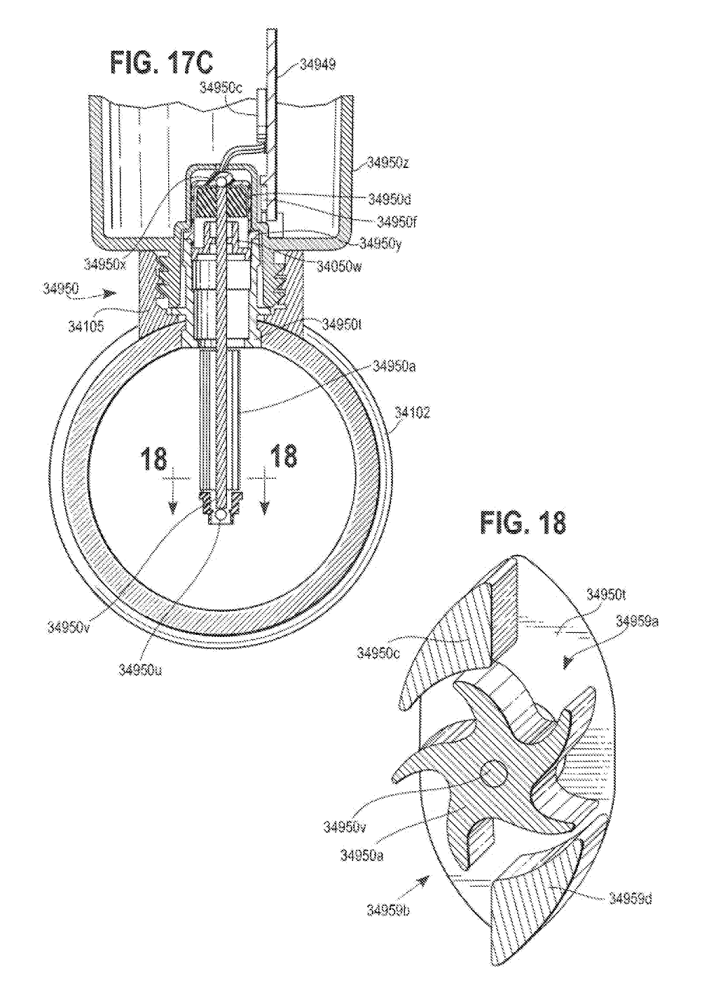

FIGS. 16 and 17A-C are a circuit diagram for an alternate flow meter embodiment and an alternate rotor or impeller type flow meter embodiment, respectively. In FIG. 16, a circuit is provided having similar power circuitry 24955, microcontroller 24950p, LEDs 24950i and 24950j, and switch 24950g, but also using additional integrated circuits instead of the discrete logic discussed above with respect to FIG. 9. In FIG. 17, an alternate flow meter 34950 is illustrated, which can be screwed into a threaded column or bore, similar to how the above-mentioned solenoids are connected to bonnets or solenoid 34400. For example, in the form illustrated, the flow meter 34950 has a shape similar to solenoid 34400 and is fastened to a section of conduit 34102 which in turn is connected to the inlet 34202 of valve 34100. In keeping with the above practice, items that are similar to those discussed above will use the same latter three digit reference numeral as used above, but with the prefix “34” just to distinguish one embodiment from another.

In the form illustrated in FIGS. 17A-C, the flow meter accessory (i.e., flow meter 34950 and conduit 34102) is connected to the inlet end of the diaphragm valve 34202 via the internal threading present in inlet end 34202, The flow meter 34950 has a vertical turbine or paddle wheel 34950a which has a longitudinal axis about which the turbine rotates that is transverse to the fluid flow through the conduit 34102 (rather than the horizontal axis the above mentioned axial turbine flow meter of FIGS. 13A-15C rotates about which is generally parallel to the fluid flow through the inlet of the valve). More particularly, the flow meter 34950 includes a lower housing 34950t which forms a sleeve or socket within which a bearing, such as ceramic ball 34950u, is disposed, followed by shaft 34950v and impeller or turbine 34950a. A cap 34950w is placed over the opposite end of the shaft 34950v, near the top of the lower housing 34950t, but defines a central opening through which a portion of the shaft 34950v extends out from the lower housing 34950t and cap assembly 34950w. A magnet, such as magnetic arm 34950d, is provided having a cylindrical body with a central opening therein. The magnet 34950d is positioned on the shaft 34950v with the distal end of the shaft being disposed in the central opening of magnet 34950d. A second bearing, such as ceramic ball 34950x, is placed over the distal end of the shaft 34950v above the magnet 34950d and these components are sealed into lower housing 34950t via upper housing 34950y. The ceramic ball bearings 34950u, 34950x serve as thrust bearings and provide low-friction vertical location for the turbine 34950a. Radial location for the turbine 34950a is provided by grit-resistant bearing structures such as radial ribs located in lower and upper housings 34950u, 34950y whose ends form an interrupted cylindrical surface within which or into which the ends of shaft 3450v extend (or are disposed). The rib-end surfaces provide radial support while the gaps between them provide escape paths for grit which would otherwise slow or stop the shaft 34950v and/or turbine 34950a.

In a preferred form, a friction fit is formed between the upper housing 34950y and lower housing 34950t when the two are connected together and then the assembled or interconnected housings 34950t, 34950y are connected into a bottom sleeve or socket defined by sensor housing 34950z. This latter connection is also preferably a friction fit so that the components can be disassembled and serviced as needed. However, in alternate embodiments these connections may be made via any means of engagement or fastening such as, but not limited to, by welding, by use of adhesive, use of screws, bolts or rivets, or use of mating threading (preferably likely reverse threading so that the components do not come apart as the flow meter 34950 is screwed into conduit 34102 or some other structure). In the form illustrated, the turbine 34950a, shaft 34950v and magnet 34950d are all press fit or friction fit together so that they do not move independent from one another and rotation of one (e.g., turbine 34950a) results in rotation of the others (e.g., shaft 34950v and magnet 34950d). This is accomplished by having the diameter of shaft 34950v larger than the diameter of the central openings defined by turbine 34950a and magnet 34950d.

It should be understood, however, that in alternate embodiments, the turbine 34950a, shaft 34950v and magnet 34950d (as well as cap 34950w if desired) may all be keyed so that they do not move independent from one another and rotation of one (e.g., turbine 34950a) results in rotation of the others (e.g., shaft 34950v and magnet 34950d). For example, the cross-section of shaft 34950v could be made with a flat side (e.g., round with a flat, triangular, rectangular, etc.) and the central openings defined by turbine 34950a and magnet 34950d could be made with a corresponding shape (e.g., a round shape with a flat, a triangle, a rectangle, etc.) so that rotation of the turbine 34950a results in rotation of the shaft 34950v and magnet 34950d.

The lower housing 34950t preferably has openings for allowing fluid to flow through at least a portion of the housing and past turbine 34950a to drive the turbine 34950a and rotate shaft 34950v. In the form illustrated and as can be best seen in the cross-sectional view of the FIG. 18, the housing has two large openings 34959a, 34959b which are formed by housing members 34959c and 34959d which run the length of the height of the turbine 34950a and are positioned on opposite sides of the housing, preferably diagonal to one another or kitty-corner to one another.

In the form illustrated, the turbine 34950a is designed to rotate in a single direction of rotation or pattern. This is accomplished by placing the housing members 34959c, 34959d such that the upstream housing member directs flow toward one half of the turbine 34950a or so that it obstructs flow from the other half of the turbine and the downstream housing member directs flow along the backside of the turbine 34950a in the same direction of rotation. In addition, the blades of turbine 34950a are also curved to encourage movement of the turbine 34950a in the same direction of rotation. In the form shown, the blades of turbine 34950a are cupped such that they collect fluid in one direction of rotation or have increased friction and resistance when traveling in the opposite direction, thus, the turbine 34950a is encouraged to spin in the direction of rotation that presents the least amount of resistance/friction. By designing the flow meter such that the turbine 34950a will always rotate in the same direction, it is also possible to use a more simplistic circuit to detect and relay data relating to flow rate and to design a housing that will properly guard or shield the turbine 34950a because of the known direction of rotation. In the form illustrated, two oppositely orientated magnets are used in magnet assembly 34950d which pull with one orientation and push with the other so that the magnets alternately switch a Hall Effect sensor on and off, creating a fluid flow data signal. If the direction of rotation for turbine 34950a is not known, than additional magnets would likely be needed and would need to be offset from one another to allow the flow meter to determine what direction of rotation the turbine is currently moving in or if the direction of rotation has changed. In alternate forms, such a multiple offset magnet circuit may be desired and used.

The housing members 34959c, 34959d illustrated are also curved or shaped to further reduce the amount of disruption or turbulence the flow meter 34950 introduces into the system to help prevent or reduce further pressure losses and turbulence being added to the system. In addition, housing members 34959c, 34959d serve as protection, such as a screen or guard, for the turbine 34950a by only leaving a portion of the turbine exposed to in-line fluid and the debris carried thereby and by deflecting debris that comes into contact with the housing member 34959c, 34959d that is positioned upstream of the turbine 34950a.

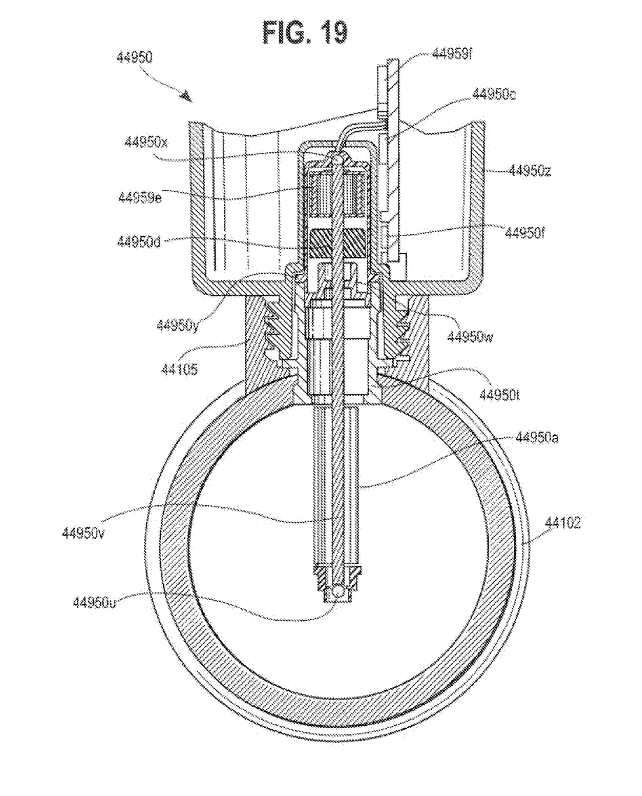

In the form illustrated, rotation of turbine 34950a causes corresponding rotation of shaft 34950v and magnet 34950d. The rotation of magnet 34950d generates a signal indicative of fluid flow rate which the flow meter, valve or irrigation system controller (depending on configuration) will use to determine if the valve should be shut or left open. In the form illustrated, the magnet is positioned close enough to printed circuit board 34949 in sensor housing 34950z that Hall Effect sensor 34950f can receive this data wirelessly and generate the corresponding signal. However, in alternate forms, the flow meter 34950 may be designed to detect this magnet rotation and transmit signals to the printed circuit board via wire if desired (e.g., see FIG. 19).

As mentioned above, the sensor body 34950z has a bottom sleeve or socket into which the assembled lower and upper housing 34950t, 34950y is disposed. In the form illustrated this socket extends down coaxially or concentrically from an upper canister that defines a cavity within which the printed circuit board 34949 is disposed or mounted. Once the printed circuit is disposed in the upper canister of sensor body 34950z, the upper canister is filled with conventional potting material so that the electronics of the flow meter are completely sealed and waterproof. In alternate embodiments, however, the electronics could be waterproofed and sealed using a sealed cap over the open end of the sensor body 34950z or other conventional methods. In the form illustrated, wires will extend out from the potting material, but the number depends on how the flow meter is configured (e.g., is it in series between the valve solenoid and a master irrigation controller, is it only connected to the system controller and the controller itself is directly connected to the valve, is the flow meter integral to the valve such that the valve and flow meter electronics are on the same printed circuit board, etc.). In the form illustrated, the socket extending down from the sensor cavity is externally threaded so that the sensor body 34950z (and hence the flow meter 34950) can be thread into a threaded bore like 34105 illustrated in the conduit 34102 in FIG. 17B.

In a preferred form, the conduit 34102 has an inlet end 34103 that is internally threaded for receiving the end of a pipe from the irrigation system (similar to how the inlet of the above mentioned valves receive such pipes. Conversely, the outlet end 34104 of conduit 34102 has external threading and is intended to be thread into the inlet of a diaphragm valve in a manner similar to how the piping is thread into the inlet of the above mentioned valves and the inlet 34103 of conduit 34102.

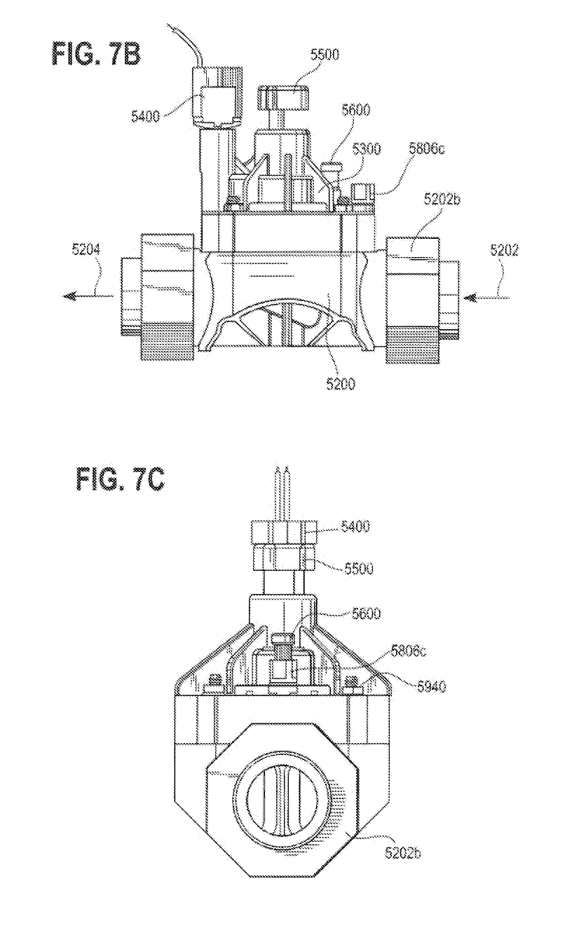

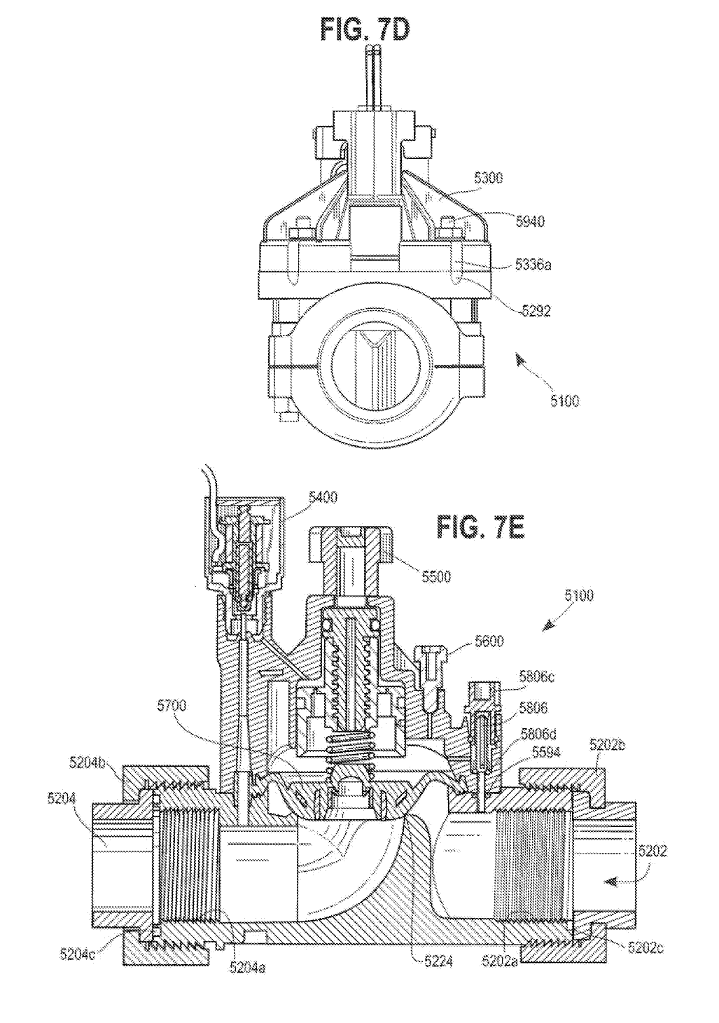

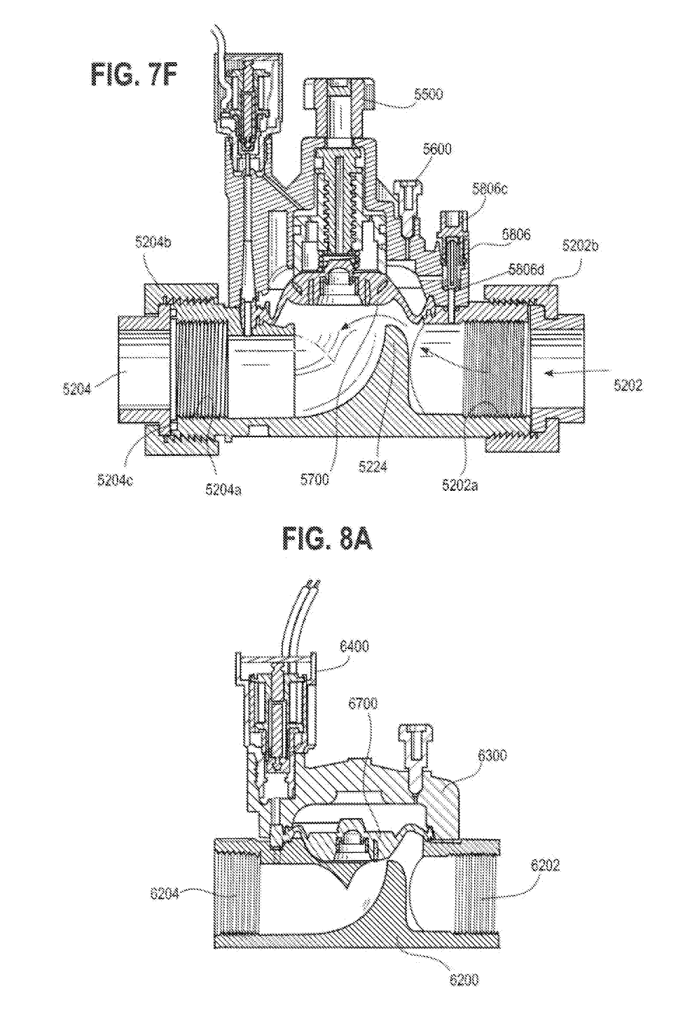

Thus, with this configuration, the flow meter 34950 may be sold as an accessory to retrofit old valves or valves that are not equipped with a flow meter, or it could be attached to new valves and sold as a complete unit. In yet other forms, the alternate flow meter 34950 could be thread into an opening similar to that used for filter 5806 in FIGS. 7A-F. The opening would either have to be positioned such that the turbine 34950a is disposed into the inlet fluid flow path only and not part of the filter and control chamber inlet passage, or the flow meter design would have to include a passage to allow fluid to flow from inlet 34202, through the flow meter 34950 and on through the remainder of the control chamber inlet passage. One advantage to this threaded flow meter design is that the flow meter 34950 can be easily installed, removed, serviced and/or replaced. In addition, the flow meter could easily be replaced with an end cap so that the valve can be sold without the flow meter feature if desired.

Although the above embodiments provide numerous embodiments with some having flow meters with onboard controllers and sensors and some linking to other devices that provide this function, it should be understood that in alternate embodiments, the flow meter and valves discussed herein can be configured in a variety of different ways. For example and as mentioned above, in one form, the flow meter may be wired in series between the diaphragm valve and a irrigation system controller. This flow meter may have circuitry onboard that allows it to sense fluid flow and to take responsive action (e.g., shut off the valve or stop powering the valve solenoid in response to unwanted fluid flow characteristics being detected). Alternatively, the flow meter could simply be wired to an irrigation system controller that actually performs this task. In some forms, the flow meter may simply provide signals back to a sensor and controller located at the main irrigation system controller. In yet other forms, the flow meter may provide signals to a controller located at the valve itself and that controller determines if the valve will remain open or close in response to fluid flow data. In still other forms, the flow meter may be installed in the valve itself rather than an accessory connected to the valve, and the circuitry for the valve and flow meter may be on one printed circuit board located onboard.

In yet other forms, the decision of how the flow meter will be connected into an irrigation system will further depend on how the flow meter is to be powered and/or controlled. For example, if the flow meter must be powered by an irrigation system controller and wires need to be run from the controller to the flow meter 34590, then it may be determined that it is just as easy (for that reason) to have the system controller control the flow meter and the system controller to turn on and off the valve based on the data provided from the flow meter. To help maximize the flexibility of what can be done with the flow meter and how it can be implemented into an irrigation system yet another embodiment is illustrated in FIG. 19. In keeping with the above practice regarding the desire to not be too redundant, items that are similar or the same as those discussed above will be referenced using the same latter three digit reference numeral but will have the prefix “44” merely to distinguish one embodiment form another. In the form illustrated in FIG. 19, the flow meter 44950 is very similar to that of flow meter 34950 of FIGS. 17A-C and 18, however, flow meter 44950 also includes a generator 44959e and a power storage device, such as battery 44959f. More particularly, in the form illustrated in FIG. 19, rotation of turbine 44950a causes shaft 44950v to rotate which in turn rotates not only magnet 44950d, but also generator 44959e. The shaft 44950v doubling as both the magnet rotating shaft and the turbine generator shaft and rotating a rotor inside of a stator to generate energy to be stored and used to power something. Thus, flow meter 44950 is not only a flow meter, but also is a hydroelectric generator that uses the fluid flow through the conduit 44102 to generate electricity which is stored in an energy storage device such as battery 44959f. This stored energy is then used to power the circuitry of the flow meter 44950 (e.g., the controller 44950c, Hall Effect sensor 44950f, etc.).

It should be understood, however, that in other forms, in addition to being a self powered flow meter, the flow meter 44950 may be designed (if the intended application allows or such) to power the valve solenoid in addition to the flow meter 44950 and/or to power a transceiver or transmitter or receiver of some type. For example, in one form the flow meter 44950 powers its own electronics which include a transceiver for wirelessly transmitting fluid flow data back to the main irrigation system controller and/or for wirelessly receiving data from the main irrigation system controller. The size of the power applications that the flow meter 44950 can power depend largely on the size generator that the flow meter 44950 is capable of being equipped with, which further depends on the size generator the turbine can rotate for the given fluid flow application in which it is inserted. Thus, some flow meters in accordance with this invention may be capable of greater power applications because of the type of application they are used in. For example, a flow meter in accordance with the embodiments disclosed herein that is used in a commercial or industrial application like at municipal water treatment facilities or hydroelectric power plants will be capable of more power applications than a flow meter in accordance with the embodiments disclosed herein that is used in a residential application like a home sprinkling system. Thus, it may be possible to use a flow meter like the type illustrated in FIG. 19 to power itself in the residential application, but also possible to use such a flow meter to power an entire irrigation system or zone at an commercial or industrial facility. Both, however, make sense in pursuing particularly given the drive to push zero energy (or net-zero) facilities. For example, although the flow meter 44950 in the residential application may not be able to power the entire irrigation system, the fact it can generate any energy at all may be enough when combined with other energy saving and generating tactics at a residence to reach zero energy status.

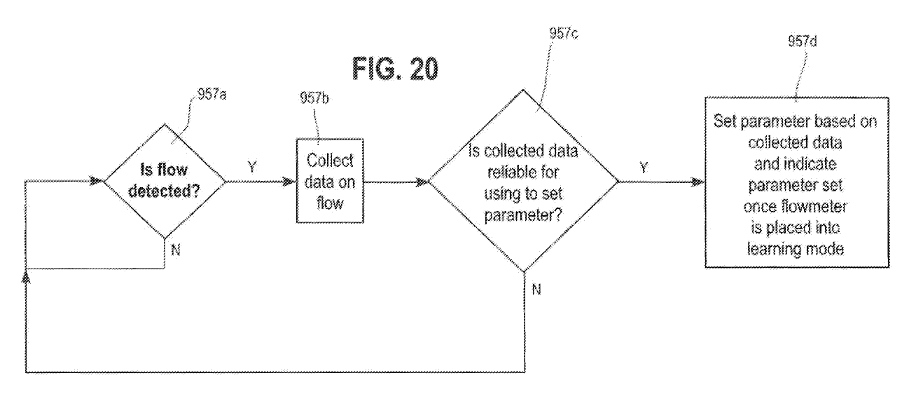

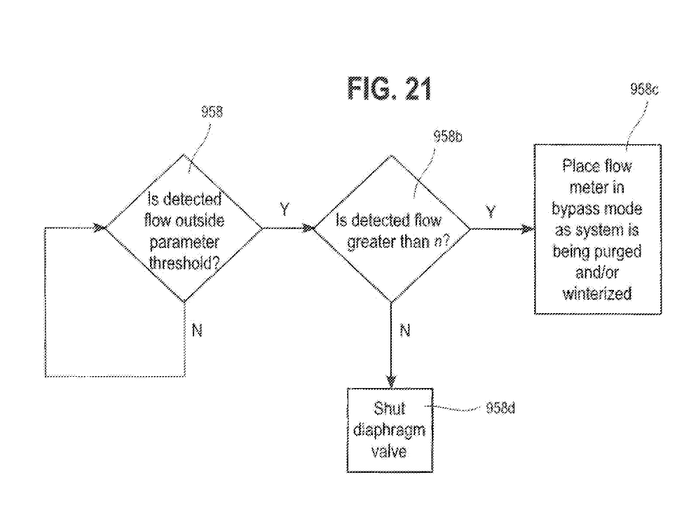

Turning now to FIGS. 20 and 21, there are disclosed two additional ways in which flow meters may operate in accordance with the inventions disclosed herein. In FIG. 20 a method for saving time in programming a flow meter is disclosed for use with any of the flow meters, valves and controllers disclosed herein. More particularly, as has been discussed, a method of monitoring fluid flow in an irrigation system is disclosed herein and comprises establishing at least one normal fluid flow parameter through the irrigation system via an initial learning period (e.g., such as parameters of what normal high flow is, what normal low flow is, what average flow is, adding some buffer amount to these figures to come up with a threshold value or coming up with a window that represents acceptable high and low flow rates, or windows of unacceptable high rates or low rates, etc.), monitoring current fluid flow through the irrigation system, determining, by a processor based apparatus, if the current fluid flow is consistent with the at least one normal fluid flow parameter, and taking action in response to a determination that the current fluid flow is not consistent with the at least one normal fluid flow parameter.

What action is taken can be a variety of things. For example, in one form, the action taken by the flow meter can be shutting a valve and/or providing an alert that current fluid flow is not consistent with the at least one parameter. The alert may include sending a notice to a user, triggering an audible alarm, displaying a visual indicator or alert, and sending a notice regarding the event may include sending a signal to a remote device.

In a preferred form, the method of establishing the at least one normal fluid flow parameter comprises activating a learn mode through an input and determining what normal fluid flow through the irrigation system is during a period of time when the system is known to be operating normally. As mentioned above, establishing the at least one normal fluid flow parameter may include adding an upper and/or lower buffer amount to an actual fluid flow detected in order to account for acceptable variances in fluid flow, acceptable pressure fluctuations or occasional and acceptable spikes above or below normal fluid flow in the fluid line or irrigation system.

In prior embodiments discussed above, it was discussed how a system operator can put the flow meter into a learn mode to establish the at least one normal fluid flow parameter which is not difficult for irrigation systems with a limited number of valves covering a limited geographical location or space. In larger irrigation systems and/or systems covering more area and/or having valves or flow meters spaced further apart, the need to put each flow meter or valve into learn mode can take-up a significant amount of time. This is particularly true, if the system operator needs to go to each unit, actuate an input for a predetermined period of time (e.g., depressing a push button for a minimum of 5 seconds) and then wait with the unit until a sufficient amount of data has been received to establish the at least one normal fluid flow parameter.

Thus, in the method of FIG. 20, a time saving method is disclosed in which the flow meter is automatically programmed to detect flow from the moment the flow meter is placed into the irrigation system (e.g., automatically detect and track flow the moment flow is detected). In this time saving routine or method, the flow meter checks to see if flow is detected as illustrated in step 957a of FIG. 20 and if flow is not detected, the flow meter continues to check for flow or flow data being generated by the flow meter. However, if flow is detected, the flow meter automatically starts collecting the flow data as set forth in step 957b and starts processing whether the collected data is reliable enough to use for setting the at least one normal fluid flow parameter as set forth in step 957c. If the collected data is not reliable, the flow meter continues to collect flow data an periodically checks to see if the newly collected data is reliable enough to use for setting the at least one normal fluid flow parameter. If the collected data is reliable (or once the collected data is reliable), the flow meter automatically establishes the at least one normal fluid flow parameter based on the collected data and provides an indication to the system operator that this data is already established or set as set forth in step 957d.

In one form of the method, the flow meter determines if the data is within a factory installed range of acceptable flow rate data for use in establishing the at least one normal fluid flow parameter and provides an indication (e.g., illuminates a light, such as an LED, or provides a message via a display, etc.) if the data is within the factory installed range. In another form, the flow meter determines if the data is within a range of acceptable flow rate data from previous readings or from input provided by a user, such as data entered by a system operator or data provided from an irrigation system controller that corresponds to fluid flow data the system controller has stored for other flow meters, valves or zones in the irrigation system.

In one form of the method of FIG. 20, the step of automatically collecting data regarding fluid flow rate upon initiation of flow through the irrigation system comprises continuously collecting the data and using a statistical measure of the collected data to establish the at least one normal fluid flow parameter. The statistical measure may include using a median or mean of the data to establish the at least one normal fluid flow parameter.

In addition to saving time in programming the at least one normal fluid flow parameter, the methods and flow meters disclosed herein essentially provide a way for programming the at least one normal fluid flow parameter or learning or accomplishing this with the single actuation of an input or the actuation of a single input. In other words, the methods and flow meters disclosed herein disclose a way of learning, establishing or programming this data with just the touch of a button (or just the actuation of an input). In most of the forms illustrated herein, this single touch requires actuation of the input for a predetermined amount of time (e.g., 3 seconds, 5 seconds, 10 seconds, etc.) to activate a learn mode.

Another method of monitoring fluid flow in an irrigation system is disclosed herein which includes providing a controller coupled to a flow meter, a main valve and downstream valves with each downstream valve controlling different irrigation zones, establishing via the flow meter, at least one normal fluid flow parameter for each irrigation zone controlled by a downstream valve and storing the at least one normal fluid flow parameter for each irrigation zone in memory, monitoring (via the flow meter) current fluid flow for each irrigation zone controlled, determining (by a controller) if the current fluid flow for each irrigation zone is consistent with the at least one normal fluid flow parameter stored in memory for that irrigation zone, and shutting at least one of the main valve and downstream valves if the current fluid flow is not consistent with the at least one normal fluid flow parameter stored in memory for that irrigation zone.

In one form the controller sequentially activates the downstream valves and the step of shutting at least one of the main valve and downstream valves comprises shutting the main valve if the current fluid flow is not consistent with the at least one normal fluid flow parameter stored in memory for the activated irrigation zone. The method may further include automatically opening the main valve once the controller sequentially activates another irrigation zone, and then determining (by the controller) if the current fluid flow for each irrigation zone is consistent with the at least one normal fluid flow parameter stored in memory for the activated irrigation zone, and shutting the main valve if the current fluid flow is not consistent with the at least one normal fluid flow parameter stored in memory for the activated irrigation zone.

In another form, the controller sequentially activates the downstream valves and the step of shutting at least one of the main valve and downstream valves comprises first shutting the downstream valve associated with the irrigation zone currently activated and determining via the flow meter and processor based apparatus if the shutting of the downstream valve associated with the irrigation zone currently activated is a sufficient response and second shutting the main valve if the shutting of the downstream valve associated with the irrigation zone currently activated is not sufficient.

The method may further include automatically opening the main valve once the controller sequentially activates another irrigation zone, determining via the controller if the current fluid flow for each irrigation zone is consistent with the at least one normal fluid flow parameter stored in memory for the activated irrigation zone, and shutting at least one of the main valve and downstream valve associated with the activated irrigation zone if the current fluid flow is not consistent with the at least one normal fluid flow parameter stored in memory for the activated irrigation zone.

In FIG. 21, an alternate method is disclosed wherein the flow meter is further programmed to automatically determine if the fluid flow that is inconsistent with the normal fluid flow parameters is indicative that the irrigation system is being purged (e.g., flushed) or winterized and, if so, a suspend mode is entered for a predetermined period of time wherein the flow meter reading will not shut the valve despite the data being inconsistent with the normal fluid flow parameter (or at least one fluid flow parameter). In one form, a very high detected fluid flow reading is indicative that the irrigation system is being purged (e.g., flushed) or winterized and the flow meter remains in the suspend mode for a period of time sufficient to complete the purge or winterization of the irrigation system. For example, in FIG. 21, a routine is illustrated where the flow meter checks to see if the detected fluid flow data is outside of the at least one normal fluid flow parameter stored in memory at step 958a. If so, the flow meter determines in step 958b if the detected fluid flow data is greater than a predetermined figure (e.g., n). If the detected fluid flow data is greater than the predetermined figure, then the flow meter will automatically place itself into a suspend or hibernate mode in step 958c and so that the high fluid flow can continue unabated under the assumption the fluid flow is purposefully being driven this high (e.g., for purging/flushing or winterizing purposes). If the detected fluid flow data is less than the predetermined figure, then the flow meter assumes that an unwanted fluid flow event has been detected (e.g., not a desired fluid flow event like a purge) and will shut the valve in step 958d similar to what has been done in prior flow meter embodiments discussed herein.

In one form, the predetermined figure (e.g., n) will represent a very high fluid flow that would not normally be reached by the fluid traveling through the irrigation system even if there is a rupture downstream (e.g., an impossibly high fluid flow which could only mean that the system is being purged or winterized). For example, in an irrigation system, the flow meter turbine could only be spun at certain revolutions by air as compared to water or other liquids. Thus, if the fluid flow data indicates that the flow meter turbine is spinning at revolutions that must be air driven, the flow meter automatically goes into a suspend mode so that the valve remains open despite the high fluid flow data reading. It should be understood that in alternate embodiments, the flow meter may be setup to look to see if the detected fluid flow data is greater or equal to a predetermined amount and/or look to see if the detected fluid flow data is below a predetermined amount (e.g., less than or less than or equal to, etc.) in order to automatically take some action if the detected fluid flow indicates a fluid flow that is too low. For example, in one form, the flow meter determines if the detected fluid flow is below a predetermined figure (e.g., nn) and, if so, automatically shuts the valve as it is clear fluid is not flowing through the system as it should. Such action may be taken and desirable for a variety of reasons. For example, when low fluid flow is detected, it may be desirable to shut the valve in order to try and prevent allowing too much air from entering into the system. As discussed above, the presence of air in an irrigation system can have negative effects on valve operation (e.g., operation of the diaphragm and control chamber) and may require system operators to go bleed the air out of system components like conduit, valves, etc. Similarly, it may be desirable to automatically shut the valve in response to a low fluid flow reading in order to minimize the amount of wear and tear or environmental conditions that internal valve components are exposed to (e.g., minimizing the amount of air and air-born dust or debris the internal valve components are exposed to, etc.).

In one form or embodiment, the flow meter is pre-programmed with purge or winterization flow rate data that is used to determine if the fluid flow that is inconsistent with the normal fluid flow parameters is indicative that the irrigation system is being purged or winterized. In another form, the flow meter is programmed to learn purge or winterization flow rate data for the specific irrigation system the flow meter is used with and this learned purge or winterization flow rate data is used to determine if the fluid flow that is inconsistent with normal fluid flow parameters is indicative that the irrigation system is being purged or winterized.

Lastly, turning now to FIGS. 7A-H, there is illustrated another embodiment of a valve. In keeping with the above, similar items will use similar reference numerals with the exception of adding a prefix “5” to distinguish between embodiments. In this embodiment, a reverse flow valve 5100 is disclosed having an externally accessible filter 5806 and dual pipe attachment options including conventional NPT threading and Union fitting attachment options. More particularly, in the embodiment shown, valve 5100 includes a cartridge type filter 5806 which is disposed in the control chamber 5304 entrance passage and has an access door, such as knob 5806c, which provides ready access to the filter without the need to disassemble the bonnet 5300 from the valve body 5200. In the form illustrated the cartridge filter is sealed to passage 5590 leading from inlet passage 5202 via o-ring 5806d and has a reservoir or pool area outside the cartridge or canister of filter 5806, which the fluid travels to before heading into the control chamber 5304 via passage 5592. The second o-ring 5594 seals the bonnet 5300 to the valve body 5200. Thus, with this configuration, an installer or servicer need only unscrew cap 5806c to gain access to filter 5806 and can gain such access without the need to remove the bonnet 5300 from valve body 5200. In a preferred form, filter 5806 is of the universal screen type filter produced by Rain Bird Corporation of Azusa, Calif.

In addition to the externally accessible filter container 5806, the valve 5100 also includes dual pipe attachment options 5203 at the inlet 5202 and outlet 5204 passages of the valve 5100. More particularly, the pipe attachment structures include a first pipe attachment structure for connecting the valve into a system in one manner, and a second pipe attachment structure for alternately connecting the valve into the system in a second manner. In the form illustrated, the first pipe attachment structure is made-up of internally NPT threaded sleeves 5202a and 5204a and the second pipe attachment structure is made-up of union fittings 5202b and 5204b. The union fittings 5202b, 5204b include O-rings 5202c and 5204c which seal the connection between the valve inlet/outlet and it's mating pipe sections. More particularly, in the embodiment illustrated in FIGS. 7E-F, the pipe segments are positioned against the O-rings 5202c, 5204c and the union nut is thread onto the exterior thread of inlet and outlet passages 5202 and 5204 to clamp the pipe sections to the valve 5100. In this way, the valve 5100 is provided with options for connecting the valve 5100 into a system thereby making the valve 5100 easier to install and/or service.

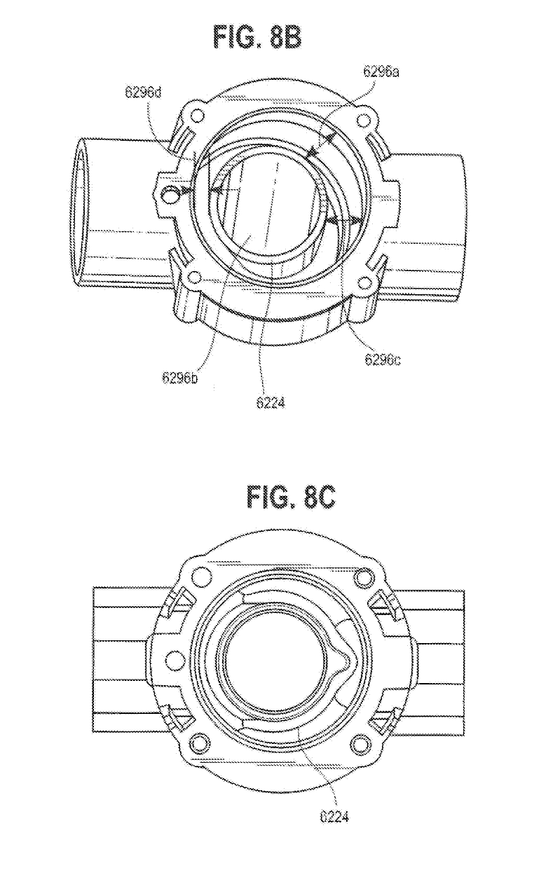

In FIGS. 8A-C, there is illustrated an alternative eccentric diaphragm valve 6100 which uses an offset diaphragm 6700 to reduce pressure loss when compared to a non-offset diaphragm. The Eccentric Valve 6100 includes a valve body with an inlet passage 6202 and an outlet passage 6204. The outlet passage 6204 turns upward in the valve body to define a valve seat 6224 that cooperates with a flexible diaphragm 6700 to control fluid flow through the valve 6100. A bonnet 6300 covers the diaphragm 6700 and forms a control chamber 6304 over the diaphragm 6700. A filtered through-hole on the diaphragm 6700 enables flow from the inlet passage 6202 to the control chamber 6304.

A solenoid valve 6400 mounted on the outlet side 6204 of the valve 6100 controls flow through a passage from the control chamber 6304 to the outlet passage. The solenoid 6400 activates a plunger that moves to cover and uncover a valve seat along the passage. When the plunger engages the seat, the control chamber 6304 fills and the valve 6100 closes. When the plunger uncovers the seat, fluid from the control chamber 6304 flows through the bypass outlet passage to the outlet passage enabling the valve 6100 to open.

Perspective and top views of two versions of the valve body 6100 are depicted in FIGS. 8B-C. In both designs, the inlet passage 6202 turns upward to form a partially annular cavity 6296a that surrounds an inner, cylindrical wall forming an outlet cavity 6296b and forming a single, annular seat that is the entrance to the outlet passage 6204. The seat is not concentric with the valve body and the outer rim of the diaphragm 6700.

Likewise, the valve seat engaging portion of the diaphragm 6700 also has an offset corresponding to the valve seat 6224. Particularly, while viewing the diaphragm in a top view, the central, circular, thickened portion of the diaphragm valve 6700 that engages the valve seat 6224 is offset toward the valve outlet 6204 relative to the center of the diaphragm 6700. The offset seat allows more room for the incoming flow to enter the body cavity surrounding the seat. The fact that the diaphragm hinges from the outlet side and opens wider at the inlet side allows the diaphragm to guide the flow more smoothly through the valve seat. These features combine to reduce the pressure loss over valves using concentrically located seats.

The drawings and the foregoing descriptions are not intended to represent the only forms of the diaphragm valve 100 in regard to the details of construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation. For example, although the foregoing benefits may each be achieved in the presently-disclosed diaphragm valve 100, other diaphragm valves may be configured to incorporate less than all of the configurations that result in these benefits.

It should also be understood that in addition to the various valves and accessories discussed herein, there have also been disclosed numerous methods relating to valves and/or accessories for use with valves. For example, new methods for filtering fluid to be delivered to a control chamber have been disclosed herein, as well as methods for cleaning such filters. Methods for draining control valves have also been disclosed as well as methods for assembling irrigation equipment (including, but not limited to, methods for clamping irrigation equipment or valve components, methods for simplifying installation and/or serviceability of irrigation equipment and, in particular, valve assemblies, methods for cleaning or flushing valve components). There have also been disclosed methods for assembling valve components to simplify installation and serviceability, methods for flushing valve assemblies of debris, methods of coupling irrigation components, methods for operating valves, flow meters and/or irrigation systems and methods for automatically responding to certain fluid flow conditions, to name a few.

In summary, many different embodiments have been disclosed herein and even more embodiments are contemplated by the disclosure set forth herein. For example, a diaphragm valve has been disclosed comprising a valve body having an inlet, an outlet and an internal passage between the inlet and outlet. The valve further having a diaphragm assembly positioned between the inlet and outlet in the internal passage of the valve body, with the diaphragm assembly being movable between a closed position where fluid flow from the inlet to the outlet is blocked and an open position where fluid flow from the inlet to the outlet is permitted. A control chamber is disposed on one side of the diaphragm assembly, with a control chamber entrance passage to permit fluid to flow into the control chamber and a control chamber exit passage extending from the control chamber to permit fluid flow from the control chamber. The diaphragm valve having an actuator, such as a solenoid valve, positioned to selectively prevent and permit fluid flow through the control chamber exit passage from the control chamber to control closing and opening of the diaphragm assembly and, thus, control flow through the diaphragm valve. In one form, the internal passage of the valve body and the diaphragm assembly have cooperating guide structures for guiding the diaphragm assembly during at least a portion of the diaphragm assembly movement between the diaphragm assembly's open and closed positions.

The cooperating guide structures may take on various shapes and sizes and/or be located in various positions about the valve and on various components of the valve. For example, in one form, the guide structures include a protrusion extending from the valve body into at least a portion of the internal passage and an exterior surface of the diaphragm assembly which is guided by the protrusion during at least a portion of the diaphragm assembly's movement between the open and closed positions. The diaphragm valve may be a canted diaphragm valve, with the protrusion actually being a plurality of ribs extending from an inner surface of the valve body toward the outside diameter of the main valve seal portion of the diaphragm assembly.

In another form, the cooperating guide structures include a protrusion extending from one of the valve body or diaphragm assembly and into at least a portion of the internal passage and a recess defined by the other of the valve body or diaphragm assembly into which at least a portion of the protrusion extends to guide the diaphragm assembly during at least a portion of the diaphragm assembly movement between the open and closed positions. In this form, the diaphragm valve may be a canted diaphragm valve, and the protrusion may include a plurality of ribs extending from an inner surface of the valve body into at least a portion of the internal passage defined thereby and the recesses may be defined by the diaphragm assembly and comprises a plurality of channels guiding the plurality of ribs as the diaphragm assembly approaches the closed position. Alternatively, the diaphragm assembly may have an exterior sidewall with a height of a predetermined length with the recesses having a length that is at least twenty percent of the height of the exterior sidewall of the diaphragm assembly to ensure that the diaphragm assembly is well guided via the guide structures. In some forms the recesses may have a height that takes up much more than twenty percent of the height of the exterior sidewall of the diaphragm assembly. For example, in some forms the recesses may take up eighty to one hundred percent of the height of the exterior sidewall of the diaphragm assembly.

The diaphragm valve assembly may also include a flow-control assembly that can be adjusted to reduce or increase the amount the diaphragm assembly travels between the open and closed positions to control fluid flow volume through the diaphragm valve when open. The flow-control assembly may also have a guide member that guides the diaphragm assembly during at least a portion of the diaphragm assembly movement between the open and closed positions. Meaning that the diaphragm assembly is well guided both at its lower portion and upper portion throughout the diaphragms movement between the open and closed positions.

In one form, the flow-control assembly guide member is an adjustable stop member that controls the travel of the diaphragm assembly when moved to the open position and has a first portion that extends into a portion of the diaphragm assembly and guides the diaphragm assembly during at least a portion of the diaphragm assembly movement between the open and closed position. The diaphragm assembly may define a recess into which the first portion of the adjustable stop is disposed when the diaphragm assembly is moved toward the open position so that the adjustable stop guides the diaphragm assembly when the diaphragm assembly approaches the open position and the cooperating guide structures of the valve housing and diaphragm assembly guide the diaphragm assembly when approaching the closed position.

In another embodiment, a diaphragm valve is disclosed that simply has a well guided upper portion of the diaphragm assembly. Like the above embodiment, this diaphragm valve may include a valve body having an inlet, an outlet and an internal passage between the inlet and outlet, a diaphragm assembly positioned between the inlet and outlet in the internal passage of the valve body, the diaphragm assembly being movable between a closed position where fluid flow from the inlet to the outlet is blocked and an open position where fluid flow from the inlet to the outlet is permitted, a control chamber disposed on one side of the diaphragm, a control chamber entrance passage to permit fluid to flow into the control chamber, a control chamber exit passage to permit fluid flow from the control chamber, and a solenoid valve positioned to selectively prevent and permit fluid flow through the control chamber exit passage from the control chamber to control closing and opening of the diaphragm assembly to control flow through the diaphragm valve. However, in this form, the diaphragm valve also includes an adjustable flow-control assembly to adjust the amount the diaphragm assembly moves between the open and closed positions to control the amount of fluid flow through the diaphragm valve when open and the time for the diaphragm assembly to move between the open and closed positions, the flow-control assembly further guiding the diaphragm assembly during at least a portion of the diaphragm assembly movement between the open and closed positions.

The adjustable flow-control assembly may include a movable stop member to set the amount of travel for the diaphragm assembly when moved to the open position and have a first portion that extends into a portion of the diaphragm assembly and guides the diaphragm assembly during at least a portion of the diaphragm assembly movement between the open and closed position. In one form (e.g., see FIGS. 3A-L), the diaphragm assembly defines a recess into which the first portion of the movable stop is disposed when the diaphragm assembly is approaching the open position so that the translatable stop guides the diaphragm assembly when the diaphragm assembly approaches the open position.

Like the earlier mentioned embodiment, this alternate embodiment may also have cooperating guide structures between the internal passage of the valve body and the diaphragm assembly for guiding the diaphragm assembly during at least a portion of the diaphragm assembly movement between the open and closed positions; however, such structures may not be present in some forms or embodiments. If present, the cooperating guide structures may include a protrusion extending from the valve body into the internal passage defined by the valve body and an exterior surface of the diaphragm assembly which is guided by the protrusion during at least a portion of the diaphragm assembly movement between the open and closed positions. The protrusion extending from the valve body into the internal passage defined by the valve body may comprise a plurality of ribs extending from an interior surface of the valve body toward the internal passage which guide the exterior surface of the diaphragm assembly as it moves between the open and closed positions.

Alternatively, the cooperating guide structures may comprise a protrusion extending from the valve body into the internal passage defined by the valve body and a recess defined by the diaphragm assembly into which at least a portion of the protrusion is disposed for guiding the diaphragm assembly during at least a portion of the diaphragm assembly movement between the open and closed positions. In one form, the diaphragm valve is a canted diaphragm valve, the protrusion is a plurality of ribs extending from an inner surface of the valve body, the recess is a plurality of recesses that correspond to the plurality of ribs so that each of the plurality of ribs extends into a corresponding recess of the plurality of recesses defined by the diaphragm.

With either form of cooperating guide structures (e.g., the first abutting surfaces form or the latter interlocking or overlapping form), the cooperating guide structures and the flow-control assembly may be configured so that there is overlap in the guidance of the diaphragm assembly between the cooperating guide structures and the flow-control assembly so that the diaphragm assembly is guided throughout its movement between the open and closed positions.

Thus, disclosed herein are diaphragm valves having guide structures connected to the valve body and at least one of the diaphragm assembly and valve bonnet for guiding the diaphragm assembly throughout movement of the diaphragm assembly between the closed and open positions. The guide structures comprise first guide structures for guiding the diaphragm assembly as the diaphragm assembly approaches the closed position and second guide structures for guiding the diaphragm assembly as the diaphragm assembly approaches the open position so that the diaphragm assembly is well guided throughout movement of the diaphragm assembly between the closed and open positions. The guidance of the first and second guide structures may overlap with one another so that the diaphragm assembly is continually guided throughout movement between the closed and open positions. Alternatively, the guide structures may purposely be designed not to overlap in applications wherein less control and more freedom of movement is desired.

In another embodiment, a diaphragm valve is disclosed herein having a valve body having an inlet, an outlet and an internal passage between the inlet and outlet, a diaphragm assembly positioned between the inlet and outlet in the internal passage of the valve body, the diaphragm assembly being movable between a closed position where fluid flow from the inlet to the outlet is blocked and an open position where fluid flow from the inlet to the outlet is permitted, a valve bonnet defining at least in part a control chamber disposed on one side of the diaphragm assembly, a control chamber entrance passage to permit fluid to flow into the control chamber, a control chamber exit passage and a solenoid valve positioned to selectively prevent and permit fluid flow through the control chamber exit passage from the control chamber to control closing and opening of the diaphragm assembly to control flow through the diaphragm valve. Unlike conventional valves, however, the control exit passage of this embodiment extends from the control chamber about a periphery of at least one of the valve bonnet and valve body to permit fluid flow from the control chamber.

In one form of this embodiment, the control chamber exit passage is formed between the valve bonnet and valve body and circumnavigates the inner passage of the valve body. For example, the valve bonnet may be designed with an annular side wall and the control chamber exit passage is positioned between an exterior surface of the annular side wall of the valve bonnet and an interior wall of the valve body. In the embodiment illustrated in FIGS. 3A-K above, the diaphragm assembly has a distal end terminating in a bead and the diaphragm valve further comprises a seal which together with the bead, the valve bonnet and valve body define the control chamber exit passage. More particularly, the bead is positioned on a lower portion of the exterior surface of the annular side wall of the valve bonnet and the seal is positioned on an upper portion of the exterior surface of the annular side wall of the valve bonnet to form respective lower and upper boundaries of the control chamber exit passage while the exterior surface of the annual side wall and interior surface of the valve body define side boundaries of the control chamber exit passage.

In the alternate form illustrated in FIGS. 1A-2C, the diaphragm assembly has a distal end terminating in a bead and the valve body defines a recess about an upper surface of the valve body that together with the bead forms the control chamber exit passage. More particularly, the bead is captured between the valve bonnet and valve body when the valve bonnet is secured to the valve body.

Another diaphragm valve is disclosed herein that includes a diaphragm having a stroke to active web outer diameter ratio between thirty and thirty-nine percent. In this form, the diaphragm valve has a valve body having an inlet, outlet and an internal passage between the inlet and outlet, and a diaphragm assembly being positioned between the inlet and outlet in the internal passage of the valve body, the diaphragm assembly having a stroke comprising movement between a closed position where fluid flow from the inlet to the outlet is blocked and an open position where fluid flow from the inlet to the outlet is permitted. The diaphragm valve also having a control chamber disposed on one side of the diaphragm assembly, a control chamber entrance passage to permit fluid to flow into the control chamber, a control chamber exit passage to permit fluid flow from the control chamber, and a solenoid valve positioned to selectively prevent and permit fluid flow through the control chamber exit passage from the control chamber to control movement of the diaphragm assembly between the open and closed positions. Unlike conventional diaphragm vales, however, in this embodiment the diaphragm assembly includes a diaphragm with an active web outer diameter and the ratio of diaphragm assembly stroke to active web outer diameter is between thirty and thirty-nine percent. For example, in FIGS. 1A-2C and 3A-3L, the stroke of the diaphragm assembly is the distance the diaphragm assembly moves up and down when the diaphragm assembly is moved between its open and closed positions. The active web of the diaphragm is the portion of dish diaphragm 710, 1710 that is not pinched between the bonnet 300, 1300 and vale body 200, 1200. Thus, the outer diameter of the active web would be the diameter of the dish diaphragm up to where the dish diaphragm gets pinched between the bonnet and valve body. The inner diameter of the valve body and bonnet at this same point is likely a comparable measurement as well. By having such a stoke to active web outer diameter ratio, the diaphragm assembly can be designed and built to a size and profile that is desired for most irrigation system applications.

In one form of this embodiment, the diaphragm valve is a canted diaphragm valve having an angled valve seat and the stroke is between about thirty and thirty-nine percent of the active web outer diameter of the diaphragm assembly at line fluid pressures between twenty and two-hundred thirty pounds per square inch (20-230 psi). In another form, the diaphragm valve is a canted diaphragm valve having an angled valve seat and the stroke is at least thirty and no more than thirty-nine percent of the active web outer diameter of the diaphragm assembly at a pressure rating between one-hundred fifty and two-hundred thirty pounds per square inch (150 psi and 230 psi). For example, the canted diaphragm valve may be designed wherein the stroke is approximately thirty-five percent of the active web outer diameter of the diaphragm assembly at a pressure rating of between at least one-hundred fifty pounds per square inch (150 psi) and no more than two-hundred thirty pounds per square inch (230 psi).

In another embodiment, a readily manufactured/assembled valve and/or a readily installable and serviceable diaphragm valve has been disclosed herein. In this embodiment, the diaphragm valve has a valve body having an inlet, an outlet and an internal passage between the inlet and outlet, and an upper opening, the valve body also defining a valve seat located in the internal passage opposing the upper opening of the valve body. A diaphragm assembly is positioned between the inlet and outlet in the internal passage of the valve body, and is movable between a closed position where a valve seal is positioned on the valve seat to prevent fluid flow from the inlet to the outlet and an open position where the valve seal is spaced apart from the valve seat to permit fluid flow from the inlet to the outlet. The valve also has a bonnet defining at least in part a control chamber disposed on one side of the diaphragm assembly, a control chamber entrance passage to permit fluid to flow into the control chamber, a control chamber exit to permit fluid flow from the control chamber, and a solenoid valve positioned to selectively prevent and permit fluid flow from the control chamber to control the fluid pressure in the control chamber to control movement of the diaphragm assembly between the open and closed positions. Unlike conventional valves, however, the valve bonnet and diaphragm assembly of the diaphragm valve are interconnected and insertable into and removable from the upper opening of the valve body together as a unit to provide access to the valve seal or valve seat.

In one form of this embodiment, the diaphragm valve further includes a flow control assembly extending through the bonnet and having a handle connected to an end thereof, the flow control assembly and handle being interconnected with the diaphragm assembly, valve bonnet and control chamber so that the flow control assembly, handle, diaphragm assembly, valve bonnet and control chamber being insertable into and removable from the upper opening of the valve body together as a unit to provide access to the valve seal or valve seat. The diaphragm valve may also include a filter disposed in the control chamber entrance passage and connected to the diaphragm assembly to filter fluid flowing to the control chamber, the filter being interconnected with the diaphragm assembly, valve bonnet, control chamber, flow control assembly and handle so that the filter, diaphragm assembly, valve bonnet, control chamber, flow control assembly and handle being insertable into and removable from the upper opening of the valve body together as a unit to provide access to the valve seal or valve seat.

In yet other forms, the diaphragm valve may also include a scrubber assembly mounted in the inlet opening of the valve body and aligned coaxially with the filter to scrub the filter as the diaphragm assembly moves between the open and closed positions. In some forms a debris screen is also included and positioned upstream of the diaphragm assembly to block larger forms of debris from entering further into the valve body. For example, in one form the debris screen is formed integrally with the remainder of the scrubber assembly and is interconnected with the filter, diaphragm assembly, valve bonnet, control chamber, flow control assembly and handle so that the integral scrubber and screen, filter, diaphragm assembly, valve bonnet, control chamber, flow control assembly and handle being insertable into the upper opening of the valve body together as a unit or as an interconnected internal valve component assembly. The integral scrubber and screen may be configured to be installed into the upper opening of the valve body together with the interconnected filter, diaphragm assembly, valve bonnet, control chamber, flow control assembly and handle and may remain in the valve body when the interconnected filter, diaphragm assembly, valve bonnet, control chamber, flow control assembly and handle (or interconnected unit) is being removable from the upper opening of the valve body. The integral scrubber and screen may also have a grasping surface for removing the integral scrubber and screen from the upper opening of the valve body once the filter, diaphragm assembly, valve bonnet, control chamber, flow control assembly and handle are removed from the upper opening of the valve body. Moreover, in one form, the valve is a canted valve with the valve body defining an angled valve seat with the filter, diaphragm assembly, valve bonnet, control chamber, flow control assembly and handle all being coaxially aligned with respect to the angled valve seat to allow for the diaphragm and valve seal to move between the open and closed positions.

In addition to valves, specific features or components of valves are disclosed herein which are markedly improved over conventional valve components and features. For example, in one embodiment an improved filter and scrubber assembly is disclosed herein. The filter is connected to a diaphragm valve having a valve body having an inlet, an outlet and an internal passage between the inlet and outlet, and an upper opening, with the valve body also defining a valve seat located in the internal passage opposing the upper opening of the valve body. A diaphragm assembly positioned between the inlet and outlet in the internal passage of the valve body, the diaphragm assembly being movable between a closed position where a valve seal is positioned on the valve seat to prevent fluid flow from the inlet to the outlet and an open position where the valve seal is spaced apart from the valve seat to permit fluid flow from the inlet to the outlet. A control chamber disposed on one side of the diaphragm assembly and having a control chamber entrance passage to permit fluid to flow into the control chamber and a control chamber exit to permit fluid flow from the control chamber. The diaphragm valve also having a solenoid valve positioned to selectively prevent and permit fluid flow from the control chamber to control the fluid pressure in the control chamber to control movement of the diaphragm assembly between the open and closed positions. The filter is connected to the control chamber entrance passage to filter the fluid permitted to flow into the control chamber and the scrubber assembly comprises a removable scrubber assembly disposed within the inlet of the valve body and having scrubber members that define an opening within which the filter is disposed such that the scrubber members engage at least a portion of filter to clean the filter as the filter moves with respect to the scrubber members.

In several forms, the filter is connected to the diaphragm assembly and moves along with the diaphragm assembly as the diaphragm assembly moves between the open and closed positions, and the scrubber members comprise a plurality of fingers that extend about a periphery of the filter and engage at least a portion of the filter with inner surfaces of each finger to clean the filter as the filter moves with respect to the scrubber fingers. More particularly, in the form illustrated in FIGS. 4A-N, the inlet of the valve body curves toward the valve seat and the filter has at least one side with a radius of curvature that tracks the curve of the inlet to allow for a larger filter having a larger surface area for filtering and passing fluid through to the control chamber. The filter is fin shaped and the opening defined by the removable scrubber assembly corresponds in shape to the fin and the scrubber fingers clean external surfaces of the fin as the filter moves with respect to the scrubber fingers. In addition, the removable scrubber assembly has a cylindrical portion that fits within the inlet of the valve body and is secured to the inlet of the valve body, the cylindrical portion of the removable scrubber assembly having a first longitudinal axis and the opening defined by the scrubber members having a second longitudinal axis that is generally transverse to the first longitudinal axis. The diaphragm assembly may further define a slot and the filter may include a flange that slidingly engages the slot to secure the filter to the diaphragm assembly. In a preferred form, the filter and diaphragm have interlocking structures that mate the filter to the diaphragm assembly. In one example, the interlocking structures comprise a detent that secures the filter to the diaphragm assembly when the filter is fully slid into the slot defined by the diaphragm assembly, the detent allowing the filter to be released from the diaphragm assembly slot by applying force to a surface of the filter.

In another form, the filter and/or scrubber may be designed to be top serviceable in another way so that the filter can easily be removed from the valve body and serviced (e.g., cleaned, repaired, replaced, etc.). For example, in the embodiment illustrated in FIGS. 3A-L, the valve seat is removable from the valve body and fits within a recess defined by the valve body, with the removable valve seat being used to capture the removable scrubber and filter assembly in the recess defined by the valve body when installed in the recess and allowing for both the valve seat and removable scrubber assembly to be removed from the valve body when desired. The removable scrubber assembly includes a debris screen that is positioned upstream of the scrubber assembly to help filter debris from entering further into the inlet and contacting the removable scrubber assembly or filter disposed therein. In this form the valve seat and diaphragm assembly support member form an integral structure, with the diaphragm support member supporting at least a portion of the diaphragm assembly to prevent the assembly from stretching overtime.

More particularly, the integral valve seat and diaphragm assembly support member have a general funnel shape with the integral diaphragm assembly support member being positioned above the valve seat in the internal passage defined by the valve body and having a first outer diameter and the valve seat being positioned below the integral diaphragm assembly support member in the internal passage defined by the valve body and having a second outer diameter smaller than the first outer diameter, wherein at least one of the first and second outer diameters being sized to create a friction fit with at least a portion of the internal passage defined by the valve body. In a preferred form, the integral valve seat and diaphragm support member define at least one lip which may be used for assisting in the removal of the valve seat and integral diaphragm assembly support member from the internal passage of the valve body.

In another form an integral scrubber and filter assembly is disclosed herein comprising a body defining a generally cylindrical opening to receive a control chamber filter that moves between a diaphragm closed position and diaphragm open position, the generally cylindrical opening having at least one scrubbing surface for engaging at least a portion of the filter while the filter moves between the diaphragm closed and diaphragm open positions to remove debris from the filter. The integral scrubber and filter further including a screen positioned upstream of the generally cylindrical opening to block larger debris from flowing through to the generally cylindrical opening. The at least one scrubbing surface includes at least one projection extending from the generally cylindrical opening to engage at least a portion of the filter while moving between the diaphragm open and closed positions to remove debris from the filter. In one form, the at least one scrubbing surface comprises a plurality of fingers extending coaxially about the generally cylindrical opening and each having a surface that is positioned to engage at least a portion of the filter while moving between the diaphragm open and closed positions to remove debris from the filter. Moreover, in a preferred form, the plurality of fingers are bell-mouthed or tapered to assist with insertion of the filter into the plurality of scrubber fingers.

In yet another form, a removable valve seat is disclosed herein which assists in the manufacturability, assembly, installation and/or serviceability of the internal valve components. In this form, the diaphragm valve includes a valve body having an inlet, an outlet and an internal passage between the inlet and outlet, and an upper opening, the valve body also defining a recess for receiving a valve seat located in the internal passage opposing the upper opening of the valve body. A diaphragm assembly positioned between the inlet and outlet in the internal passage of the valve body, the diaphragm assembly being movable between a closed position where a valve seal is positioned on the valve seat to prevent fluid flow from the inlet to the outlet and an open position where the valve seal is spaced apart from the valve seat to permit fluid flow from the inlet to the outlet. A control chamber disposed on one side of the diaphragm assembly, with a control chamber entrance passage to permit fluid to flow into the control chamber and a control chamber exit to permit fluid flow from the control chamber. The diaphragm valve also having a valve positioned to selectively prevent and permit fluid flow from the control chamber to control the fluid pressure in the control chamber to control movement of the diaphragm assembly between the open and closed positions, and a filter connected to the control chamber entrance passage to filter the fluid permitted to flow into the control chamber. Unlike conventional valves, however, the disclosed valve includes a removable valve seat assembly disposed in the recess defined by the valve body which can be removed and serviced or replaced.

In the form illustrated in FIGS. 3A-L, the removable valve seat assembly includes a diaphragm assembly support member for supporting at least a portion of the diaphragm assembly when disposed within the internal passage of the valve body. The removable valve seat assembly also includes a gripping surface for grasping the removable valve seat assembly when removing the removable valve seat assembly from the internal passage of the valve body.

In another embodiment a non-transitory storage medium such as memory for storing a program executable by a processor based system such as a controller is disclosed wherein the program causes the processor based system to execute steps comprising: receiving data regarding fluid flow in an irrigation system; establishing at least one normal fluid flow parameter based on received data while the processor is in a learn mode; determining if current fluid flow is consistent with the at least one normal fluid flow parameter while the processor is in a normal operating mode; and responding to situations wherein current fluid flow is not consistent with the at least one normal fluid flow parameter while the processor is in the normal operating mode. In one form responding to situations wherein current fluid flow is not consistent with the at least one normal fluid flow parameter while the processor is in the normal operating mode comprises shutting a valve connected to the irrigation system and preventing the valve from opening until the processor receives a reset command.

In still another embodiment, a diaphragm valve having a flow meter for learning, monitoring and taking action in response to fluid flow data is disclosed. The diaphragm valve having a valve body having an inlet, an outlet and an internal passage between the inlet and outlet. A diaphragm assembly positioned between the inlet and outlet in the internal passage of the valve body, with the diaphragm assembly being movable between a closed position where fluid flow from the inlet to the outlet is blocked and an open position where fluid flow from the inlet to the outlet is permitted. A control chamber disposed on one side of the diaphragm assembly, with a control chamber entrance passage to permit fluid to flow into the control chamber and a control chamber exit passage extending from the control chamber to permit fluid flow from the control chamber. The diaphragm valve also having a solenoid valve positioned to selectively prevent and permit fluid flow through the control chamber exit passage from the control chamber to control closing and opening of the diaphragm assembly to control flow through the diaphragm valve. Unlike conventional valves, however, the diaphragm valve further includes a flow meter coupled to the diaphragm valve for learning normal fluid flow parameters, monitoring fluid flow and moving the diaphragm assembly to the closed position when fluid flow is inconsistent with the normal fluid flow parameters is detected.

The diaphragm valve further includes a controller coupled to at least one of the flow meter and diaphragm valve for moving the diaphragm assembly between the open and closed positions. In one form, the controller is electrically coupled in series to the flow meter and the flow meter is electrically coupled in series to the diaphragm valve so that the flow meter actuates the diaphragm valve in response to receiving a signal from the controller and closes the diaphragm valve when the fluid flow is inconsistent with the normal fluid flow parameters. In another form, the controller is electrically coupled directly to the flow meter and directly to the diaphragm valve and opens the diaphragm valve when programmed to open the diaphragm valve and shuts the diaphragm valve in response to receiving a signal from the flow meter that the fluid flow is inconsistent with the normal fluid flow parameters. In yet another form, the flow meter is self-powered via a generator that converts rotational movement of a turbine of the flow meter into electricity to power the flow meter. In some applications, the flow meter may be electrically connected to the diaphragm valve and also power the diaphragm valve in addition to itself.

In another form, the flow meter includes a processor and a turbine coupled to the processor which the processor uses for learning normal fluid flow parameters and monitoring fluid flow, the processor being programmed to cut power to the solenoid to selectively prevent fluid flow through the control chamber thereby causing the diaphragm to move to the closed position when detected flow rates are inconsistent with the normal fluid flow parameters. In a preferred form, the flow meter is positioned upstream of the diaphragm assembly and includes at least one input and at least one visual display, the processor being programmed to enter a learning mode upon actuation of the at least one input wherein the axial turbine is used to determine normal fluid flow parameters. In one example, the at least one input is a push button switch and the actuation of the at least one input comprises depressing the push button for a predetermined period of time to enter the learning mode.

In a preferred form, the at least one input comprises first and second inputs and the at least one visual display comprises first and second LEDs, the processor being programmed to enter the learning mode upon actuation of the first input for a predetermined period of time and causing the first LED to illuminate steadily and the second LED to flash once the learning mode has been entered. In addition, the at least one input is preferably a sealed actuator which can be operated in wet environments. For example, the sealed actuator may be selected from one or more of a magnetic switch, a capacitive switch or a sealed push-button switch. In one example, a magnetic switch is used for the actuator. In use, a system operator would carry a magnetic device that operates the magnetic switch directly through a sealed surface so that the internal electronics of the flow meter could not be exposed to humidity or liquids that might otherwise interfere with normal operation of the flow meter.

The diaphragm valve and flow meter may also be programmed to automatically detect fluid flow and to start processing the accompanying fluid flow data to determine if this data can be used to establish at least one fluid flow parameter (such as a threshold for acceptable fluid flow). By automatically detecting this information, significant time can be saved when teaching the flow meter normal fluid flow parameters. The flow meter may be pre-programmed with a range or list of normal fluid flow data that the flow meter may use to determine if the automatically detected data is reliable and can be used to establish at least one normal fluid flow parameter. Alternatively, the flow meter may be programmed to receive a range or list of normal fluid flow data that the flow meter can use for this purpose.

The diaphragm valve and flow meter may also be programmed to automatically determine if the fluid flow that is inconsistent with the normal fluid flow parameters is indicative that the irrigation system is being purged or winterized and enters a suspend mode for a predetermined period of time without moving the diaphragm assembly to the closed position. A very high detected fluid flow reading may be indicative that the irrigation system is being purged or winterized and, thus, the flow meter may be programmed to remain in a suspend mode for a period of time sufficient to complete the purge or winterization of the irrigation system. In one form, the flow meter is pre-programmed with purge or winterization flow rate data that is used to determine if the fluid flow that is inconsistent with the normal fluid flow parameters is indicative that the irrigation system is being purged or winterized. In another form the flow meter is programmed to learn purge or winterization fluid flow data for the specific irrigation system the flow meter is used with and this learned purge or winterization fluid flow data is used to determine if the fluid flow that is inconsistent with normal fluid flow parameters is indicative that the irrigation system is being purged or winterized.

1. A method of monitoring fluid flow in an irrigation system comprising:
establishing at least one normal fluid flow parameter through the irrigation system via an initial learning period;
monitoring current fluid flow through the irrigation system;
determining, by a processor based apparatus, if the current fluid flow is consistent with the at least one normal fluid flow parameter; and
taking action in response to a determination that the current fluid flow is not consistent with the at least one normal fluid flow parameter.

2. The method of claim 1, wherein taking action comprises at least one of shutting a valve and providing an alert that current fluid flow is not consistent with the at least one parameter.

3. The method of claim 2, wherein the alert comprises at least one of sending a notice to a user, triggering an audible alarm, and displaying a visual indicator.

4. The method of claim 3, wherein sending a notice comprises transmitting a signal to a remote device.

5. The method of claim 1, wherein establishing the at least one normal fluid flow parameter comprises activating a learn mode through an input and determining what normal fluid flow through the irrigation system is during a period of time when the system is known to be operating normally.

6. The method of claim 5, wherein establishing the at least one normal fluid flow parameter comprises adding an upper and lower threshold buffer to the determined normal fluid flow through the irrigation system to account for acceptable variances in fluid flow rate due to pressure changes within the irrigation system.

7. The method of claim 1, wherein establishing the at least one normal fluid flow parameter comprises automatically collecting data regarding fluid flow rate upon initiation of flow through the irrigation system and using this data to set the at least one normal fluid flow parameter upon actuation of an input.

8. The method of claim 7, wherein the processor determines if the data is within a range of acceptable flow rate data for use in establishing the at least one normal fluid flow parameter and provides an indication if the data is within the range.

9. The method of claim 8, wherein providing the indication comprises illuminating a light.

10. The method of claim 7, wherein the processor determines if the data is acceptable for establishing the at least one normal fluid flow parameter and provides an indication if the data is acceptable.

11. The method of claim 7, wherein automatically collecting data regarding fluid flow rate upon initiation of flow through the irrigation system comprises continuously collecting the data and using a statistical measure of the collected data to establish the at least one normal fluid flow parameter.

12. The method of claim 11, wherein using a statistical measure comprises using a median or mean of the data to establish the at least one normal fluid flow parameter.

13. The method of claim 1 wherein establishing the at least one normal fluid flow parameter is accomplished with the single actuation of an input.

14. The method of claim 13 wherein the single actuation of an input comprises actuating the input for a predetermined amount of time to activate a learn mode.

15. A diaphragm valve comprising:
a valve body having an inlet, an outlet and an internal passage between the inlet and outlet;
a diaphragm assembly positioned between the inlet and outlet in the internal passage of the valve body, the diaphragm assembly being movable between a closed position where fluid flow from the inlet to the outlet is blocked and an open position where fluid flow from the inlet to the outlet is permitted;
a control chamber disposed on one side of the diaphragm assembly;
a control chamber entrance passage to permit fluid to flow into the control chamber;
a control chamber exit passage extending from the control chamber to permit fluid flow from the control chamber;
a valve positioned to selectively prevent and permit fluid flow through the control chamber exit passage from the control chamber to control closing and opening of the diaphragm assembly to control flow through the diaphragm valve; and
a flow meter coupled to the diaphragm valve for learning normal fluid flow parameters, monitoring fluid flow and moving the diaphragm assembly to the closed position when fluid flow is inconsistent with the normal fluid flow parameters is detected.

16. The diaphragm valve of claim 15 wherein the flow meter includes a controller programmed to automatically determine if the fluid flow that is inconsistent with the normal fluid flow parameters is indicative that the irrigation system is being purged or winterized and enters a suspend mode for a predetermined period of time without moving the diaphragm assembly to the closed position.

17. The diaphragm valve of claim 16 wherein a very high detected fluid flow reading is indicative that the irrigation system is being purged or winterized and the flow meter remains in the suspend mode for a period of time sufficient to complete the purge or winterization of the irrigation system.

18. The diaphragm valve of claim 16 wherein the flow meter is pre-programmed with purge or winterization flow rate data that is used to determine if the fluid flow that is inconsistent with the normal fluid flow parameters is indicative that the irrigation system is being purged or winterized.

19. The diaphragm valve of claim 16 wherein the flow meter is programmed to learn purge or winterization flow rate data for the specific irrigation system the flow meter is used with and this learned purge or winterization flow rate data is used to determine if the fluid flow that is inconsistent with normal fluid flow parameters is indicative that the irrigation system is being purged or winterized.

20. The diaphragm valve of claim 15 wherein the flow meter includes a controller programmed to automatically detect fluid flow and determine if the detected fluid flow is reliable for use in establishing the normal fluid flow parameters.
